(19) United States
(12) Patent Application Publication
(10) Pub. No.: US 2026/0010811 A1
(43) Pub. Date: Jan. 8, 2026

(54) SYSTEMS AND METHODS FOR DETERMINING ENERGY OF PREPARED QUANTUM STATES

(71) Applicant: Quantinuum GmbH, München (DE)

(72) Inventors: Henrik Dreyer, München (DE); Etienne Louis Granet, München (DE)

(73) Assignee: Quantinuum GmbH, München (DE)

(21) Appl. No.: 19/259,527

(22) Filed: Jul. 3, 2025

Related U.S. Application Data
(63) Continuation-in-part of application No. 18/795,516, filed on Aug. 6, 2024.

(30) Foreign Application Priority Data
Jul. 5, 2024 (GB) 2409808.9

(51) Int. Cl. G06N 10/20; G06N 10/40

(52) U.S. Cl. CPC G06N 10/20; G06N 10/40

(57) ABSTRACT

Provided are computer-implemented methods and quantum computing systems for preparing computational states representing quantum states of a physical system, including performing a computational evolution of the state and then determining physical properties of the system using the time-evolved computational state. A described computer-implemented method enables computing Hamiltonian dynamics of observables on a quantum computer to provide information about the physical system represented by the Hamiltonian. A described computer-implemented method prepares low energy electronic structure states of a physical system using adiabatic evolution. The method determines the energy of an equilibrium quantum state of a physical system using a time evolution operator that enables adiabatic evolution of a prepared electronic structure state on a quantum computing system. A described method involves indirectly determining the energy of an eigenstate of a physical system by evaluating the expectation values of a time-evolution operator averaged across multiple shots for randomly-generated quantum circuits.

### CROSS-REFERENCE TO RELATED APPLICATIONS

This application is a continuation-in-part of and claims the benefit to U.S. application Ser. No. 18/795,516, filed Aug. 6, 2024, which claims the benefit of G.B. Patent Application No. 2409808.9, filed on Jul. 5, 2024, the entire contents of which applications are incorporated herein by reference.

### TECHNICAL FIELD

The present disclosure relates to quantum computing and, in particular, to the preparation of low-energy electronic structure states and determination of the energy of the prepared states. The disclosure has applications in computational chemistry using quantum computing systems, where the energy of a prepared state must be determined with high accuracy despite noise within the quantum computing system.

### BACKGROUND

Quantum computers are inherently suitable for determining properties of complex physical systems, by modelling the energy states of individual molecules or solid materials, because they exploit quantum phenomena. Unlike classical digital computers in which the basic unit of computation, the bit, has to be in one of two discrete binary states (1 or 0), quantum computers utilise qubits or qudits which may exist in a superposition of different computational states. This is important for quantum chemistry applications, because it enables the computer to accurately describe molecules with exponentially fewer qubits than bits on a classical computer. However, the current generation of quantum computers are vulnerable to stochastic noise which may lead to decoherence between the different quantum states. This noise problem becomes more significant as the number of qubits and gates increase for more complex computational processing. Currently available quantum computers are often referred to as noisy intermediate-scale quantum (NISQ) devices, in recognition of the significant problem of noisy qubits. The presence of noise and the current lack of complete fault-tolerance causes significant limitations in the types of algorithms that are executable on currently-available NISQ devices, where considerations such as the circuit depth or the available resources (e.g., limited number of qubits and a lack of gate fidelity) need to be taken into account. Therefore, mitigation of the problems of noise is a significant technical problem associated with NISQ devices. Quantum computers have also been emulated using classical computers, and quantum computing systems have been implemented using a hybrid combination of a classical digital computer and a quantum computer, partly because of the need to improve the reliability and scalability of quantum computers.

There is interest in developing computational procedures and implementations of quantum computers for simulating and evaluating the physical properties of materials, such as energy levels and particle interactions. When using quantum computing systems to simulate the behaviour of physical quantum systems, such as a molecule, there is a need for a computer-implemented method to prepare a low-energy electronic structure state and to determine the energy of the state. For the results to be useful, there is a desire for computational results such as these energy determinations to have a level of precision referred to as ‘chemical accuracy’ (generally considered to be a level of accuracy of 10⁻³ atomic units), but noisy quantum gates reduce the accuracy of energy measurements and discretization errors arise when a computation is broken down into a large number of discrete steps (e.g. when simulating the evolution of a quantum system by Trotterising time-dependent electronic-structure Hamiltonians).

Known approaches for determining the ground state energy of a simulation of a complex quantum system are not implementable with sufficient accuracy on currently available classical computers or NISQ computers.

### SUMMARY

Aspects of the present disclosure provide computer-implemented methods and quantum computing systems for preparing computational states representing quantum states of a physical system, including performing a computational evolution of the state and then determining physical properties of the system using the time-evolved computational state.

A first aspect of the present disclosure provides a computer-implemented method for computing Hamiltonian dynamics of observables on a quantum computer to provide information about the physical system represented by the Hamiltonian. A second aspect provides a method for preparing the electronic structure state with lowest energy of a physical system using adiabatic evolution. A third aspect of the disclosure provides a method for determining the energy of a quantum state of a physical system using a time evolution operator that enables adiabatic evolution of a prepared electronic structure state on a quantum computing system. A fourth aspect of the disclosure provides a method for indirectly determining the energy of a prepared quantum state by evaluating the expectation values of a time-evolution operator.

Example methods described below enable calculation of the energy of an evolved state with chemical accuracy, due to avoiding discretization errors, with a finite circuit depth requiring fewer quantum gates than known alternatives. In this context, the achievement of chemical accuracy and avoidance of discretization errors with ‘finite circuit depth’ refers to the fact that the number of gates in the quantum circuits does not increase unacceptably with precision improvements, as would happen in alternative solutions relying on Trotterisation. For this reason, the methods described herein are implementable on NISQ computers.

According to an aspect of the disclosure, there is provided a computer-implemented method for determining the energy of a quantum state of a physical system or determining another physical property of the physical system, comprising: generating a computational model representing the physical system, wherein the computational model comprises an initial computational state and a time-evolution operator for performing an evolution over time to prepare a final computational state; generating quantum circuits for implementing the computational model, wherein each of the quantum circuits comprises a sequence of steps to implement the time-evolution operator, wherein each step of the sequence of steps is drawn randomly from a set of potential steps of the time-evolution operator; and executing the quantum circuits on the qubits or qudits of a quantum computing system and measuring the qubits or qudits to output expectation values of the time-evolution operator; computing an average of the expectation values over the generated quantum circuits; and determining a physical property of the physical system from the computed average of the expectation values.

In an example implementation, each quantum circuit comprises, for each of a plurality of terms in the computational model, a sequence of rotations of a selected gate angle applied to the respective term. A quantum circuit may contain rotations of multiple different terms and different terms can be associated with different gate angles, but the sequence of rotations for each respective term of the computational model comprises a sequence of rotations having the same gate angle selected from a predefined set of gate angles. After computing the average of the expectation values over the generated quantum circuits for each term of the computational model, the computed average can be rescaled by a factor that is a function of the gate angle.

The present disclosure is implementable by measuring the qubits or qudits of a quantum computer system and computing expectation values as an average of measurement outcomes over several shots (i.e. realizations of the same circuit) for each of a plurality of randomly-generated quantum circuits.

The disclosure can be used, for example, to determine the effects on the properties of physical systems, including the properties of their electronic structure states, from chemical interactions that stretch the bonds within a molecule. The disclosure can be used to determine reaction rates by computing the ground state energy as a function of interactions that cause bond stretching. The disclosure can also enable a determination of the effect of temperature on molecules, such as determining the temperature at which molecules will dissociate, for example. As well as determining the ground state energy of a physical system or the energy of another equilibrium state, the disclosure could also be used for computing quantities out-of-equilibrium, such as orbital occupation for example.

The generated computational model may comprise a Hamiltonian, H, which represents the states and interactions of a physical system. This can take account of the composition of molecules and approximate configuration of atoms and the effects of orbital electrons, including building a Hamiltonian that is designed to reflect the results of experimental testing of the physical system, such as experimentally testing molecules for a specific objective and reflecting that test data within an objective function of the Hamiltonian. The evolution operator of the Hamiltonian allows a computational determination of the energy of a state of the represented physical system, implementing an evolution of an initial computational state followed by a determination of properties of that evolved state such as the ground state energy.

Computational states representing states of the physical system may be evolved gradually from a prepared initial state using quantum circuits that average to an adiabatic evolution of the physical system. Expectation values of a time-evolution operator of the Hamiltonian may be calculated as an average of measurement outcomes over a plurality of shots of each of a plurality of quantum circuits. In an example implementation, the sequence of operations of each quantum circuit comprises a sequence of rotations with a selected gate angle, for a respective term of the Hamiltonian, wherein each rotation is drawn randomly and independent of each other with a rate (corresponding to a probability) given by a function of the gate angle. The rotations for a respective term of the Hamiltonian have the same gate angle, but each quantum circuit may comprise rotations with a different gate angle. Rotation operators in a quantum circuit manipulate qubits to change their orientation, modifying the quantum state. A sequence of rotations can transform an initial state into a desired state. The gate angle is a parameter that specifies the amount of rotation in Hilbert space that is applied by a quantum gate operator. Adjusting the gate angle can control the state evolution, and in the present disclosure a sequence of small rotations can be used to achieve an adiabatic state evolution-evolving the state while staying in the ground state. We note here that the terms of the computational model may be the terms in a Pauli string decomposition of a Hamiltonian. The rotations in this context are implemented as the exponential of a tensor product of Pauli matrices on different qubits times a coefficient which is referred to here as the gate angle. Namely, an operator e^{iτP}^{ₙ}, with a gate angle τ, where P is a Pauli string (for example P=X_0 Y_1 Z_2).

An implementation of the above-described aspect of the present disclosure provides a computer-implemented method for performing adiabatic time evolution calculations on quantum computers, which is free of discretization errors. The method involves expressing the time evolution operator as an average over randomly generated quantum circuits which have a finite number of gates. The quantum circuits are generated by appending to the circuit, for each term in a Hamiltonian, a sequence of rotations of the term with a fixed gate angle, drawn randomly and independently with a rate given by a known function of the gate angle and the coefficient of the term, during a time equal to the simulation time. The averaged expectation values measured are proportional to the exact expectation value with a proportionality factor given by a known function of the fixed gate angle and the Hamiltonian.

A computer-implemented method for determining the energy of a quantum state of a physical system comprises: preparing an initial computational state of the physical system (such as a representation of a known ground state); generating a time-dependent Hamiltonian comprising a time-evolution operator for evolving the initial computational state towards a target computational state; generating quantum circuits which each implement a sequence of gates for implementing the time-evolution operator to perform an adiabatic state evolution from the initial computational state to the target computational state, wherein each gate of the sequence of gates is drawn randomly from a set of potential gates associated with the time-evolution operator; and executing the quantum circuits on the qubits of a quantum computing system and measuring the qubits for a plurality of shots of each quantum circuit, to output expectation values of the time-evolution operator; computing an average of the expectation values over the plurality of shots of the generated quantum circuits; and determining the energy of the target computational state from the computed average of the expectation values.

According to another aspect of the disclosure, there is provided a computer-implemented method for determining the energy of a quantum state of a physical system, comprising: generating a computational model representing the energy of a time-evolved quantum state of the physical system, wherein the computational model comprises a prepared computational state, representing a state of the physical system, and a time-evolution operator performing an evolution over time of the prepared computational state, wherein the operator has a parameter that encodes the energy of the time-evolved computational state and the operator has a parameter-dependent expectation value that is zero when the parameter is equal to the ground state energy of the state; generating quantum circuits corresponding to the computational model; executing the quantum circuits on the qubits or qudits of a quantum computing system to compute the effects of the time-evolution operator of the computational model; and measuring the qubits or qudits of the quantum computing system so as to determine the value of the parameter where the parameter-dependent expectation value is zero, and using the determined parameter value to determine the ground state energy of the time-evolved quantum state.

A feature of this aspect of the disclosure is an indirect method for measurement of the energy of a quantum state, especially an equilibrium state such as the ground state of the physical system or another eigenstate. This indirect measurement is much more robust to hardware noise than direct energy measurement. It involves measuring a parameter-dependent operator whose expectation value vanishes at a certain parameter value, to determine the parameter value corresponding to the ground state energy of the state. Instead of directly measuring the energy of the state, which would require running circuits with lower noise than the target precision, the energy of the state is encoded in the value of the parameter where this operator has a vanishing expectation value. Since the main effect of hardware noise is to attenuate the signals measured, this approach of determining the point at which the operator has a zero expectation value has been observed by the inventors to tolerate higher levels of noise.

The method of this measurement aspect can be implemented using the above-described state evolution followed by indirect measurement to determine the ground state energy. The computational model that represents physical properties of the system may include experimentally-determined properties for an initial electronic structure state, followed by time-evolution of the computational state and use of that time-evolved state in the determination of physical properties and indirect measurement. The disclosure allows a computational determination of the ground state energy of a time-evolved quantum state. This can be used, for example, to determine the effects of physical interactions on the ground state energy of a physical system.

Described below by way of example are three methods for measuring the energy of the prepared state in an efficient and noise-resilient manner, each of which has been shown to yield chemically accurate results on a 4-qubit molecule in the presence of realistic gate noise, without the need for error mitigation when performing a determination of the ground state energy for small molecules.

Features of the above-described aspects of the disclosure may be combined. According to one aspect of the disclosure, there is provided a computer-implemented method to determine the energy of a quantum state of a physical system, by calculating an expectation value of a parameter-dependent state evolution operator as an average over a plurality of quantum circuits, and indirectly measuring the energy. The method comprises: generating a computational model representing the energy of a physical system, wherein the computational model comprises an initial computational state representing a state of the physical system and an operator representing an evolution over time of the physical system from the initial state, wherein the operator is selected to have a parameter-dependent expectation value that is zero when the parameter is equal to the energy of the state; generating quantum circuits for implementing the computational model, wherein each of the quantum circuits comprises a sequence of operations of the time-evolution operator, wherein each operation of the sequence of operations is drawn randomly from a set of operations of the time-evolution operator; and executing the quantum circuits on the qubits or qudits of a quantum computing system to compute the effects of the time-evolution operator of the computational model; and measuring the qubits or qudits of the quantum computing system so as to determine the value of the parameter where the parameter-dependent expectation value is zero, to output measurement results corresponding to the ground state energy of the time-evolved quantum state.

This approach avoids directly measuring the energy of the state, making use of the calculated expectation values for a time-evolution operator applied on the ground state, by encoding the energy of the state in the value of a parameter and determining where the parameter-dependent time-evolution operator has a zero expectation value. The inventors have determined that this approach is less sensitive to system noise than known methods for measuring the energy of a state. In one implementation of the described method, the parameter for which the expectation value of the operator vanishes is directly the energy of the state. In particular, the inventive systems and methods described below have been shown to provide chemically accurate results for small molecules in the presence of realistic gate noise, without the need for error mitigation. With high-fidelity qubits and/or error mitigation, the disclosure is applicable to larger molecules.

In an example, the state preparation comprises an adiabatic state preparation that generates a state corresponding to an eigenstate of the physical system, such as the ground state. The computational model may comprise a Hamiltonian representing the evolution of the physical system from a prepared state, with computations involving an adiabatic preparation of a state and determination of the ground state energy based on a measurement of observables other than a direct measurement of the energy of the state. The adiabatic state preparation involves preparing a quantum system in a specific desired state, preferably starting with a Hamiltonian whose ground state is relatively easy to prepare, and then gradually transforming the initial Hamiltonian into a target Hamiltonian whose ground state corresponds to the desired state. The final Hamiltonian can encode the solution to a problem of interest. This type of adiabatic state preparation has applications in quantum chemistry, for tasks such as molecular simulation and electronic structure calculations, such as to determine chemical reaction rates. An aspect of the present disclosure provides an efficient way of determining the energy of the evolved ground state of a physical system, without requiring such a high quantum circuit depth.

Thus, the inventive approach described herein reduces the circuit depth compared to conventional implementations of quantum phase estimation (QPE). For increased efficiency on most of the currently available hardware, it is preferred to use simplified methods such as the binary search approach, arctan fit approach or Robbins-Munro approach described below. These described methods each provide a level of noise-resilience in the determination of the energy of an adiabatically prepared ground state, and demonstrate that adiabatic approaches to state preparation can play a key role in quantum chemistry simulations, whether using noisy intermediate scale quantum (NISQ) computers or error-corrected quantum computers.

The methods described herein are designed to take account of the constraints and capabilities of existing quantum computing systems and include adaptations to exploit connectivity between remote qubits in an ion-trapping quantum computer system. An ion-trapping quantum computer system typically has significantly lower error rate than other quantum computing systems, offers flexible connectivity between qubits (not limited to nearest neighbours connections, and allowing any-to-any qubit connectivity in some ion trapping systems), has a relatively lower clockspeed, displays hardware noise that is highly localized on the qubits on which gates are applied (namely, there is very low cross-talk noise), and gate-unrelated errors are mostly memory error, which acts like an approximately uniform rotation on the qubits. These properties are specific to ion-trapping quantum computer systems, and do not hold for superconducting quantum computer systems for example. The algorithm of this disclosure is particularly adapted to these ion-trapping quantum computer systems for the following reasons: (i) Chemical Hamiltonians expressed in terms of molecular orbitals and qubits involve a large number of couplings between arbitrary qubits, such that the physical system to be analyzed may be considered all-to-all coupled, and so the processing of chemical Hamiltonians is computationally far cheaper to implement on ion-trap devices with a built-in any-to-any connectivity. (ii) The method described herein implements rotations of terms in the Hamiltonian in a fixed way drawn at random for every circuit. This precludes optimizing the gate ordering to fit the connectivity between the qubits on other hardware systems that do not support flexible connectivity, because this optimization would take much longer than running the circuits themselves, especially on fast quantum computing systems like superconducting systems. This aspect will thus be more difficult to implement on other hardware systems than ion-traps. (iii) The indirect measurement approach requires to use an ancilla qubit which is frequently acted on. On ion-trapped architectures where the ions are shuttled around different “gate zones”, this ancilla can be kept in the same gate zone of the system where entangling gates are performed, minimizing shuttling and swapping qubits. (iv) The native two-qubit entangling gate on an ion-trapping system is a ZZ-rotation with a tuneable angle, which is valuable for the present method when implementing many such small-angle rotations. Moreover, gate fidelity on Quantinuum's ion trapping devices improves for smaller angles. (v) Sources of error that are usually difficult to handle such as memory error (due to miscalibration of varying magnetic field in the ion trap), modelled by random global rotations in the Z direction, have fewer effects due to particle number conservation in these chemical systems, because the sum of Z on all qubits is conserved.

When implemented on a quantum computer allowing quantum gates between qubits other than their nearest neighbours (including those with all-to-all connectivity between the qubits), the computer-implemented methods described herein can be implemented with reduced circuit depth and errors compared with quantum computing systems that only support quantum gates using nearest neighbour qubits. Therefore, the described methods are optimised for quantum computing systems featuring connectivity between non-adjacent high-fidelity qubits. An example system of this type is Quantinuum's H2 ion-trapping quantum computing system. Quantinuum's ion trapping quantum computer systems enable representation of the evolution of states and the interactions between atomic orbitals when forming molecular orbitals in a molecule, with reduced qubit errors because of the relatively high fidelity of ion trap qubits. However, the disclosure is implementable on other quantum computers.

An aspect of the present disclosure provides a quantum computing system comprising a quantum computer having a plurality of qubits or qudits for executing quantum circuits, and further comprising a controller for controlling performance of operations on the quantum computer, to perform a method comprising: generating a computational model representing the physical system, wherein the computational model comprises an initial computational state and a time-evolution operator for performing an evolution over time to prepare a time-evolved computational state; generating quantum circuits for implementing the computational model, which quantum circuits each comprise a sequence of operations of the time-evolution operator, wherein each operation of the sequence of operations is drawn randomly from a set of operations of the time-evolution operator; executing the quantum circuits on the qubits or qudits of a quantum computing system to output expectation values of the time evolution operator; computing an average of the expectation values over the generated quantum circuits; and rescaling the computed average by a factor that is a function of the gate angle, thereby to output a determination of a physical property of the physical system.

Any reference to qubits herein should be interpreted as potentially including qubits and/or qudits, unless stated otherwise.

### BRIEF DESCRIPTION OF FIGURES

Methods and systems implementing the present disclosure are described below in detail, by way of example, with reference to the accompanying drawings in which:

FIG. 1A is a graphical representation of the precision of the determination of ground state energy for the current disclosure compared with a known approach to adiabatic state preparation using Trotterisation, showing the precision as a function of the duration of the adiabatic state evolution.

FIG. 1B shows how the difference between a trial energy value and the ground state energy is affected by noise, but with much less influence at the point where the trial value equals the ground state energy.

FIGS. 2A and 2B show examples of the optimal gate angle (FIG. 2A) and minimum total runtime (FIG. 2B) for different values of noise.

FIG. 3 shows an estimate of the total runtime to achieve chemical precision with a described binary search approach for different values of noise.

FIGS. 4A and 4B show how the (reduced) norm of the Hamiltonian scales with the number of qubits for an algorithm implementing the method of the disclosure, which is relevant for the runtime of the algorithm.

FIG. 5A shows the difference between the ground state energy E_{GS} and the determined energy E of the state adiabatically evolved up to a time T, as a function of T.

FIG. 5B shows the lowest adiabatic evolution times, Tₘᵢₙ, for which a precision of 10⁻³ is reached (which is referred to as “chemical accuracy”), using the example of a hydrogen chain for linear and quadratic paths.

FIG. 6A shows the minimum adiabatic evolution time Tₘᵢₙ required to reach precision 10⁻³ on the ground state energy, using the linear path and quadratic path, as a function of the number of qubits, for a subset of molecules appearing in FIG. 4.

FIG. 6B shows the adiabatic evolution time as a function of the stretching defined as the ratio of the bond length with the equilibrium value.

FIG. 7 shows the difference between the ground state energy E_{GS} at stretching value 3 and the energy E of the state adiabatically prepared evolved up to time T, as a function of T for example molecules.

FIG. 8 is a graphical representation of statistical variance of state measurements as a function of T for different gate angles.

FIG. 9A shows the difference between the energy of the prepared state and the ground state energy as a function of adiabatic evolution time T for different numbers of Trotter steps, for a method relying on Trotterisation.

FIG. 9B compares a Trotterisation technique with an implementation of the present disclosure, by showing the number of Pauli string rotations required to achieve chemical precision when adiabatically preparing the ground state with a linear path.

FIG. 10 represents the amplitude of the imaginary part of expectation values for an operator in a state prepared using adiabatic state preparation.

FIG. 11A shows the expectation value of the time evolution operator on the ground state for different trial energies, as a function of simulation time, with positive/negative amplitude indicating over/underestimation of the ground state energy.

FIG. 11B shows a comparison of the precision of calculated energy values using a randomised sampling technique and either an artan fit or a Robbins-Monro approach, as a function of the number of samples.

FIG. 12 shows the real part of the Loschmidt amplitude [symbol] 0|e\hat{ }itH|0 [symbol] in the 2D Ising model at h=2 in size 3×4 with |0 [symbol] the Z=+1 product state, comparing Trotter, qDRIFT and the inventors' algorithm, all with the same gate angle and Trotter step equal to τ=0.1, and all with 10⁵ shots per point. For qDRIFT and the inventors' algorithm, the 10⁵ shots are distributed over 10³ random circuits with 10² shots per circuit.

FIG. 13A shows a noisy simulation of a computational chemistry Hamiltonian.

FIG. 13B shows an adiabatic state preparation for noiseless simulations with 10⁵ circuits and τ=0.04 (circles with a dashed line, the shade indicating one standard deviation), and exact value (lighter continuous line).

FIG. 14 is a schematic representation of an example quantum computing system comprising a hybrid combination of a classical digital computer and a quantum computer.

FIG. 15 shows a sequence of steps of a method according to an aspect of the disclosure.

FIG. 16 shows a sequence of steps of a method according to an aspect of the disclosure.

FIG. 17A shows standard deviation of measurements of real part of Loschmidt amplitude as a function of number of CNOTs per circuit (without any circuit optimization), for different number of shots per circuits.

FIG. 17B shows the real part of Loschmidt amplitude as a function of 1/α, simulated with a depolarizing noise channel.

FIG. 18 shows hardware results from the Quantinuum H1-1 ion-trap quantum computer.

FIG. 19 shows hardware results after exponential LGAE, in the same setting as in FIG. 18.

FIG. 20 shows the real part of Loschmidt amplitude as a function of time Jt, showing hardware results (bullets) and curves obtained from theoretical noise model (dashed lines), for shallow and deep.

FIG. 21A shows the real part of Loschmidt amplitude as a function of time Jt, for different system sizes N=8, 12, . . . , 32 (from right to left).

FIG. 21B shows relative Trotter error in the real part of the Loschmidt amplitude, as a function of time, using one single Trotter step (left panel) and two Trotter steps (right panel), for different system sizes N=8, 12, . . . , 32 (from bottom to top).

FIG. 22 shows a numerically simulated mirror-on-average benchmark.

### DETAILED DESCRIPTION

### 1. Introduction

For chemists, there is interest in determining what reactions can occur in a physical system, and at what temperature and rate. A simple example is to determine the point at which water molecules will dissociate into hydrogen and oxygen. A determination of the energy of the ground state of a molecule or another quantum system is an important part of this determination. Quantum computers can be used for computational chemistry, to determine the energy or other properties of a quantum system from a mathematical representation of the states of the quantum system.

Let us assume that we have prepared a computational state in a quantum computing system, with sufficient accuracy that it corresponds to an eigenstate of the physical system. We must now evaluate the energy of the state—for example determining the ground-state energy of a molecule with high accuracy. For example, we may wish to determine a ground state energy with an accuracy within 1.6×10⁻³ atomic units (1.6 mH), which is sometimes referred to as a threshold for “chemical accuracy”.

The minimum energy of a quantum system may be influenced by bond lengths, and it is possible with advanced quantum computers such as Quantinuum's H2 trapped-ion quantum computer system to take account of variations such as a stretched molecular geometry when computing the energy of a ground state of a quantum system. The ability of the present disclosure to perform determinations of the energy of quantum states of a physical system, such as a time-evolved ground state that accounts for stretching of bond lengths, is facilitated by the all-to-all connectivity of high-fidelity qubits in Quantinuum's trapped ion quantum computers. Chemical systems typically require highly correlated long-range Hamiltonians when performing computational chemistry on the qubits of a quantum computing system, and discretisation to break the complex computations down into smaller computations (Trotterisation) has resulted in too many errors when performed on systems that require all interactions to be exclusively between nearest neighbour qubits. An ion trapping quantum computer system is well-adapted to determinations of the properties of complex chemical systems, and the computer-implemented methods described herein are well-adapted to an ion-trapping system featuring all-to-all connected qubits.

Described below are computer-implemented methods and quantum computing systems for determining properties of a physical system, in particular for determining the energy of an equilibrium quantum state such as the ground state, using adiabatic evolution of an initial computation state towards a target state. The described methods and systems can provide results within the currently-accepted threshold for chemical accuracy, at least for some small molecules, in a noisy quantum computer system without error correction. The methods have been shown to yield chemically accurate results on a 4-qubit molecule in the presence of realistic gate noise, without the need for error mitigation other than simple symmetry filtering of the shot outcomes.

The described methods and algorithms involve noise-resilient approaches for determining the energy of a prepared state, which is particularly advantageous when combined with adiabatic state preparation and evolution. This has been achieved without discretisation errors heating the state, and with far fewer gates than Trotterisation.

Representing low-energy states of the electronic structure Hamiltonian is an important step in quantum computational chemistry. Initial proposals for the use of quantum computers for this task have used Quantum Phase Estimation (QPE) to project high-overlap Hartree-Fock wavefunctions into the ground state with high probability [2]. The high cost of the coherent time-evolution required, as well as the existence of strongly multireference ground states (i.e. molecules where the Hartree-Fock state has low overlap with the ground state) has triggered interest in how to efficiently prepare a low-energy electronic structure state on a digital quantum computer.

Heuristic approaches, most notably the variational quantum eigensolver (VQE), have been devised and carried out on noisy devices [3-5]. While inspired by adiabatic evolution [6], these methods abandon the theoretical guarantees of the adiabatic approach in favor of parameterized circuits which need to be optimized. For the classical computer, this replaces the quantum simulation problem with the usually hard problem of non-linear optimization in a generically hostile cost landscape [7-11].

In contrast, adiabatic approaches to the state preparation problem have received considerably less attention, despite more theoretical guarantees and fewer hidden costs than VQE [2, 12-18]. A major reason for this is that the adiabatic evolution is usually assumed to be implemented via Trotterisation, in part because more sophisticated methods suffer from extra overheads [19-26], especially when simulating time-dependent Hamiltonians [20, 21, 24, 27-29]. Trotterising the electronic structure Hamiltonian, which contains O(L⁴) terms where L is the number of orbitals, then requires extremely large numbers of gates. What's more, discretising a continuous adiabatic path into piecewise constant Trotter steps necessarily leads to discretisation errors (Trotter errors), which effectively heat the quantum state. This is particularly problematic in quantum chemistry applications, where extreme precision is required to have predictive power on chemical reaction rates.

An example computer-implemented method for implementing the present disclosure employs a randomized ‘TETRIS’ algorithm (Time Evolution Through Random Independent Sampling) for Hamiltonian evolution, which combines adiabatic state preparation with random sampling. The TETRIS algorithm is an algorithm that computes Hamiltonian dynamics of observables [symbol] [symbol] (t) [symbol] = [symbol] 0|e|^{iHt} [symbol] e^{-iHt}|0 [symbol] on digital quantum computers without discretization error even with a finite number of gates, for any Hamiltonian H and unitary [symbol] . The expectation value ( [symbol] (t)) is obtained as the average over random circuits drawn from a known distribution, multiplied by a known factor. One can choose freely the angle τ of the rotations entering the circuit, only modifying the multiplicative factor and not the precision of the result. The inventors have determined that this allows a decrease of the gate count, at the cost of an increased number of shots on a quantum computer, yielding a natural noise-mitigation technique. Optimisation of the gate angle is described in section 3.4 and Appendix 1.

The optimal choice of gate angle yields a shot overhead of order [symbol] (1) with a gate count per circuit [symbol] (t²μ²) where μ is the 1-norm of the Hamiltonian, without any dependence on the precision desired, contrary to all previous algorithms. Since the gate count depends only on μ, the algorithm is particularly adapted to non-sparse Hamiltonians. It also straightforwardly generalizes to time-dependent Hamiltonians without any overhead. Thus, the method implements adiabatic evolution without heating and with far fewer gates than Trotterisation. This avoids the discretization errors that typically arise when Trotterising time-dependent electronic structure Hamiltonians, and therefore removes one of the main obstacles to the use of adiabatic state preparation for computational chemistry applications. Additionally, the method requires a circuit depth that is independent of the desired precision ∈, contrary to many algorithms that require an infinite depth when ∈→0. Hence, by applying randomly gates on the initial state according to a gate creation process (as described below in section 3.2), and multiplying the result by a known amplification factor, one achieves an energy determination with zero discretization error while having finite-depth circuits.

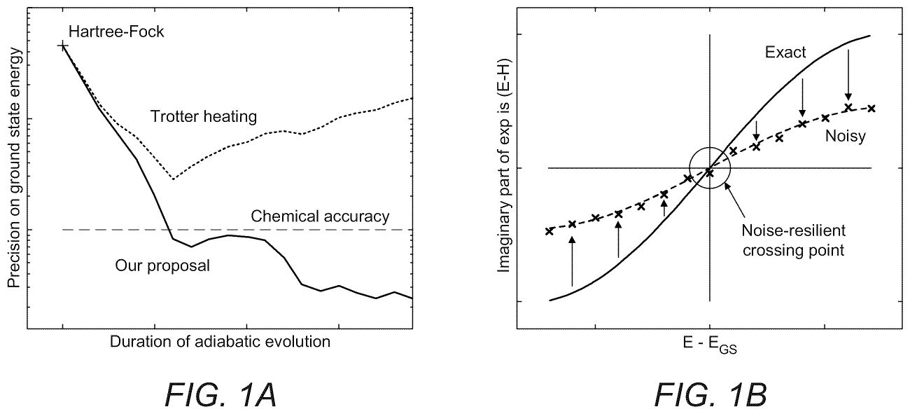

FIG. 1A provides a graphical representation of the performance of the disclosure (including achievement of chemical accuracy) compared with a known technique based on Trotterisation. FIG. 1B is a conceptual figure summarizing one aspect of the disclosure. FIG. 1A represents the accuracy of the determined energy of the ground state prepared adiabatically, as a function of the total adiabatic time evolution. A Trotter decomposition leads to heating, precluding reaching chemical accuracy. In contrast, the solution proposed herein implements the exact adiabatic evolution and is free of any discretization error heating. FIG. 1B shows the imaginary part of a Hamiltonian operator e^{is(E-H)} on a prepared state, as a function of E-E_{GS}, at fixed arbitrary s. The main effect of hardware noise is to flatten the curve of FIG. 1B, which does not affect the point where the curve vanishes. This zero point is where E matches the ground state energy E_{GS}. The data for FIG. 1A was obtained from an H₆ hydrogen chain and the data for FIG. 1B was obtained from an H₂ hydrogen molecule, both in a STO-3G basis, see Section 5 and below.

A new computer-implemented method is described herein using an implementation of the randomised “TETRIS” algorithm (Time Evolution Through Random Independent Sampling) for Hamiltonian simulation that was described in E. Granet and H. Dreyer, arXiv:2308.03694 (2023), 10.48550/arXiv.2308.03694 [1]. That paper is incorporated herein by reference and included as Appendix 1.

The TETRIS algorithm takes as input a Hamiltonian H decomposed, a unitary observable [symbol] , a time t and an initial state |ψ(0) [symbol] , and outputs [symbol] ψ(t)| [symbol] |ψ(t) [symbol] . It takes 0<τₙ≤π/2 as N parameters. The algorithm consists of the following steps: firstly, prepare the system in the initial state |ψ(0) [symbol] . Secondly, for each n∈{1, . . . , N}, draw an integer mₙ from a Poisson distribution with parameter

$$\frac{\vert {c}_{n} \vert t}{sin \vert {τ}_{n} \vert} .$$

Then draw mₙ real numbers

$${t}_{n}^{( i )} ,$$

where i∈{1, . . . , mₙ}, uniformly at random between 0 and t. These

$$M ≡ {\sum }_{n = 1}^{N} {m}_{n}$$

numbers are collected into a set T. Thirdly, deduce then the sequence k₁, . . . , K_{M}∈{1, . . . , N} such that the index n corresponding to the j-th smallest element of T is kⱼ. For m=1, . . . , M in this order, apply the rotation

$${e}^{i {τ}_{{k}_{m}} sgn ( {c}_{{k}_{m}} ) {o}_{{k}_{m}}}$$

on the system. Fourthly, apply the observable [symbol] on the system. Fifthly, repeat the second and third steps with τₙ replaced by −τₙ. Sixthly, measure the overlap with the initial state and divide the result by an attenuation factor. On a quantum computer, this step requires to perform a Hadamard test. Then repeat the first to sixth steps a number of times and average the results. Section 3B of this patent specification also discloses these steps of the TETRIS algorithm. When measuring the overlap with the initial state, one has to choose a number of shots S to do per configuration, i.e. how to distribute the resources between number of configurations and accuracy of each configuration. If we neglect compilation time, the optimal number of shots can be seen to be S=1 [117].

This TETRIS algorithm has the following features: (i) the cost depends not on the number of terms in the Hamiltonian but on the interaction norm μ_{I} (which we will introduce shortly) which is bounded by the 1-norm and generically has a scaling between O(L) and O(L³) depending on the system and the decomposition considered [30-32], (ii) the number of gates can be chosen at will at the cost of introducing sampling overhead, (iii) time-dependent Hamiltonians can be simulated at no extra cost, (iv) there are no parameters to be optimised, (v) the output is free from discretization (Trotter) error and (vi) in practice, the required number of gates not only scales advantageously but also comes with a prefactor known to be <1.

This algorithm removes thus one of the main obstacles to adiabatic state preparation (ASP) for chemistry applications. The inventors have shown that states that hold information about the ground state energy of small molecules within chemical accuracy can be prepared adiabatically in this way with circuits containing only tens to hundreds of two-qubit gates. For example, with around ˜10³ two-qubit gates, one can prepare the ground state of molecules like LiH or a hydrogen chain H₄ at equilibrium within chemical precision.

This finding, however, introduces a new challenge: State preparation is only useful to the extent that observables (most notably the energy) can be extracted from the state. The distribution of states created by the TETRIS algorithm agree with the exact time-evolved state only up to the first moment. Namely, it produces unitary operators U that statistically average to the time evolution operator e^{iHt}, but quantities quadratic in U like U^{†} [symbol] U with some operator [symbol] do not average to e^{-iHt} [symbol] e^{iHt}. This renders impractical many techniques developed for measuring the energy when the state is prepared using e.g., VQE. Our second main contribution is to overcome this challenge by developing three approaches to efficiently measure arbitrary observables in a state prepared by the TETRIS method. Remarkably, the measurement techniques are resilient to noise, and we show that the combined programme of adiabatic state preparation plus measurement yields chemically accurate results on a 4-qubit problem using 100′000<(1e−3)⁻² shots on a noisy quantum computer with errors modeled by depolarising noise on two-qubit gates with fidelity 99.82% and without error mitigation apart from trivial symmetry filtering.

To summarise, the two-step method we propose is depicted in FIGS. 1A and 1B and consists of:
an adiabatic preparation of the ground state [symbol] |ini [symbol] where |ini [symbol] is some initial state and [symbol] the operator implementing the adiabatic path. Using the algorithm of [1], this step can be implemented without any discretization error heating.
an energy measurement to determine the energy of the state [symbol] |ini [symbol] . We propose three different related methods: a binary search approach, an arctan fit approach, and a Robbins-Monro approach. These three methods possess some built-in noise resilience.

This patent specification is organized as follows. We start in Section 2 with a quick description of the setup encountered in quantum chemistry applications of quantum computing. In Section 3, we present the algorithm of [1] to implement time evolution under a time-dependent Hamiltonian. We discuss how to best choose the parameters of the algorithm and give some runtime estimate for ASP. In Section 4 we then discuss how to best measure the energy of the state that we prepared adiabatically. We introduce three different approaches for the computation of the energy. Then in Section 5 we do a resource estimate of the algorithm to reach chemical precision in multiple chemical systems. In particular we investigate the scaling with system size of the time that is required to perform ASP. Then in Section 6 we present some noisy simulations of the algorithm. Finally, Section 7 provides a summary of the findings and conclusions.

### 2. Setup and Notations

Quantum chemistry aims at computing the ground state energy of molecules [34]. These are described by the following Hamiltonian

$$H = - {\sum }_{i} \frac{{\partial }_{{R}_{i}}^{2}}{2 {M}_{i}} - {\sum }_{j} \frac{{\partial }_{{r}_{j}}^{2}}{2} - {\sum }_{i , j} \frac{{Z}_{i}}{\vert {R}_{i} - {r}_{j} \vert} + {\sum }_{{i}_{1} < {i}_{2}} \frac{{Z}_{{i}_{1}} {Z}_{{i}_{2}}}{\vert {R}_{{i}_{1}} - {R}_{{i}_{2}} \vert} + {\sum }_{{j}_{1} < {j}_{2}} \frac{1}{\vert {r}_{{j}_{1}} - {r}_{{j}_{2}} \vert} , \qquad ( 1 )$$

where Rᵢ, rⱼ, Mᵢ, Zᵢ are respectively the positions of the nuclei, the positions of the electrons, the masses of the nuclei and the charges of the nuclei, written here in atomic units. The movement of the nuclei can usually be neglected with the Born-Oppenheimer approximation [34], leaving only electronic degrees of freedom rⱼ and a parametric dependence of the ground state energy in the nuclei positions Rᵢ. The Hilbert space associated to this Hamiltonian is infinite-dimensional, and has to be discretized in some way to be implemented on a computer (whether classical or quantum). Approaches referred to as “first quantization” discretize space [35-37], while “second quantization” methods project the Hilbert space onto linear combinations of a finite number of well-chosen states that approximate equilibrium configurations, called basis set. In this patent specification we will consider the second quantization approach, which is the most studied. Here, the Hamiltonian is (approximately) written as

$$H = {\sum }_{p , q = 1}^{L} {h}_{pq} {c}_{p}^{†} {c}_{q} + {\sum }_{p , q , r , s = 1}^{L} {h}_{pqrs} {c}_{p}^{†} {c}_{q}^{†} {c}_{r} {c}_{s} , \qquad ( 2 )$$

where L is the number of orbitals (which depends on the basis set), h_{pq}, h_{pqrs} are real coefficients, and cₚ,

$${c}_{p}^{†}$$

are fermionic operators satisfying canonical anticommutation relations

$$\{ {c}_{p} , {c}_{q}^{†} \} = {δ}_{p , q} and \{ {c}_{p} , {c}_{q} \} = 0 .$$

To be implemented on a quantum computer, this second-quantized Hamiltonian must be written in terms of Pauli matrices X, Y, Z. This can be done through different mappings [38-40]. We will consider the widely used Jordan-Wigner transformation

$${c}_{p} = \frac{1}{2} ( {X}_{p} + i {Y}_{p} ) {Z}_{p - 1} {Z}_{p - 2} … {Z}_{1} . \qquad ( 3 )$$

Once the Hamiltonian H is written in terms of Pauli matrices, our objective is to determine its ground state with some precision €. In chemistry applications, this precision is very often set to 1.6·10⁻³=1.6 mH, called chemical accuracy, which corresponds approximately to the accuracy achieved in experiments [41]. We will take the precision to be 10⁻³ for simplicity. We note that in this patent specification we will not be concerned with the accuracy of the basis set: the precision we wish to achieve is with respect to the ground state of the (approximated, truncated) Hamiltonian H expressed in a finite basis set, not with respect to original infinite-dimensional Hamiltonian. This is referred to as chemical precision [42].

### 3. Adiabatic Preparation

### 3.1. Adiabatic Path

In this Section, we present the first step of our proposal, which is the adiabatic preparation of the ground state of H. Adiabatic State Preparation (ASP) relies on the adiabatic theorem of quantum mechanics, which roughly states that if parameters of the Hamiltonian are varied slowly enough, a system initially in the ground state will remain in the ground state of the time-dependent Hamiltonian at all times [43-45]. Specifically, one considers a time-dependent Hamiltonian H(u) for 0≤u≤1, and an initial state |ini [symbol] , such that:
(i) |ini [symbol] is the ground state of H(0),
(ii) the final time Hamiltonian H(1) is the target Hamiltonian H, and
(iii) for all u, H(u) is gapped (i.e. there is a clear separation or gap between the ground state energy and the first excited state energy).

Then, evolving |ini [symbol] with the time-dependent Hamiltonian H(t/T) from t=0 to t=T (where t is the actual physical time, and T the total simulation time, and u is equal to t/T), one prepares a state [symbol] (T)|ini [symbol] that becomes closer to the ground state of H as T grows larger. T is a parameter that controls the speed of the adiabatic evolution, but which is fixed for every simulation run. To implement an exact adiabatic evolution, a large T should be chosen. The convergence of the energy of [symbol] (T)|ini [symbol] is typically polynomial in 1/T, but can be exponential in T if the path is smooth enough [46-48]. The time needed then scales as the inverse square of the smallest gap of H(u) along the path [49]. The operator [symbol] (T) that implements this time evolution under a time-dependent Hamiltonian can be written with the following time-ordered exponential

$$𝒜 ( T ) = 𝒯 exp ( i {\int }_{0}^{T} H ( \frac{t}{T} ) dt ) . \qquad ( 4 )$$

There are many valid paths H(u) that can be considered for ASP. In our case, we will assume the simple following setting that is well adapted to quantum chemistry Hamiltonians. We split H into two terms

$$H = {H}_{B} + {H}_{I} , \qquad ( 5 )$$

where the ground state of the background Hamiltonian H_{B} contains only Z Pauli matrix terms. More generally, one could consider any Hamiltonian H_{B} but the adiabatic state preparation method is most helpful if the ground state of this Hamiltonian is relatively easy to prepare on a quantum computer (i.e. the preparation of the ground state of H_{B} should require far fewer gates than the adiabatic evolution itself). We decompose then the interaction Hamiltonian H_{I} that contains the remaining terms into Pauli strings

$${H}_{I} = {\sum }_{n = 1}^{{N}_{I}} {c}_{n} {P}_{n} , \qquad ( 6 )$$

with Pₙ∈±{I, X, Y, Z}^{⊗L} and cₙ real coefficients. Up to flipping Pₙ into −Pₙ, we can assume cₙ≥0. For notational convenience, we will denote as well

$${H}_{B} = {\sum }_{n = {N}_{I} + 1}^{N} {c}_{n} {P}_{n} , \qquad ( 7 )$$

where here Pₙ are strings of Z Pauli matrices at some sites times a ±sign, and with N the total number of terms in the Hamiltonian H. Then we take the initial state |ini [symbol] as the ground state of H_{B}, which can always be prepared efficiently on a quantum computer as it is a product state (i.e. a tensor product of states on every qubit; it can be prepared efficiently as one can just apply one-qubit gates on every qubit, starting from | 000>). For a given weight function (or path) w(u)≥0 such that w(0)=0 and w(1)=1, we then set

$$H ( u ) = {H}_{B} + w ( u ) {H}_{I} . \qquad ( 8 )$$

This adiabatic path could be refined by e.g. setting a different weight w(u) for every Pauli string in H_{I}. However, the adiabatic path can be implemented with a single weight function for all terms and this simpler implementation is the example described in this patent specification.

3.2. Algorithm for Implementing [symbol] (T)Lg

The operator [symbol] (T) can be implemented exactly with a finite circuit depth on a quantum computer, using the randomization algorithm introduced in Appendix 1 of this patent specification and in [1]. To present this algorithm, we define

$$z ( u ) = {\int }_{0}^{u} w ( {u}^{′} ) {du}^{′} , \qquad ( 9 )$$

as well as z⁻¹(u) the reciprocal function of the increasing function z(u), namely such that z⁻¹(z(u))=u for all u. We will denote

$$ζ = z ( 1 ) = {\int }_{0}^{1} w ( {u}^{′} ) {du}^{′} , \qquad ( 10 )$$

which is of order [symbol] (1). The algorithm takes as a parameter a gate angle 0<τ<π/2. It consists of the following steps.
1. Initialize the state of the system |ψ [symbol] to |ini [symbol] .
2. For n=1, . . . , N_{I}, draw an integer mₙ≥0 from a Poisson distribution with parameter

$$\frac{{c}_{n} ζ T}{sin τ} .$$

3. For n=1, . . . , N_{I}, draw mₙ real numbers \tilde{t}_{i,n} (with i=1, . . . , mₙ), independently and uniformly at random between 0 and ζ. For every i, n, set t_{i,n}=T z⁻¹(\tilde{t}_{i,n}).
4. For n=N_{I}+1, . . . , N, draw an integer mₙ≥0 from a Poisson distribution with parameter

$$\frac{{c}_{n} T}{sin τ} .$$

5. For n=N_{I}+1, . . . , N, draw mₙ real numbers t_{i,n} (with i=1, . . . , mₙ), independently and uniformly at random between 0 and T.
6. Find the sequence (i₁, n₁), . . . , (i_{M}, n_{M}) such that

$$0 < {t}_{{i}_{1} , {n}_{1}} < … < {t}_{{i}_{M} , {n}_{M}} < T , where M = {\sum }_{n = 1}^{N} {m}_{n} . \qquad ( 11 )$$

7. For m=1, . . . , M, apply the operator

$$exp ( i τ {P}_{{n}_{m}} ) \qquad ( 12 )$$

on the state |ψ [symbol] .

Let us denote U the random unitary operator that is generated with this process. The result of [1] is that

$$𝔼 [ U ] = {e}^{- tan ( τ / 2 ) T ( ζ {μ}_{I} + {μ}_{B} )} 𝒜 ( T ) , \qquad ( 13 )$$

where [symbol] denotes the statistical average with respect to U, and with μ_{I}, μ_{B} the 1-norm of the interaction/background Hamiltonian

$${μ}_{I} = {\sum }_{n = 1}^{{N}_{I}} {c}_{n} , \qquad ( 14 )$$

$${μ}_{B} = {\sum }_{n = {N}_{I} + 1}^{N} {c}_{n} .$$

We will call attenuation factor the term

$$λ = {e}^{- tan ( τ / 2 ) T ( ζ {μ}_{I} + {μ}_{B} )} . \qquad ( 15 )$$

In each random realization U, there are in average

$$\frac{{c}_{n} ζ T}{sin τ}$$

gates e^{iτP}^{ₙ} in the circuit for n=1, . . . , N_{I}, and

$$\frac{{c}_{n} T}{sin τ}$$

gates e^{iτP}^{ₙ} tor n=N_{I}+1, . . . , N. Let us denote gₙ the number of two-qubit gates that is required to implement e^{iτP}^{ₙ}. Then the average number of two-qubit gates in the circuit is

$${N}_{TQG} = \frac{T}{sin τ} ( ζ {\sum }_{n = 1}^{{N}_{I}} {g}_{n} {c}_{n} + {\sum }_{n = {N}_{I} + 1}^{N} {g}_{n} {c}_{n} ) , \qquad ( 16 )$$

which is finite even though the exact adiabatic preparation is implemented on average.
3.3. Improvement of the Algorithm for Implementing [symbol] (T)Lg

The algorithm of Section 3.2 possesses the following improvement in the case where the time evolution with respect to the background Hamiltonian H_{B} can be implemented with just a finite number of gates, namely when e^{iτH}^{_{B}} can be decomposed exactly as a finite product of gates on the quantum computer. This improvement is called the background Hamiltonian technique [1]. It consists in applying continuously the time evolution with respect to H_{B}, and randomizing only the time evolution with respect to the interaction Hamiltonian H_{I}. The upside is that the attenuation factor λ involves only μ_{I} the 1-norm of the interaction Hamiltonian.

This improved algorithm takes as a parameter a gate angle 0<τ<π/2, and consists of the following steps:
1. Initialize the state of the system |ψ [symbol] to |ini [symbol] .
2. For n=1, . . . , N_{I}, draw an integer mₙ≥0 from a Poisson distribution with parameter

$$\frac{{c}_{n} ζ T}{sin τ} .$$

3. For n=1, . . . , N_{I}, draw mₙ real numbers \tilde{t}_{i,n} (with i=1, . . . , mₙ), independently and uniformly at random between 0 and ζ. For every i, n, set t_{i,n}=T z⁻¹(\tilde{t}_{i,n}).
4. Find the sequence (i₁, n₁), . . . , (i_{M}, n_{M}) such that

$$0 < {t}_{{i}_{1} , {n}_{1}} < … < {t}_{{i}_{M ,} {n}_{M}} < T , \qquad ( 17 )$$

$$where$$

$$M = {\sum }_{n = 1}^{{N}_{I}} {m}_{n} .$$

5. For m=1, . . . , M, apply the operator

$$exp ( i τ {P}_{{n}_{m}} ) exp ( i ( {t}_{{i}_{m} , {n}_{m}} - {t}_{{i}_{m - 1} , {n}_{m - 1}} ) {H}_{B} ) \qquad ( 18 )$$

$$on the state \vert ψ 〉 , with {t}_{{i}_{0} , {n}_{0}} ≡ 0.$$

6. Apply

$${e}^{i ( T - {t}_{{i}_{M} , {n}_{M}} ) {H}_{B}}$$

on the state |ψ [symbol] .

Let us denote U the random unitary operator that is generated with this process. The result of [1] is that

$$𝔼 [ U ] = {e}^{- tan ( τ / 2 ) ζ T {μ}_{I}} 𝒜 ( T ) , \qquad ( 19 )$$

where [symbol] denotes the statistical average with respect to U. In that case, we will call attenuation factor the term

$$λ = {e}^{- tan ( τ / 2 ) ζ T {μ}_{I}} . \qquad ( 20 )$$

In each random realization U, there are in average

$$\frac{{c}_{n} ζ T}{sin τ}$$

gates e^{iτP}^{ₙ} in the circuit. Let us denote gₙ the number of two-qubit gates that is required to implement e^{iτP}^{ₙ}. Then the average number of two-qubit gates in the circuit is

$${N}_{TQG} = \frac{ζ T {μ}_{I} g}{sin τ} , \qquad ( 21 )$$

$$g = \frac{{\sum }_{n = 1}^{{N}_{I}} {c}_{n} {g}_{n}}{{\sum }_{n = 1}^{{N}_{I}} {c}_{n}} ,$$

which is again finite.

### 3.4. Choice of Gate Angle

### 3.4.1. Optimal Gate Angle on a Noiseless Quantum Computer

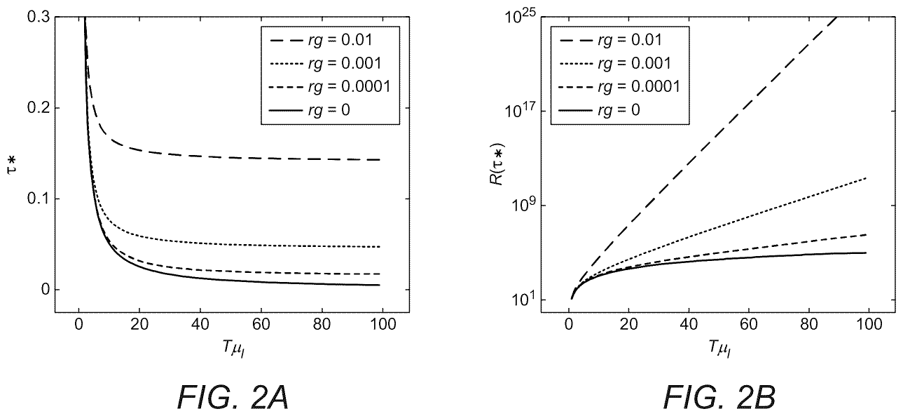

FIGS. 2A and 2B show the relationship between optimal gate angle (FIG. 2A) and minimum total runtime (FIG. 2B) for different values of noise. FIG. 2A shows the optimal gate angle τ, and FIG. 2B shows the minimal total runtime R(τ_{*}) as a function of T_{μ}_{_{I}}, with ζ=1, for different values of noise rg. Total runtime corresponds to the number of shots times the number of two-qubit gates per shot, to get a precision [symbol] (1) on the result. The total runtime to get a precision [symbol] (ϵ) on the result is R(τ)/ϵ².

The gate angle τ is here a free parameter of the algorithm, which does not change the precision on the result. Increasing τ reduces the number of two-qubit gates N_{TQG}, so reduces the runtime of every random circuit. However, it also makes the attenuation factor λ smaller. This attenuation factor increases the number of shots required to reach a certain precision. Indeed, because we have to divide the amplitude measured on the quantum computer by λ, the number of shots required to have a precision ϵ on the result is (ϵλ)⁻². We elaborate on this fact in Section 5.3 below. This means that for the same precision we have to run more shots of the same circuit as τ increases. Hence, the total runtime at fixed precision, i.e. the product of runtime of each circuit and number of shots per circuit, has a non-trivial behaviour with the gate angle τ and reaches a minimum at some optimal τ_{*}. This optimal gate angle τ_{*} moreover depends on the task that we wish to fulfil. Let us consider for example the problem of measuring an observable [symbol] within the adiabatically evolved state [symbol] (T)|ini [symbol] . Using the above protocol, we can write

$$〈 ini \vert {𝒜 ( T )}^{†} 𝒪𝒜 ( T ) \vert ini 〉 = {λ}^{- 2} {𝔼}_{{U}_{1} , {U}_{2}} [ 〈 ini \vert {U}_{2}^{†} 𝒪 {U}_{1} \vert ini 〉 ] , \qquad ( 22 )$$

where the circuits U₁, U₂ are drawn independently from the previous protocol. Importantly, the backward and forward propagations that are randomly drawn do not (at least not necessarily) coincide U₁≠U₂, so the amplitude

$$〈 ini \vert {U}_{2}^{†} 𝒪 {U}_{1} \vert ini 〉$$

has to be measured explicitly on the quantum computer with for example a Hadamard test. This means that both U₁ and U₂ have to be implemented explicitly, so that the total number of two-qubit gates (not taking into account those possibly entering [symbol] ) is 2N_{TQG}. Each of the two averages over U₁, U₂ contributes with an attenuation factor λ, so that the total attenuation is λ². On a perfect quantum computer, one thus has to run λ⁻⁴ many circuits to obtain a precision [symbol] (1) on the result, and λ⁻⁴ϵ⁻² to obtain a precision ϵ. Hence the total number of two-qubit gates to run (across different circuits) to get precision ϵ is R(τ)/ϵ², with R(τ)=2N_{TQG}λ⁻⁴. Explicitly, this factor R(τ) is

$$R ( τ ) = \frac{2 ζ T {μ}_{I} g}{sin τ} exp ( 4 tan ( τ / 2 ) ζ T {μ}_{I} ) . \qquad ( 23 )$$

We recall that R(τ)/ϵ² is the total number of two-qubit gates to run to reach precision ϵ, but each circuit has only 2N_{TQG} two-qubit gates, independently of ϵ.

This total runtime reaches a minimum at some τ_{*}. Imposing ∂_{τ}R(τ_{*})=0, we find at large T_{μ}_{_{I}} [1]

$${τ}_{*} = \frac{1}{2 ζ T {μ}_{I}} , R ( {τ}_{*} ) = 𝒪 ( {T}^{2} {μ}_{I}^{2} ) . \qquad ( 24 )$$

Intuitively, in absence of noise, one should choose the largest possible t to reduce the number of two-qubit gates in each circuit, while still keeping an attenuation factor A of order [symbol] (1). This gives τ= [symbol] (1/(T_{μ}_{_{I}})).

### 3.4.2. Optimal Gate Angle on a Noisy Quantum Computer

This “total runtime” count holds for a perfect, noiseless quantum computer where every gate can be executed perfectly. However, in any hardware in the near future, noise cannot be neglected and is a crucial aspect to take into account in quantum computing algorithms. We are going to make the assumption that because of the imperfect hardware, the measured expectation value is multiplied by e^{-r} with r>0 for every two-qubit gate present in the circuit. This e^{-r} is called the effective two-qubit gate fidelity. This noise model is of course a crude approximation of actual hardware noise, which is much more complex and platform-dependent. However, it is known to give a rough first estimate and there are several noise mitigation techniques such as Probabilistic Error Cancellation that can convert any noise occurring in the hardware into this kind of global depolarizing noise [50,51]. We note that even with quantum error correction, the noise level r would not be exactly equal to 0, so this discussion is also relevant beyond the NISQ era. As long as rgₙ is small (if rgₙ is not small a single gate e^{iτP}^{ₙ} would be too noisy to implement), the noise can then be assumed to multiply the measured amplitude by a factor ˜q=e^{-rN}^{_{TQG}}. This has the same effect as the attenuation factor λ and increases the number of shots required to reach a given precision. Hence, the total runtime with a noise parameter r is

$$R ( τ ) = \frac{2 ζ T {μ}_{I} g}{sin τ} exp ( \frac{4 r ζ T {μ}_{I} g}{sin τ} + 4 tan ( τ / 2 ) ζ T {μ}_{I} ) . \qquad ( 25 )$$

Let us write an equation for the gate angle τ_{*} that minimizes R(τ). The quantity x=tan(τ_{*}/2) satisfies the quartic equation

$${x}^{4} ( 4 + 2 rg ) ζ T {μ}_{I} - {x}^{3} + 4 {x}^{2} ζ T {μ}_{I} + x - 2 r ζ T {μ}_{I} g = 0. \qquad ( 26 )$$

If we set r=0, at large T_{μ}_{_{I}} we recover the previous noiseless result. In the presence of noise r>0, the behaviour of τ_{*} at large T_{μ}_{_{I}} is completely different. We find at large T_{μ}_{_{I}}

$${τ}_{*} = \sqrt{2 rg} , R ( {τ}_{*} ) = 𝒪 ( {e}^{4 \sqrt{2 rg} ζ T {μ}_{I}} ) . \qquad ( 27 )$$

In the presence of noise, the argument of the exponential appearing in R(τ) cannot be kept constant when T_{μ}_{_{I}}→∞. The optimal gate angle depends only on the noise factor r, and the runtime is exponential in T_{μ}_{_{I}}, with an exponent proportional to \sqrt{r}.

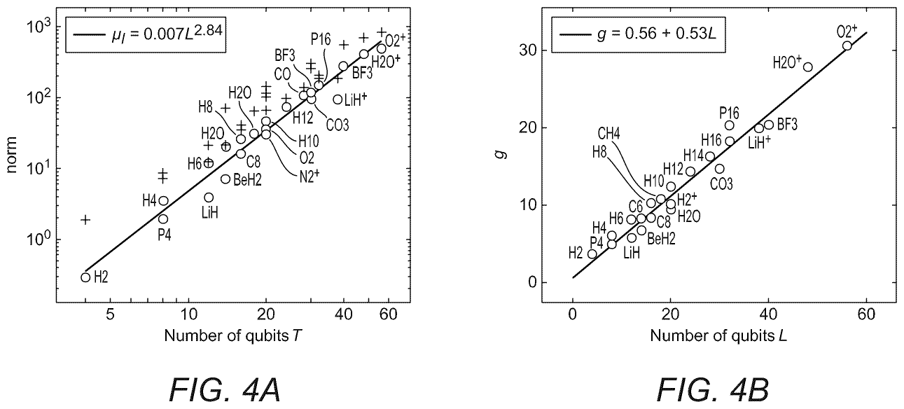

In FIG. 2, we show the behaviour of the optimal gate angle τ_{*} and the corresponding minimal runtime R(τ_{*}) as a function of T_{μ}_{_{I}}, for different amounts of noise r. To give concrete numbers, r≈2·10⁻³ for current state-of-the-art two-qubit gates [33], while the average number of two-qubit gates per rotation g is roughly g≈L/2 where L is the number of qubits, see FIG. 4 below.

### 3.5. Techniques for Reducing the Norm μ_{I}Lg

In terms of system size, the cost of the algorithm depends only on the 1-norm μ_{I} of the interaction Hamiltonian. It differs from a Trotter decomposition that depends on the number of terms in the Hamiltonian, and also from Linear Combination of Unitaries techniques, as well as other randomization techniques such as qDRIFT, which depend on the 1-norm of the entire Hamiltonian. Contrary to the 2-norm, the 1-norm is basis-dependent. There can thus be decompositions of the same Hamiltonian that have different interaction norms μ_{I}. Since the cost of implementing the time evolution for time t is a function of tμ_{I}, it is valuable to use a decomposition that reduces this norm μ_{I}.

There exist different techniques to decrease the 1-norm. In particular, in the context of chemistry applications, one can perform a unitary transform on the orbital basis that minimizes the 1-norm, instead of minimizing the energy of the Hartree-Fock state [32]. This classical pre-processing of the Hamiltonian scales polynomially with the number of orbitals. According to [32], it can for example modify the scaling with system size of the 1-norm of the Hamiltonian corresponding to a hydrogen chain, which then scales as ˜L^{1.4} with L the number of hydrogen atoms, instead of ˜L^{2.1} in the Hartree-Fock optimized basis.

Another cheap way of reducing the 1-norm is to make use of exact symmetries in the Hamiltonian. It is well-known that symmetries can be used to reduce the number of qubits, with a process called tapering [52]. However, it does not necessarily reduce the 1-norm of the Hamiltonian, which is the only relevant system-size-related parameter in the TETRIS algorithm. Instead, given a conserved quantity Q, i.e. an operator that commutes with the Hamiltonian [H, Q]=0, one can always add a multiple of Q to form a new Hamiltonian H′

$${H}^{′} = H - α Q , \qquad ( 28 )$$

that has the same eigenstates as H with eigenvalues trivially shifted by their eigenvalue on −αQ. In the quantum chemistry application case, particle number Nₚₐᵣₜ is a conserved quantity. We find that setting

$$Q = {N}_{part}^{2}$$

the square of the number of particles, and taking α so as to minimize μ_{I}, can significantly reduce the norm μ_{I}. When using the Jordan-Wigner transformation for the encoding, one finds in that case that the optimal choice of α is given by the median value of the coefficients cₙ in front of Pauli strings with exactly two Z's. In the molecules that we consider below in this patent specification, we systematically use this trick to reduce the norm of the Hamiltonian.

### 4. Measuring the Energy

### 4.1. Generalities

The algorithm that we presented in Section 3 enables us to prepare (an approximation of) the ground state of the Hamiltonian

$$\vert ψ ( T ) 〉 = 𝒜 ( T ) \vert ini 〉 . \qquad ( 29 )$$

We now need to decide how to best measure this state and retrieve information in order to fulfill a certain task. In our case, we are interested in evaluating the energy of the state that we prepared

$$E ( T ) = 〈 ψ ( T ) \vert H \vert ψ ( T ) 〉 . \qquad ( 30 )$$

The simplest approach to compute E(T) is to measure individually every Pauli string in the Hamiltonian H. A Pauli string with a small coefficient cₙ requires fewer shots to obtain a certain fixed precision on the total energy. At a fixed total number of shots, the optimal strategy is to spend a number of shots to measure Pₙ that is proportional to cₙ [32, 53]. This way, in order to have a precision e on the result, the number of shots M_{S} that is required is

$${M}_{S} = \frac{{μ}^{2}}{{ϵ}^{2}} , \qquad ( 31 )$$

where μ is the 1-norm of the total Hamiltonian

$$μ = {\sum }_{n = 1}^{N} {c}_{n} = {μ}_{I} + {μ}_{B} . \qquad ( 32 )$$

This approach has two shortcomings. Firstly, it is very sensitive to noise on an imperfect hardware. With this approach, obtaining a precision of order 10⁻³ would inevitably require to bring the noise in the signal below 10⁻³. Secondly, with this approach, one necessarily computes all the bits in the binary decomposition of the energy E(T), including those that can be obtained classically by exact or approximate methods. To make a better use of scarce quantum computing resources, one would like to be able to compute only the most precise bits that are beyond reach of classical methods. Moreover, the noise will not affect the bits that are easy to compute classically, and will completely blur the bits that require quantum computation.

### 4.2. Measuring the Energy Through Time Evolution

### 4.2.1. QPE Techniques

In order to explain the present improved method to compute the energy of the state |ψ(T) [symbol] , we briefly review Quantum Phase Estimation (QPE) [54, 55] below, and then describe an optimisation. QPE is an algorithm to measure the eigenvalue of an eigenvector |ψ [symbol] of a unitary operator U, that requires only [symbol] (log 1/ϵ) shots and a circuit depth [symbol] (1/ϵ) to reach a precision ϵ. In our case we could apply QPE to measure the energy of the state |ψ [symbol] assumed to be the ground state, by taking U=e^{iH}. The algorithm works as follows. It takes as input a unitary operator U, an eigenvector |ψ [symbol] and a target precision ϵ=2⁻ⁿ for some integer n, and returns n bits of the binary decomposition of x where e^{2iπx} is the eigenvalue of U. Firstly, it prepares n ancilla qubits in the state |+ [symbol] . Then it performs sequentially n controlled-U²^{^{m}} operations between the system and the ancillas for m=1, . . . , n, followed by an inverse Quantum Fourier Transform (QFT) on the ancillas. Finally, measuring the ancillas exactly provides the bits of the binary decomposition of x.

What makes QPE able to yield a drastic reduction of the number of shots compared to measuring all the terms in H is the time evolution. Measuring e^{iH} does not have a notable precision change compared to measuring H. However, if we measure the eigenvalue of e^{isH} instead of e^{iH} for some s>0, we only need a precision se on the eigenvalue of e^{isH} in order to have a precision ϵ on the eigenvalue of e^{iH} (or more precisely on its value modulo 2π/s). If one takes s=1/ϵ, one only requires [symbol] (1) shots to reach a precision ϵ. To be more concrete, we can describe the following “iterative” version of QPE [56, 57]. Let us assume that 0≤x<1 the eigenvalue of H on |ψ [symbol] has an exact binary decomposition x=0. b₁ . . .

$${b}_{n} = {\sum }_{k = 1}^{n} \frac{{b}_{k}}{{2}^{k}}$$

with n bits bᵢ∈{0,1}. If we measure

$$𝔍 〈 ψ ( T ) \vert {e}^{2 i {π2}^{n - 1} ( H - {2}^{- n - 1} )} \vert ψ ( T ) 〉 , \qquad ( 33 )$$

we obtain a measurement outcome +1 with probability 1 if bₙ=1, and −1 with probability 1 if bₙ=0. Then, we shift

$${H}^{′} = H - \frac{{b}_{n}}{{2}^{n}} .$$

If we measure

$$𝔍 〈 ψ ( T ) \vert {e}^{i 2 π {2}^{n - 2} ( {H}^{′} - {2}^{- n} )} \vert ψ ( T ) 〉 , \qquad ( 34 )$$

we obtain +1 with probability 1 if bₙ₋₁=1, and −1 if bₙ₋₁=0. Proceeding repeatedly, we can measure all the bits b₁, . . . , bₙ. The downside of this “iterative” version of QPE is that one needs to have an exact eigenstate of H, and not an approximation, whereas QPE would succeed for general states with a probability proportional to the overlap of the state that we have with the target eigenstate. However, the upside of this approach is that one only requires to run n separate circuits each containing only one controlled time evolution, instead of one circuit containing n sequential controlled time evolutions [56]. It reduces thus the circuit depth, which is valuable for current and near-term devices where gates have a moderate level of noise.

### 4.2.2. Binary Search Approach

The previous “iterative QPE” approach reduces the circuit depth compared to the original QPE. However, the times during which one needs to evolve the system are still large, of order 10³ to get chemical precision. On current-day devices, these very deep circuits are not feasible. In fact, the approach can be further simplified. When measuring (33) to determine the n-th bit of the energy, one does not necessarily need to do a time evolution up to time 2ⁿ⁻¹ Assuming knowing the bits b₁, . . . , bₙ₋₁, in order to determine the bit bₙ, one only needs to time evolve sufficiently long and take enough shots to be able to distinguish whether the eigenvalue after removing the bits b₁, . . . , bₙ₋₁ is below or above 2⁻ⁿ⁻¹. This observation suggests the following approach. Instead of seeking to measure H, we wish to answer the following question:

$$Given an energy E and an eigenstate \vert ψ 〉 , is its eigenvalue below or above E ? \qquad ( 35 )$$

By performing a binary search, one only needs to answer [symbol] (log 1/ϵ) questions (35) to locate with precision e the energy of the state |ψ [symbol] . Moreover, each answer to (35) provides one bit of information about the ground state. Contrary to measuring H directly, here we can choose which bit of information we want to measure.

Each of these yes/no questions (35) can be answered by measuring the quantity

$$ρ ( s ) = 𝔍 〈 ψ \vert {e}^{is ( E - H )} \vert ψ 〉 . \qquad ( 36 )$$

We will call the time s “central time”, to distinguish it from the adiabatic preparation time T. Let us denote δ=E−E_{GS} where E_{GS} is the energy of the state |ψ [symbol] that we are looking for. To answer question (35), one only needs to decide whether ρ(s) is positive or negative where

$$0 < s < \frac{π}{\vert δ \vert} .$$

The actual value of ρ(s) beyond its sign is irrelevant.

To that end, we wish to choose s so as to maximize the measured value of ρ(s). This would both (i) minimize the number of shots required to claim that ρ(s) is either positive or negative, and (ii) maximize the resilience to noise, as a larger ρ(s) would make it less likely to have its sign flipped because of noise. We will take into account the effect of noise in determining the optimal choice of the central time s. Under the same assumptions as in Section 3.4.2, the measured ρₘₑₛ(s) can be written as

$${ρ}_{mes} ( s ) = C sin ( s δ ) {e}^{- su} , \qquad ( 37 )$$

$$where$$

$$C = exp ( - \frac{2 r ζ T {μ}_{I} g}{sin τ} - 2 tan ( τ / 2 ) ζ T {μ}_{I} ) \qquad ( 38 )$$

is a τ-dependent factor that takes into account the adiabatic preparation of |ψ [symbol] , and where u depends on the gate angle τ as

$$u ( τ ) = \frac{rg {μ}_{I}}{sin τ} + tan ( τ / 2 ) {μ}_{I} . \qquad ( 39 )$$

The value of the central time s_{*} that maximizes ρₘₑₛ(s) is

$${s}_{*} = \frac{1}{δ} arc tan \frac{δ}{u} . \qquad ( 40 )$$

Since δ is unknown, this optimal value cannot be chosen exactly. Computing the derivative of s_{*} with respect to δ, and using that

$$arctan ( x ) \geq \frac{x}{1 + {x}^{2}} for x \geq 0 ,$$

we find that s_{*} is a decreasing function of |δ|. Its maximal value is 1/u(τ). Moreover, within the binary search approach described above, after m searches we have located the ground state with precision 2^{-m}, so we know that |δ|≤2^{-m}. Hence, assuming we have |δ|≤8, for some known initial guess δ₀>0, we deduce the following bound

$$\frac{1}{{δ}_{0}} arc tan \frac{{δ}_{0}}{u} \leq {s}_{*} \leq \frac{1}{u} , \qquad ( 41 )$$

which depends only on known factors. In the following, we will set the central time equal to the lower bound

$$s ( τ ) = \frac{1}{{δ}_{0}} arctan \frac{{δ}_{0}}{u ( τ )} . \qquad ( 42 )$$

The total number of two-qubit gates in the circuit is

$${N}_{TQG} = ( 2 ζ T + s ) \frac{{μ}_{I} g}{sin τ} . \qquad ( 43 )$$

Hence it follows that the total runtime

$${R}_{δ , {δ}_{0}}^{Q} ( τ )$$

to answer one question (35), assuming we know a bound |δ|≤δ₀, is

$${R}_{δ , {δ}_{0}}^{Q} ( τ ) = \frac{s ( τ ) + 2 ζ T}{{sin}^{2} [ s ( τ ) δ ]} \frac{{μ}_{I} g}{sin τ} exp [ 2 ( s ( τ ) + 2 ζ T ) u ( τ ) ] , \qquad ( 44 )$$

with s(τ) given in (42) and u(τ) in (39). We recall that this total runtime is the number of two-qubit gates per circuit times the number of circuits to run.

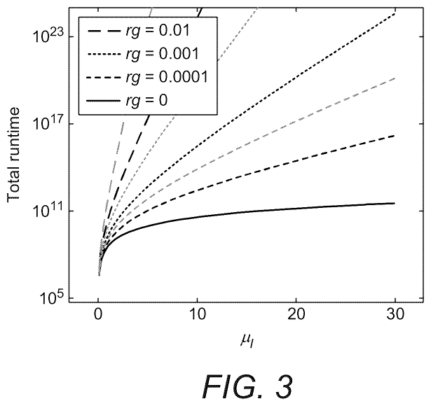

In FIG. 3, we plot the estimate of the total runtime to get chemical precision 1 mH with this binary search approach. Specifically, we plot the minimum with respect to the gate angle τ of

$$10 {R}_{δ , {δ}_{0}}^{Q} ( τ )$$

for δ=δ₀=10⁻³, with g=10, ζ=½, T=10, as a function of μ_{I}. This value of δ corresponds to the last step of the binary search (when one already knows the location of the ground state within 2 mH), and the factor 10 is a rough (over) estimate of the cost of previous steps. The analytical value of the total number of CNOTs to run to get chemical precision at large μ_{I}T on noiseless hardware is

$$10 {R}_{δ , δ}^{Q} ( τ ) = 10 eg {{μ}_{I}^{2} ( \frac{π}{2 δ} + 2 ζ T )}^{2} , \qquad ( 45 )$$

with δ=10⁻³. In Section 6 below, we will present noisy implementations of this approach, and show that after simple noise mitigation the sign of the measured amplitude is indeed not affected by the noise.

FIG. 3 provides an estimate of the minimal total runtime to get chemical precision with the binary search approach, as a function of μ_{I}, with ζ=½, g=10, for different values of noise r. The darker lines are obtained with T=10 and the lighter lines with T=20 (darker and lighter lines are essentially superimposed for r=0). Total runtime is given in units of number of shots times number of two-qubit gates per shot, i.e. they are related to real runtimes by multiplying by the average duration of a two-qubit gate and dividing by the average number of gates that can are executed in parallel. The values plotted are upper bounds. As an example, the values of μ_{I} for chromium dimer in a STO-3G basis or FeMoCo with an active space of 50 states are around μ_{I}≈10³.

### 4.2.3. Arctan Fit Approach

The approach we presented in Section 4.2.2 above spares circuit depth compared to the “iterative” QPE by running a central time evolution e^{is(H-E)} with s just large enough so that the sign of the amplitude can be obtained. This allows one to answer the question (35), namely whether the ground state energy is below or above E. We argued that this approach is noise-resilient because noise, while certainly affecting the measured value of ρ(s) would be less likely to flip the sign of ρ(s), especially when s is large enough.

An improvement can be made further if the noise is mild enough to be described by a simple depolarizing channel. Namely, we make the following assumptions. Firstly, (i) we assume that the effect of the noise does not depend on δ. This is a reasonable assumption as δ only enters as a phase in ρ(s). If, for example, we compute ρ(s) using a Hadamard test, the circuit depends on δ only through one single-qubit rotation. Secondly, (ii) we assume that the effect of the noise is just to multiply the measured ρ(s) by some positive factor q(s). This means that noise only acts as a global depolarizing channel. We justified this assumption in Section 3.4.2 by pointing out that depolarising channels are the dominant sources of noise in many current hardware platforms and by referring to existing noise mitigation techniques that convert non-depolarizing noise into global depolarizing noise, like for example Probabilistic Error Cancellation [50, 51].

This provides a significant advantage over known techniques. Under these assumptions, although noise will affect individual amplitudes ρ(s), it will not affect the value of E where ρ(s) vanishes (which is the ground state energy). We will test numerically this fact in Section 6.3 with noisy simulations. Specifically, let us assume we have an initial energy estimate Eₜₑₛₜ with an estimated precision ϵ>0. We measure ρ(s) for two different values of E=Eₜₑₛₜ±ϵ, but with the same s, denoting ρ_{±} the noisy measurement outcomes. Under these two assumptions, we can extract

$${E}_{GS} = {E}_{test} + \frac{1}{s} arctan ( tan ( s ϵ ) \frac{{ρ}_{+} + {ρ}_{-}}{{ρ}_{-} - {ρ}_{+}} ) . \qquad ( 46 )$$

The advantage of this formula is that it depends on a ratio of measurements of ρ(s) at same value of s, and so would not be highly sensitive to depolarizing noise as it would cancel out from numerator and denominator. Using this formula to refine the estimate of the ground state energy is a way of utilising information in the amplitude of ρ(s), which are, otherwise, thrown away in the binary search approach above (which only requires to know the sign of ρ(s)). We will present below in Section 6 noisy numerical simulations of this approach and show that it performs well, showing that these assumptions are realistic.

### 4.2.4. Robbins-Monro Approach

The previous “arctan fit” approach relied on the observation that, in the presence of depolarizing noise, although the value of ρ(s) is modified, the value of E where ρ(s) vanishes is invariant, which is E_{GS}. We finally present a third approach to compute E_{GS} that uses an algorithm to find the zero of a function that we only know with statistical error.

The Robbins-Monro algorithm is an algorithm for finding the root of a function M(x) when instead of having directly access to M(x), one has only access to a random variable V(x) that averages to M(x), i.e. [symbol] [V(x)]=M(x) [58]. Specifically, the Robbins-Monro algorithm requires that (i) M(x) is a non-decreasing function of x, (ii) M′(x_{*})>0 where M(x_{*})=0, and (iii) the values taken by the random variable V(x) are uniformly bounded. In our case, this setup corresponds to the variable x=E the trial energy, to the function M(x)=ℑ [symbol] (ψ|e^{is(E-H)}|ψ [symbol] at some fixed s, and with V(x) the expectation value of one random circuit generated with the algorithm in Section 3.3. The requirements of the Robbins-Monro algorithm are satisfied provided E is in the interval

$$[ {E}_{GS} - \frac{π}{2 s} , {E}_{GS} + \frac{π}{2 s} ] .$$

This algorithm takes as parameters an arbitrary sequence of steps aₙ>0 such that

$${\sum }_{n = 0}^{∞} {a}_{n} = ∞ , {\sum }_{n = 0}^{∞} {a}_{n}^{2} < ∞ . \qquad ( 47 )$$

Starting from an initial energy estimate E₀, we then build a sequence of energy estimates Eₙ as

$${E}_{n + 1} = {E}_{n} - {a}_{n} {V}_{n} ( {E}_{n} ) , \qquad ( 48 )$$

where Vₙ(Eₙ) is the expectation value of random circuit generated with the algorithm in Section 3.3 to measure ℑ [symbol] (ψ|e^{is(E}^{ₙ}^{-H)}|ψ [symbol] . This sequence of energies Eₙ converges when n→∞ to the root of the function ℑ [symbol] ψ|e^{is(E}^{ₙ}^{-H)}|ψ [symbol] , namely the ground state energy E_{GS}.

This approach shares with the previous arctan fit approach its noise resilience when the noise can be well approximated by a depolarizing channel, as it does not shift the value of E where ρ(s) vanishes. It has the advantage of being a well-studied algorithm with optimality results and improvements. However, the arctan fit approach above incorporates the known shape of the function ρ(s) which might bring some additional precision. We will present in Section 6 a comparison of these different approaches using a depolarizing channel.

### 5. Resource Estimate

In this Section we report a resource estimate for obtaining chemical precision with the TETRIS method on different molecules.

### 5.1. Hamiltonian-Related Costs

We start with a study of the required resources of the algorithm that pertain to the size of the molecular system studied. The number of qubits and the number of terms in the Hamiltonian H do not enter directly the cost of the algorithm. The only dependence of the number of two-qubit gates in the system size is through the interaction norm μ₁, which is the sum of the coefficients in the decomposition of the interaction Hamiltonian H_{I} into Pauli strings, and through the factor g, which is the average number of two-qubit gates required to implement a rotation e^{iτP}^{ₙ}.

FIGS. 4A and 4B show the dependence of these two parameters μ_{I} and g on the number of qubits, for various molecules and basis sets. The interaction norm μ_{I} and the factor g are plotted as a function of the number of qubits (i.e. the number of spin orbitals). We can decompose these molecular Hamiltonians in terms of Pauli strings, after applying a Hartree-Fock optimization of the molecular or spin orbitals. We call μ the 1-norm of the Hamiltonians obtained this way, and μ_{I} the 1-norm of the Hamiltonians without counting single Pauli Z terms, see Section 3.3, and after removing the square particle number operator to minimize the norm as explained in Section 3.5. We observe that the norm μ_{I} scales polynomially with the number of qubits L, with a fit μ_{I}≈0.007 L^{2.84}. When restricted to hydrogen chains, we observe a behaviour μ_{I}≈0.2 L^{2.13}. We note that it is known that if instead of doing the Hartree-Fock optimization, we perform an orbital rotation to minimize the norm, then we can bring this exponent below 2 [32]. Moreover, we see that the norm μ_{I} of the interaction Hamiltonian is often a few factors below the norm of the entire Hamiltonian. The factor g is seen to be well approximated by g≈L/2.

In particular, the circles in FIG. 4A show values for reduced norm μ_{I} and the crosses show total norn μ, and FIG. 4B shows plots for factor g assuming a Hadamard test and Jordan-Wigner decomposition, as a function of the number of qubits L. The molecules considered are hydrogen chains H₂ₙ for n=1, . . . , 8, hydrogen squares Pₙ_{²}≡Hₙ_{²} for n=2,4, hydrogen cube Cub₂³≡H₂_{³}, N₂, H₂O, O₂, LiH, BeH₂, CO₂, O₃, BF₃, CH₄ in a STO-3G basis, and H₂, H₂O, LiH, O₂, CH₄ in a CCPVDZ basis (indicated by a ′ on the plot), all in their equilibrium configuration.

### 5.2. Adiabatic-Path-Related Costs

### 5.2.1. Minimal Adiabatic Time to Reach Chemical Precision

We now estimate the behaviour of the required adiabatic time evolution T to reach chemical precision, as a function of the system size. We study two different paths that have different smoothness behaviour. The first one is linear

$$w ( u ) = u , \qquad ( 49 )$$

for which we have ζ=½, and the second one has a quadratic behaviour both at u=0 and u=1

$$w ( u ) = 2 {u}^{2} - {u}^{4} , \qquad ( 50 )$$

for which we have ζ= 7/15. We recall that the smoothness of the path influences the asymptotic scaling of adiabatic state preparation.

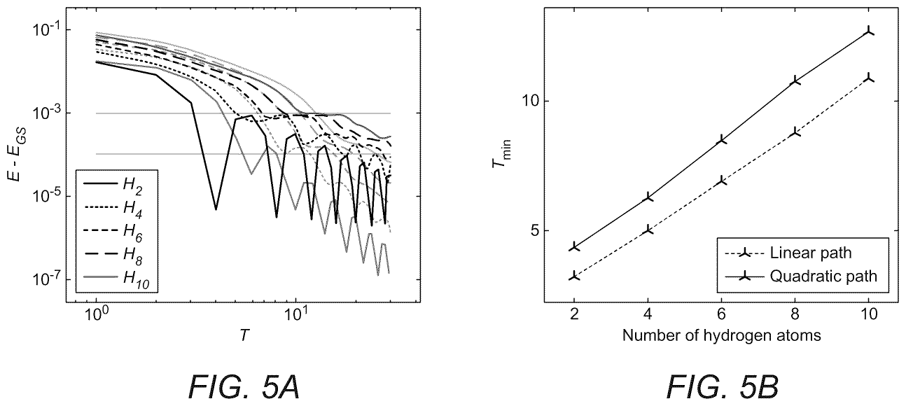

In the left panel of FIG. 5A, we first compare the energy E(T) reached after an adiabatic evolution during a time T, with the ground state energy E_{GS} obtained with exact diagonalization, for a hydrogen chain with 2 to 10 atoms in a STO-3G basis. Specifically, FIG. 5A shows the difference between the ground state energy E_{GS} and the energy E of the state adiabatically evolved up to time T, as a function of T, for hydrogen chains H₂, H₄, H₆, H₈, H₁₀, and two different paths: w(u)=u (darker lines) and w(u)=2u²−u⁴ (lighter lines). The horizontal lines indicate precisions 10⁻³ and 10⁻⁴. These plots implement the exact adiabatic evolution, without any Trotter error or discretization error. We observe a general decrease of E(T)−E_{GS} as ˜1/T² for the linear path, and around ˜1/T⁴ for the quadratic path. This is consistent with the fact that smoother paths are associated with better asymptotic scaling. From these curves, we plot in the right panel of FIG. 5B the smallest adiabatic times Tₘᵢₙ for which chemical precision 10⁻³ is reached in a hydrogen chain, as a function of the number of hydrogens, for linear and quadratic paths. For both the linear and quadratic paths, this time is seen to vary linearly with the number of hydrogen atoms in the chain.

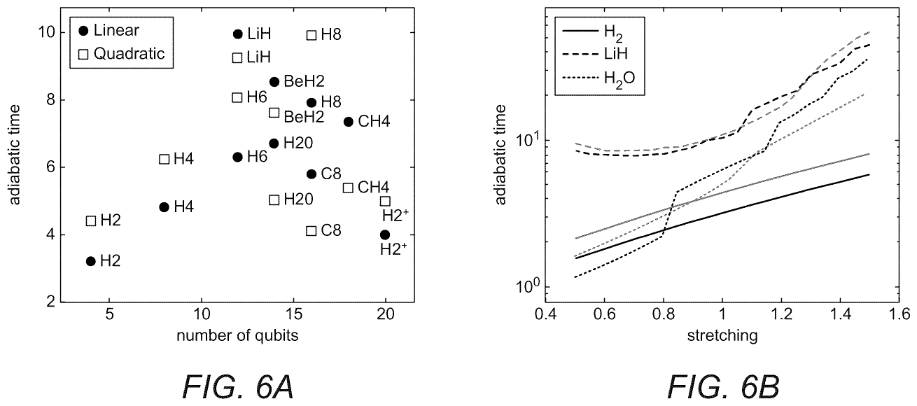

In the left panel of FIG. 6A, we then consider a larger class of molecules for which we compute the minimal adiabatic time Tₘᵢₙ required to reach accuracy 10⁻³ on the ground state energy, using the linear path (49) (circles) and quadratic path (50) (squares), and plot it as a function of the number of qubits, for a subset of molecules appearing in FIG. 4. For most of these molecules that are reachable with exact diagonalization (≤20 qubits), we observe that the adiabatic time remains below 10, and can be bounded by L the number of qubits. This is in contrast with adiabatic times that were hypothesised to blow up exponentially with the number of qubits in certain previous works [13]. On the other hand the order of magnitude of most of the adiabatic times we found is in agreement with certain previous estimates [15]. In the right panel of FIG. 6B, we then consider non-equilibrium geometries by stretching the bond length of some of these molecules. FIG. 6B is the same as the left panel, but as a function of the stretching defined as the ratio of the bond length with the equilibrium value. These adiabatic times for stretched geometries are obtained with the standard paths we consider in this patent specification, but they can be significantly decreased by modifying the path, see Section 5.2.2 ‘Path modification’. For small stretching we observe only a mild variation of the minimal adiabatic times. However, we see that for larger stretching there can be a significant increase of the adiabatic time with the particular path we study, starting from only single Z Pauli strings.

### 5.2.2. Path Modification

Besides the cases where the adiabatic times needed to reach chemical precision remain small, we also encountered a few cases not listed in FIG. 6 where these times become very large. For example, equilibrium hydrogen H₂ in a CCPVDZ basis set with 20 qubits in our setup requires an adiabatic time >1000 to reach chemical precision. These times are obviously very large and could preclude using ASP to solve chemical systems. We also saw in the right panel of FIG. 6 that adiabatic times tend to grow fast with the stretching.

One advantage of ASP is the very large freedom one has in the choice of the adiabatic path. Besides varying the speed along the path, one can also vary the initial Hamiltonian and include so-called counter-diabatic terms [18, 59-65]. ASP can be slow for one such path and considerably faster for another path. Let us take the example of equilibrium H₂ in a CCPVDZ basis set, which is 20 qubits. As noted above, when starting from the Hamiltonian containing only single Pauli Z matrices, the adiabatic time required to reach chemical precision is larger than 1000. If now we take the initial Hamiltonian H_{B} as the one containing all Pauli strings in H with either exactly one or two Z Pauli matrices (instead of just those with one Z), then the adiabatic time to reach chemical precision is reduced to around 4. A very simple modification of the path can thus completely change the adiabatic time required.

Let us give another example with the non-equilibrium geometries at large stretching, for which ASP was observed to be slow when starting from the Hamiltonian with only single Z terms. We propose instead the following adiabatic path. We first prepare the ground state of the equilibrium geometry by starting from the Hamiltonian with only the single Z terms. As we saw, the minimal adiabatic times remain small for most of the molecules in that setup. Then, we slowly increase the stretching with time

$$s ( t ) = {s}_{initial} ( 1 - \frac{t}{T} ) + {s}_{final} \frac{t}{T} ,$$

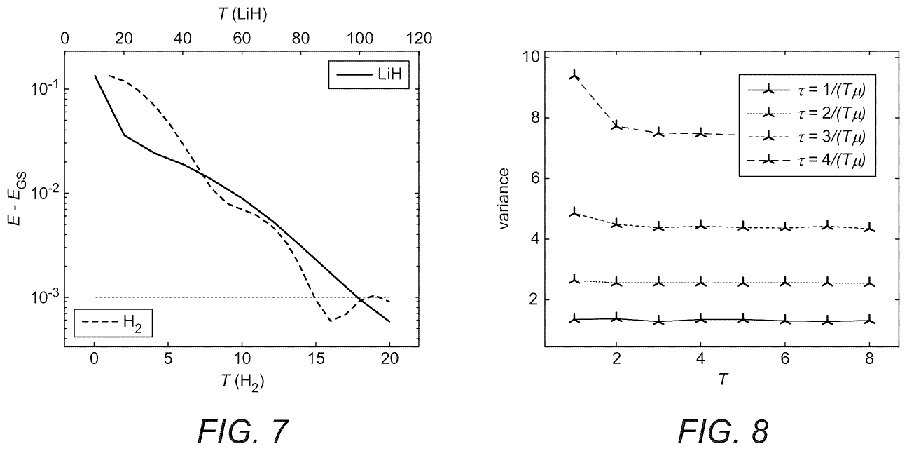

performing the Hartree-Fock optimization of the Hamiltonian with that new value of stretching at each time step. We report in FIG. 7 the energy precision obtained during this adiabatic process when preparing the ground state of a molecule with stretching 3, starting from the ground state of the equilibrium geometry (i.e. stretching 1), for H₂ and LiH. In particular, FIG. 7 shows the difference between the ground state energy E_{GS} at stretching value 3 and the energy E of the state adiabatically prepared evolved up to time T, as a function of T, for H₂ and LiH in a STO-3G basis. The adiabatic path starts from the ground state with stretching 1 (i.e. equilibrium) and increases the stretching up to 3, during a total time T. The gray dashed line indicates chemical precision 10\hat{ }(−3). We observe that this path yields much lower adiabatic times to reach chemical precision. Compared to the previous path, for H₂, this reduces the adiabatic time from ≈300 to ≈15, while for LiH the reduction is from ≈800 to ≈100.

We note that there exist still several other ways of reducing the adiabatic times or the circuit depth [12, 66]. These examples show that the flexibility of ASP (in the choice of the path, the initial Hamiltonian, possible counter-diabatic terms) can overcome unfavorable setups where adiabatic times needed naively appear to be very large.

### 5.3. Sampling Costs

The algorithm presented in Section 3 is a randomized algorithm, in the sense that it requires to average over several different random circuits to obtain the desired quantum expectation value within the adiabatically evolved state. Compared to a deterministic algorithm like a Trotter decomposition where only one circuit is required, this seemingly comes with a sampling cost overhead.

If these random circuits were simulated classically, there would be indeed an overhead in including multiple samples to compute the statistical average over the random circuits. However, on a quantum computer, expectation values are computed through averaging measurement outcomes over several realizations of the same circuit, called shots. To obtain a precision e on the expectation value, one has to run in any case of order ϵ⁻² shots. In our case, because of the randomized algorithm we use, imprecision on the expectation values comes from two sources: the finite number of random circuits, and the finite number of shots per circuit. Given a total shot budget S, it is a priori non trivial how to best distribute these S shots among different random circuits, i.e., what is the optimal number of shots s per circuits that minimizes the total variance over the S/s random circuits. As shown in [1], this optimal number is s=1, namely one single shot per circuit. In that case the noise coming from the finite number of circuits and that coming from the finite number of shots per circuit are indistinguishable.

Let us now estimate the actual statistical variance associated with the random circuit drawing in the case where we do only one shot per circuit. We write an amplitude as

$$〈 0 \vert {𝒜 ( T )}^{†} {e}^{is ( E - H )} 𝒜 ( T ) \vert 0 〉 = {( {λ}_{A}^{2} {λ}_{C} )}^{- 1} 𝔼 [ 〈 0 \vert {U}_{1}^{†} {U}_{{1}^{′}} {U}_{2} \vert 0 〉 ] , \qquad ( 51 )$$

with U₁, U₂ two independent random circuits drawn to generate [symbol] (T), and U′₁ a random circuit drawn to generate e^{is(E-H)}. λ_{A} and λ_{C} are the attenuation factors corresponding to generating [symbol] (T) and e^{is(E-H)} respectively. We will denote

$$λ = {λ}_{A}^{2} {λ}_{C}$$

the total attenuation factor. For −1≤x≤1, we denote [symbol] (x) the Bernoulli random variable that takes value +1 with probability

$$\frac{1 + x}{2}$$

and −1 with probability

$$\frac{1 - x}{2} .$$

We denote then X the random variable

$$X = {λ}^{- 1} ℬ ( 𝔍 〈 0 \vert {U}_{1}^{†} {U}_{{1}^{′}} {U}_{2} \vert 0 〉 ) . \qquad ( 52 )$$

This random variable is exactly the measurement outcome of one shot of a circuit that measures the imaginary part of

$$〈 0 \vert {U}_{1}^{†} {U}_{{1}^{′}} {U}_{2} \vert 0 〉 ,$$

multiplied by λ⁻¹. We thus have the mean value

$$𝔼 [ X ] = 𝔍 〈 0 \vert {𝒜 ( T )}^{†} {e}^{is ( E - H )} 𝒜 ( T ) \vert 0 〉 .$$

The number of circuits to include to converge to the mean is around the variance ≈Var(X) with

$$Var ( X ) = 𝔼 [ {X}^{2} ] - {𝔼 [ X ]}^{2} . \qquad ( 53 )$$

In our case, since [symbol] (x)²=1, this variance is exactly

$$Var ( X ) = \frac{1 - {( 𝔍 〈 0 \vert {𝒜 ( T )}^{†} {e}^{is ( E - H )} 𝒜 ( T ) \vert 0 〉 )}^{2}}{{λ}^{2}} . \qquad ( 54 )$$

Hence the statistical variance of the algorithm is bounded by the inverse square of the total attenuation factor

$$Var ( X ) \leq \frac{1}{{λ}^{2}} . \qquad ( 55 )$$

This means we need at most ≈1/λ² shots to converge to precision [symbol] (1), and ≈1/(λϵ)² to converge to precision ϵ. Thus, in contrast with Trotterization (where the actual amplitude of Trotter errors are a priori unknown), for any desired confidence interval, the required total cost (i.e. number of gates per sample times number of samples) can be known in advance. Given a Trotter step, there is no “guarantee” that the time evolution generated with Trotter has converged to the exact time evolution. In contrast, with computer-implemented methods using the TETRIS algorithm, the only imprecision comes from the finite number of shots as there is no discretisation error. Therefore, given a number of shots and the variance associated to the measurements, one can affirm the probability that an exact value is within a particular range.

In FIG. 8, we evaluate numerically the statistical variance in the case s=0, measuring [symbol] 0| [symbol] (T)^{†} [symbol] (T)|0 [symbol] =1, the real part of the amplitude (which should be 1) instead of the imaginary part, with the randomized algorithm with 1 shot per circuit, as a function of T, for different gate angles τ(T), for a H₄ molecule at equilibrium in a STO-3G basis. We fix the gate angle

$$τ = \frac{n}{{T}_{{μ}_{I}}}$$

for n=1,2,3,4 and vary T. For this value of the gate angle the attenuation factor should become independent of T as T grows, with value λ⁻¹˜eⁿ. We observe indeed this behaviour. This shows that the randomized nature of the algorithm, provided the optimal gate angle

$$τ = \frac{1}{{T}_{{μ}_{I}}}$$

is chosen, does not bring any overhead compared to a deterministic algorithm like Trotter. That is, the apparent additional overhead of TETRIS in running distinct random circuits is actually non-existent, since any quantum algorithm has to be run several times (normally with multiple different realizations of the same circuit, called “shots”) and the measurement outcomes can be averaged to yield a result. By doing only one shot per random circuit, the random circuit sampling has zero additional overhead compared to a deterministic algorithm (if the number of random circuit samples is equivalent to a single circuit being run the same number of times).

### 5.4. Discretization Costs of Trotter

Let us now evaluate the cost of implementing ASP with a Trotter decomposition, and compare with our proposal. To use the Trotter algorithm to implement ASP, we have to approximate the adiabatic evolution operator as

$$𝒜 ( T ) \approx {e}^{i Δ tH ( 0 )} {e}^{i Δ tH ( Δ t )} … {e}^{i Δ tH ( T - Δ t )} , \qquad ( 56 )$$

with Δt a chosen time step, and H(t) the time-dependent Hamiltonian of interest, evaluated at time points 0, Δt, 2Δt, . . . . Then each of the term e^{iΔtH(u)} at time u is itself written as a product of exponentials

$${e}^{i Δ tH ( u )} \approx {\prod }_{n = 1}^{N} {e}^{i Δ {tc}_{n} ( u ) {P}_{n}} ,$$

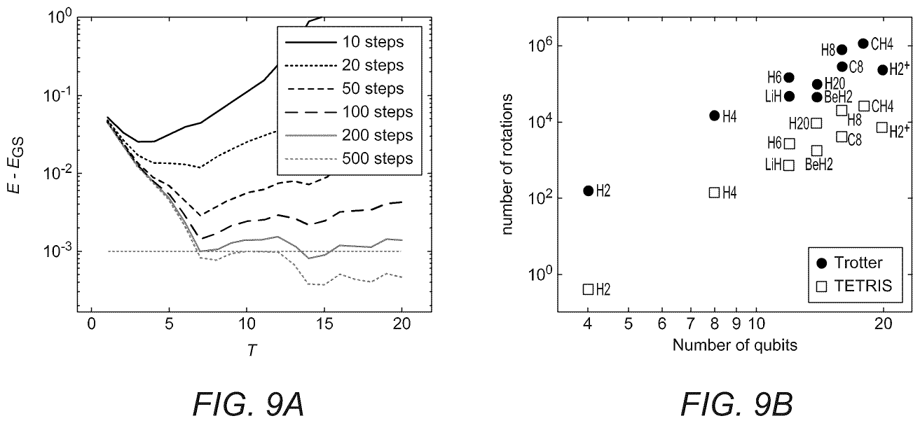

with cₙ(u) the corresponding coefficient of H(u) in front of Pauli string Pₙ. This implementation comes both with a discretization error (the first approximation) and a Trotter error (the second approximation), that both lead to a heating, namely to an increase of the energy of the state prepared. In the left panel of FIG. 9A, we plot the energy of the adiabatic evolution as a function of the final time T, for different fixed number of steps 1/Δt, for a H₆ hydrogen chain. Specifically, FIG. 9A shows the difference between energy of the state prepared and ground state energy, as a function of adiabatic time T for different number of Trotter steps with linear adiabatic path, for the H₆ hydrogen chain. The heating effect is clearly visible on the plot. At a fixed finite number of Trotter steps, when increasing the total simulation time T, there is inevitably an increase of the energy of the state prepared after some time T. This precludes reaching chemical precision if the number of Trotter steps is too low. In this particular example we see that we require ˜200 time steps to reach chemical precision. Since each Trotter step requires to implement a rotation e^{iτP}^{ₙ} for the 919 terms of that particular molecule, this yields ˜10⁵ rotations.

When implementing a Trotter decomposition, one has to choose the order of the terms, and different orderings may display more or less pronounced discretization error [67]. However, for these large number of Trotter steps required to reach chemical precision, these variations are observed to be negligible. For example, for H₆ at time T=7 with 300 Trotter steps, by permuting randomly the terms in the Trotter decomposition we find energies in the range 0.98±0.03 mH above the ground state. The curves in the left panel of FIG. 9A would thus be similar for different Trotter orderings.

In contrast, in our case with the algorithm of Section 3, we do not have any discretization error. In particular, we do not have the approximate decomposition of (56): ASP is implemented exactly. For the example of the H₆ hydrogen chain mentioned above, the

$$\frac{1}{2} {μ}_{I}^{2} {T}^{2}$$

algorithm we use requires rotations where μ_{I}=11.7 and T=7, which is around a factor 10² less than a Trotter implementation. Moreover, by multiplying the gate angle τ (which is a free parameter of the algorithm) by some factor κ>0, one can always divide the depth of the circuit by κ, provided we can afford a shot overhead ˜e^{K}. In the right panel of FIG. 9B, we compare the number of rotations e^{iτP}^{ₙ} that have to be implemented to reach chemical accuracy using a Trotter decomposition and with TETRIS, for several different molecules with a number of orbitals within reach of exact diagonalization. Specifically, FIG. 9B shows the minimal number of Pauli strings rotations e^{iτP}^{ₙ} (of length ≥2) to perform to reach chemical precision by adiabatically preparing the ground state with a linear path, using a Trotter implementation (purple, circles) and a TETRIS implementation ½ T\hat{ }2 μ_I\hat{ }2 (cyan, squares), for different molecules. We observe a significant reduction of order 10² with TETRIS in the number of gates per circuit. This shows that the algorithm of Section 3 is able to significantly reduce the cost of ASP.

### 5.5. Cost of Other Time Evolution Algorithms

As mentioned in the introduction, there exist many other techniques to implement Hamiltonian evolution besides Trotter. However, none of the known techniques are optimal. Another randomized algorithm for Hamiltonian time evolution is the qDRIFT algorithm [68]. The algorithm has a gate count [symbol] (t²μ²/ϵ) for time t, 1-norm μ and precision ϵ. However, it is known to have a large prefactor and to present important discretization error, see e.g. [1]. There exist as well time evolution algorithms with more favorable scaling than Trotter, for example Linear Combination of Unitaries (LCU) [20]. This algorithm has a gate count

$$𝒪 ( N μ t \frac{log μ t / ϵ}{log log μ t ϵ} ) ,$$

with N the number of terms in the Hamiltonian. Approximating the prefactor and the log term by some constant C, the cost is thus CL⁴μT. This prefactor is known to be large. It follows that TETRIS has a better performance when

$$T < C \frac{{L}^{4}}{μ} . \qquad ( 57 )$$

Using the scaling of μ that we obtained, this is approximately

$$T {\approx }^{<} 100 CL . \qquad ( 58 )$$

This condition is largely satisfied for the molecules we studied in FIG. 6 We note that by changing the orbital basis to minimize the 1-norm of the Hamiltonian, this condition could be brought to T≈ [symbol] (L²) [32]. This shows the better practicality of TETRIS for quantum chemistry applications using current and expected near term quantum computing capabilities.

### 5.6. Scaling Analysis

To conclude this Section, we perform a basic scaling analysis of the cost of ASP for chemistry applications, based on the previous resource estimates. Using g=L/2, ζ=½, adiabatically preparing a state |ψ [symbol] [symbol] ψ| has a cost

$${C}_{prepare} = L {μ}_{I}^{2} {T}^{2} . \qquad ( 59 )$$

The cost of measuring the energy with precision 10⁻³ using the different methods presented in Section 4 is

$${C}_{measure} = {10}^{6} {Lμ}_{I}^{2} . \qquad ( 60 )$$

For the hydrogen chain, we had the estimates μ_{I}≈0.2 L^{2.13} and adiabatic times T≈L/2. This yields the scaling

$${C}_{total} \sim {10}^{- 3} \cdot {{L}^{6.6} ( {10}^{3} + L )}^{2} . \qquad ( 61 )$$

This estimate shows that for systems with less than ˜10³ qubits, the measurement of the energy is the most costly step, whereas for larger systems the adiabatic preparation step is more costly.

For more generic molecules, we had the estimate μ_{I}≈0.007 L^{2.8}. The adiabatic times required are more difficult to estimate, but on the molecules we tested at equilibrium we found an upper bound T≈L. Hence in total, we get a rough upper bound estimate of the total number of CNOTs

$${C}_{total} \sim {10}^{- 3} \cdot {{L}^{6.6} ( {10}^{3} + L )}^{2} . \qquad ( 62 )$$

We again recall that these estimates are obviously very dependent on the scaling of the adiabatic times T required to reach chemical precision, that we estimated for systems with up to 20 spin orbitals.

### 6. Noisy Simulations

### 6.1. Setup

We now present numerical simulations of the algorithm that take into account hardware imperfections. We compile every circuit into Pauli matrices, S, S^{†}, H, Z rotations, and the two-qubit gate e^{iθZ}^{₁}^{Z}^{₂}, which is the native coupling gate in Quantinuum's ion-trap hardware [33]. We model hardware noise by a simple depolarizing channel after every e^{iθZ}^{₁}^{Z}^{₂} gate. This kind of basic noise model gives a good approximation of many current platforms.

### 6.2. Symmetry Filtering

The presence of symmetries in a system can be exploited to reduce the noise on the measurement outcomes of hardware or noisy simulations. If the unitary operator that a circuit implements commutes with some charge operator Q, then one can discard in the measurement outcomes all the shots where the value of Q is modified compared to the initial value of Q.

In our case, the Hamiltonians describing molecules always conserve the number of electrons with spin up or down separately. However, the use of the randomization algorithm comes with a subtlety. Although the total Hamiltonians conserve particle number

$$Q = {\sum }_{i = 1}^{N} {Z}_{i} ,$$

each term in their Pauli string decomposition does not necessarily conserve particle number. After the Jordan-Wigner transformation, we obtain terms like X₁X₂+Y₁Y₂ which commutes with particle number Z₁+Z₂. However, in every random circuit generated by TETRIS, rotations with respect to X₁X₂ and Y₁Y₂ are performed separately, and these terms separately do not commute with Z₁+Z₂ and do not conserve particle number. When drawing randomly the gates, the circuits that we obtain thus do not individually conserve particle number, although on average they will. Even in the noiseless case, some shots will not conserve particle number. Discarding them would lead to a biased result. However, since we know these shots have to average to 0 in the result, one can impose that these non-particle-conserving shots contribute as zero in the average over the shots (which is different from discarding them, because the total number of shots that we use to average the results remains the same). In the presence of noise, shots that do not conserve particle number can come from either the fact that the circuit itself does not conserve particle number, or from the fact that an error has occurred. However, because non-particle-conserving shots can also occur in noiseless circuits, we cannot discard these shots in the noisy case, and one can only impose that they contribute as zero in the result. The consequence is that this symmetry filtering does not remove noise, but only converts it into a global depolarizing channel that maps the final density matrix ρ into

$$( 1 - λ ) ρ + \frac{λ}{{2}^{L}}$$

with some noise level λ.

There is however a less constraining symmetry that is satisfied at the level of each random circuit generated by the algorithm. This is the parity of particles with spin up or down. As this property is conserved individually in each circuit, no shots breaking the symmetry will be observed in the noiseless case, and one can systematically discard non-parity-conserving shots in hardware data or noisy simulations as one is certain that an error has occurred in those shots. This is the technique that we will use below when any symmetry filtering is mentioned.

### 6.3. Noise-Resilience

In Section 4.2 we proposed three different methods to extract the ground state energy from the measurement of the expectation value of the operator e^{is(E-H)} within the state prepared adiabatically. If the state prepared is sufficiently close to the ground state, this amplitude is sin(s(E−E_{GS})) with E_{GS} the desired ground state energy. We argued that these methods are noise-resilient because the main effect of hardware noise is to dampen the signal sin(s(E−E_{GS})) by multiplying it by a positive constant that is independent of E.

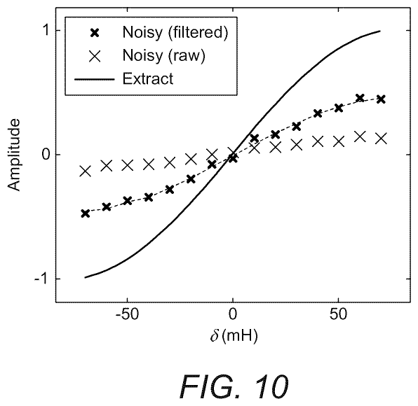

In this Section, we start by checking this affirmation with a very common noise model where a depolarizing channel on two qubits is applied after every two-qubit gate. In FIG. 10 we show simulations for a stretched hydrogen H₂ molecule in a STO-3G basis with bond length 1.11 Å, on 4 qubits, comparing the noisy simulations of ℑ [symbol] ψ|e^{is(E-H)}|ψ [symbol] with exact value, using depolarizing channels with amplitude 0.01 and the corresponding optimal gate angle τ as described in Section 3.4.2. In particular, FIG. 10 shows the imaginary part of the expectation value of e^{is(E-H)} in the state prepared with ASP, for a H₂ molecule with bond length 1.11 Å, using an adiabatic time T=12 with a linear path, as a function of δ=E-E_{GS} expressed in mH, at fixed s=20: exact curve sin(0.02δ) (continuous black), raw noisy simulations (larger, thinner crosses) and noisy simulations after parity filtering (smaller, thicker crosses). The noise is modelled by a depolarizing channel with amplitude 0.01 after every two-qubit gate. The dashed curve is a fit 0.46 sin(0.02(δ−0.979)). We show both the raw data and the data obtained after parity filtering as introduced in Section 6.2. For these parameters there are around 200 two-qubit gates per circuit. We first observe that the raw noisy data are hugely dampened compared to the exact value. At δ=E-E_{GS}=±70 mH, the amplitude is damped by a factor ≈0.131, which is very close to the rule of thumb 0.99²⁰⁰≈0.134, namely the fidelity of every two-qubit gate raised to the number of two-qubit gates in the circuit. The parity filtering is seen to have a large effect and multiplies the amplitude of the signal by a factor ≈3-4.

Next, we observe that the main effect of the noise after parity filtering is to dampen the curve. The value of E where the amplitude ℑ [symbol] ψ|e^{is(E-H)}|ψ [symbol] vanishes (which is E=E_{GS}) is barely affected by the noise. By fitting the noisy data points after parity filtering, we find that the results fit well with a sinus. The amplitude is dampened by a factor 0.46 compared to exact, and the point where the curve vanishes is shifted by only 0.98 mH. This confirms the noise-resilience of extracting the ground state energy from the point where the amplitude ℑ [symbol] ψ|e^{is(E-H)}|ψ [symbol] vanishes.

### 6.4. Performance of the Three Measurement Methods

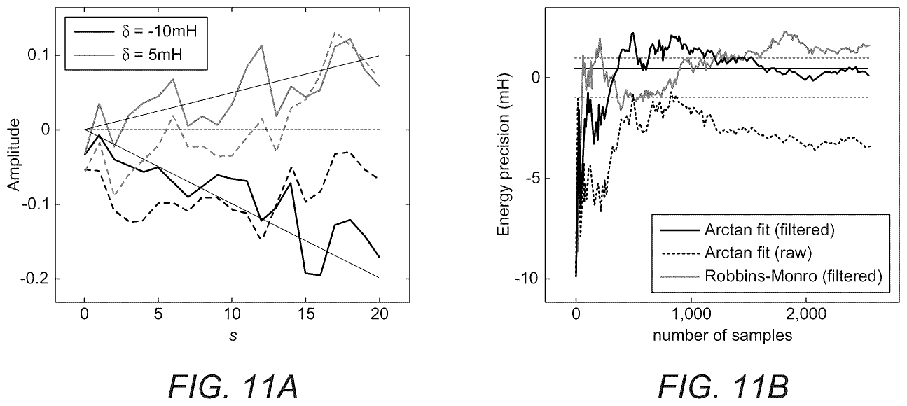

In FIG. 11 we show simulations for a stretched hydrogen H₂ molecule in a STO-3G basis with bond length 1.11 Å, on 4 qubits. We show the results for the three different approaches to measure the energy presented in Section 4, using the same adiabatic state preparation with linear path and adiabatic time T=12. The energy of the state produced this way is 0.49 mH above the exact ground state energy.

In the left panel of FIG. 11A, we show the results of the binary search approach, where one determines whether the ground state energy is above or below a certain energy E by measuring the sign of ℑ [symbol] (ψ(T)|e^{is(E-H)}|ψ(T) [symbol] . We consider two cases where E is at a distance −10 mH and 5 mH from the ground state, and plot the measured value of the noisy amplitude ℑ [symbol] ψ(T)|e^{is(E-H)}|ψ(T) [symbol] as a function of s the central time, for a H₂ molecule with bond length 1.11 Å, using an adiabatic time T=12 with a linear path, for two different values of δ=E−E_{GS}, for a two-qubit gate fidelity 0.9982, with 1000 samples and 100 shots per sample. Continuous lines indicate values after parity filtering, and dashed lines raw data. The black lines indicate the theoretical noiseless values. We see that the raw unfiltered results are systematically shifted because of noise. This occurs even for s=0, because the circuit still contains the adiabatic state preparation in this case. However, after using the parity filter, we observe that up to the shot noise the results are compatible with the noiseless exact values. In particular, they allow one to distinguish positive from negative by going to central times s≈15-20. Nevertheless, performing the same calculation with a case where E is at a distance ±1 mH from the ground state would be challenging and would require to go to large values of s or much larger number of shots.

In the right panel of FIG. 11B, we then test the two other approaches, the arctan fit approach and the Robbins-Monro approach and show the precision on the estimated energy for the two approaches as a function of the number of samples considered, in the same conditions as in the left plot of FIG. 11A. We start from an initial energy estimate 10 mH below the exact ground state. For the arctan fit approach, we then measure ℑ [symbol] ψ(T)|e^{is(E-H)}|ψ(T) [symbol] at energies 30 mH below and 10 mH above the ground state (i.e., δ=−10 mH and ϵ=20 mH), and plot formula (46) for s=20 and Eₜₑₛₜ=E_{GS}−10 mH as a function of the number of samples.

We see that the ground state estimate improves immediately with just one hundred samples, and reaches chemical precision after around 1000 samples. As for the Robbins-Monro approach, we use the parameters

$${a}_{n} = \frac{10}{{n}^{0.75}}$$

starting at δ=−10 mH and plot the energy iterates (48) as a function of the number of iterations. The black continuous line indicates 0.49 mH the energy of the adiabatic state prepared, and dashed lines indicate chemical precision 1 mH. We see again a very fast increase in precision at the beginning. Values close to chemical precision are also reached after around 1000 samples. Optimal choices of coefficients an could improve further the results.

### Measuring Multiple Observables

There exists a simple variation of the algorithm that allows one to measure multiple commuting observables when evolved at time t, like if we were directly measuring the qubits, namely to measure

$$〈 0 … 0 \vert {e}^{- iHt} {Oe}^{iHt} \vert 0 … 0 〉 , \qquad ( 1.1 )$$

for different observables O. The TETRIS algorithm requires an ancilla initialized in |+ [symbol] , and we assume that the system qubits are initially in |0 . . . 0 [symbol] . The initial density matrix is thus

$$ρ = \frac{1}{2} \vert 0 〉 〈 0 \vert ⊗ \vert 0 … 0 〉 〈 0 … 0 \vert + \frac{1}{2} \vert 1 〉 〈 0 \vert ⊗ \vert 0 … 0 〉 〈 0 … 0 \vert + \frac{1}{2} \vert 0 〉 〈 1 \vert ⊗ \vert 0 … 0 〉 〈 0 … 0 \vert + \frac{1}{2} \vert 1 〉 〈 1 \vert ⊗ \vert 0 … 0 〉 〈 0 … 0 \vert . \qquad ( 1.2 )$$

The states before the ⊗ denote the ancilla, and the states after the ⊗ denote the system qubits. When generating one random circuit U according to the random process described previously, and applying it on the system qubits conditioned on the ancilla to be 1, we prepare

$$( 1.3 )$$

$$ρ = \frac{1}{2} \vert 0 〉 〈 0 \vert ⊗ \vert 0 … 0 〉 〈 0 … 0 \vert + \frac{1}{2} \vert 1 〉 〈 0 \vert ⊗ U \vert 0 … 0 〉 〈 0 … 0 \vert + \frac{1}{2} \vert 0 〉 〈 1 \vert ⊗ \vert 0 … 0 〉 〈 0 … 0 \vert {U}^{†} + \frac{1}{2} \vert 1 〉 〈 1 \vert ⊗ U \vert 0 … 0 〉 〈 0 … 0 \vert {U}^{†} .$$

Let us now generate another random circuit U′, independently from U and according to the same random process, and apply it on the system qubits conditioned on the ancilla to be 0. We get

$$( 1.4 )$$

$$ρ = \frac{1}{2} \vert 0 〉 〈 0 \vert ⊗ {U}^{′} \vert 0 … 0 〉 〈 0 … 0 \vert {U}^{′†} + \frac{1}{2} \vert 1 〉 〈 0 \vert ⊗ U \vert 0 … 0 〉 〈 0 … 0 \vert {U}^{′†} + \frac{1}{2} \vert 0 〉 〈 1 \vert ⊗ {U}^{′} \vert 0 … 0 〉 〈 0 … 0 \vert {U}^{†} + \frac{1}{2} \vert 1 〉 〈 1 \vert ⊗ U \vert 0 … 0 〉 〈 0 … 0 \vert {U}^{†} .$$

Averaging over the unitary U or U′ gives

$$𝔼 [ U ] = 𝔼 [ {U}^{′} ] = λ {e}^{iHt} , \qquad ( 1.5 )$$

with λ the attenuation factor. However, the average [symbol] [U⊗U^{†}] is unknown. We thus have, after averaging over different random circuits

$$( 1.6 )$$

$$𝔼 [ ρ ] = \frac{1}{2} \vert 0 〉 〈 0 \vert ⊗ {ρ}_{unk} + \frac{{λ}^{2}}{2} \vert 1 〉 〈 0 \vert ⊗ {e}^{iHt} \vert 0 … 0 〉 〈 0 … 0 \vert {e}^{- iHt} + \frac{{λ}^{2}}{2} \vert 0 〉 〈 1 \vert ⊗ {e}^{iHt} \vert 0 … 0 〉 〈 0 … 0 \vert {e}^{- iHt} + \frac{1}{2} \vert 1 〉 〈 1 \vert ⊗ {ρ}_{unk} ,$$

with ρᵤₙₖ:= [symbol] [U|0 . . . 0 [symbol] [symbol] 0 . . . 0|U^{†}] some unknown density matrix. Let us now measure the observable X⊗O, with X on the ancilla and O on the system qubits. In average we get

$$Tr [ 𝔼 [ ρ ] X ⊗ O ] = {λ}^{2} 〈 0 … 0 \vert {e}^{- iHt} O {e}^{iHt} \vert 0 … 0 〉 . \qquad ( 1.7 )$$

This is exactly the expectation value of O at time t times the attenuation factor λ². Different observables O that commute can in principle be measured simultaneously. For example, if O are strings of Z Pauli matrices, by measuring all the system qubits in the Z basis, one gets access to all their expectation values simultaneously. This technique removes the specificity of the observables measured in TETRIS compared to using a Trotter decomposition, and brings the algorithm as general as the Trotter decomposition to compute the expectation values.

### Noise Mitigation Technique: Large Gate Angle Extrapolation

In TETRIS, the gate angle τ is a free parameter that does not modify the precision obtained on the result, in the sense that exact expectation values can be computed for all values of τ. However, the gate angle τ modifies the random unitaries U sampled and the attenuation factor λ. The angle of the rotations in U is τ, and there are in average tμ/sin τ such rotations in each circuit U. Being able to tune a parameter to continuously change the number of gates in the circuit, but without changing the expectation values, is the ideal setup to perform Zero Noise Extrapolation (ZNE). Namely, on an actual noisy hardware, by changing T one can measure the effect of noise on the result, and compensate for it.

Specifically, ZNE can be performed using two or more different gate angles. As a first example, let us run two values of τ, given by τ₀ and ατ₀ where τ₀>0 is fixed and 0<α<1, and let y₁ and y_{α} be the expectation values obtained from the corresponding circuits. We assume that these gate angles are small so that sin τ≈τ. Also, as usual with ZNE, we assume that at low noise level the effect of noise is linear in the number of gates, namely that

$${y}_{α} = a + {bN}_{g} ( α ) , \qquad ( 2.1 )$$

with a, b parameters and N_{g}(α) the average number of gates in the circuits generated with gate angle τ=ατ₀. Other functional forms could be considered as well, such as an exponential behaviour y_{α}=ae^{-bN}^{_{g}}^{(α)}, and would not modify the discussion. The number of gates N_{g}(α) is proportional to 1/sin τ≈1/τ. Under these assumptions, we obtain a mitigated expectation value as

$${y}_{ZNE} = \frac{{y}_{1} - α {y}_{α}}{1 - α} . \qquad ( 2.2 )$$

The TETRIS algorithm allows thus for a very specific implementation of ZNE through variation of the gate angle.

Let us estimate the standard deviation obtained on the mitigated result. The standard deviation σ_{ZNE} obtained on y_{ZNE}, writing σ₁, σ_{α} those of y₁, y_{α}, is

$${σ}_{ZNE} = \frac{1}{1 - α} \sqrt{{σ}_{1}^{2} + {α}^{2} {σ}_{α}^{2}} . \qquad ( 2.3 )$$

Considering that there is a certain total number of shots to distribute among σ₁ and σ_{α}, we write

$${σ}_{1}^{2} = {s}_{1}^{2} / x and {σ}_{α}^{2} = {s}_{α}^{2} / ( 1 - x ) ,$$

with 0<x<1 and s₁, s_{α} numbers. The minimal variance is obtained for

$$x = \frac{{s}_{1}}{{s}_{1} + α {s}_{α}} , \qquad ( 2.4 )$$

and then it takes the value

$${σ}_{ZNE} = \frac{{s}_{1} + α {s}_{α}}{1 - α} . \qquad ( 2.5 )$$

The assumption that the effect of noise is linear with the number of gates is not a limitation of the technique, as non-linear relationships may be determined by comparing expectation values for a larger number of gate angles.

### 7. Conclusion

In the work described in this patent specification, the inventors investigated the relevance of adiabatic state preparation for chemistry applications, using a new algorithm (described in the Appendix below and in [1]) to implement time-dependent Hamiltonian evolution without Trotter heating.

Firstly, the inventors evaluated the cost to adiabatically prepare the ground state of molecules within chemical precision 10⁻³, using a Trotter decomposition and with the TETRIS algorithm. This determined that the method using TETRIS divides by a factor ˜10² the number of two-qubit gates required to reach chemical precision compared to Trotter, for several molecules within reach of exact diagonalization on less than 20 qubits. Moreover, the inventors evaluated the minimal adiabatic times required to reach chemical precision and found in many cases that they either remain of order 1 or 10, or that modifications of the adiabatic path can drastically reduce them. For example, the adiabatic times required for a hydrogen chain scale only linearly with the number of atoms.

The precision required in chemistry applications is a technical challenge in terms of noise, number of measurements and runtime. Moreover, because TETRIS requires averaging of complex amplitudes and not their absolute values squared, one cannot use the efficient and optimized techniques that have been developed to measure efficiently the energy of states prepared with VQE. The inventors proposed three different approaches to measure the energy of a state which is adiabatically prepared. The methods and systems implementing the three approaches rely on the fact that when |ψ [symbol] is an eigenstate of H, the value of E where the imaginary part of [symbol] ψ|e^{it(E-H)}|ψ [symbol] vanishes (that is the eigenvalue of |ψ [symbol] on H) is resilient to depolarizing noise channels. The inventors tested numerically these approaches on small molecules and showed that they are efficient.

From these results, the inventors determined that adiabatic state preparation is a viable approach to compute the ground state energy of molecules within chemical precision, and the determination of energy of an adiabatically prepared state is significantly enhanced by the described methods and systems. The methods are executable on advanced quantum computers such as Quantinuum's H2 trapped-ion quantum computer system, which provides the ability to implement two qubit gates on qubits other than nearest neighbour qubits. This avoidance of the limitation to nearest neighbour connections is significant, as it can greatly reduce the number of two qubit gates required to perform a computation such as applying rotations for time-evolution of a computational state. Chemical Hamiltonians are typically long-range and highly-coupled when written in terms of qubits, and so reliance on gates between nearest neighbour qubits would be a significant limitation. On typical quantum computers, additional gates imply additional gate errors. The high-fidelity qubits and all-to-all connectivity of Quantinuum quantum computers allow efficient computation of time-evolved computational states using the methods described herein, with gates being formed between remote qubits when required to reflect the interactions between orbiting electrodes in a real physical system. The described methods can achieve adiabatic evolution with chemical accuracy for some physical systems (such as small molecules) without error mitigation other than symmetry filtering. Implementations of the present disclosure on a quantum computer with high-fidelity gates enables ground state energy determinations that take account of stretched molecular geometry when computing the energy of a ground state of a quantum system. Nevertheless, the absolute costs remain large, and many of today's quantum computers will only be capable of applying the described techniques for a determination of energy for small molecules. At the algorithmic level, there are opportunities for further optimization such as, for example, modifying the path or the speed along the path, modifying the orbital basis in order to minimize the 1-norm of the Hamiltonian, or starting from a different initial state with lower initial energy. Each of these optimisations is expected to yield drastic savings, reinforcing the conclusion that adiabatic state preparation has significant advantages for solving chemistry problems on a near-fault-tolerant or fault-tolerant quantum computer.

### APPENDIX 1: CONTINUOUS HAMILTONIAN DYNAMICS ON DIGITAL QUANTUM COMPUTERS WITHOUT DISCRETIZATION ERROR

### Introduction

Hamiltonian dynamics is one of the most promising application of current and near-term quantum computers [69, 70]. It is believed to be exponentially faster to perform on quantum computers and finds multiple applications, either directly or indirectly as subroutines of other quantum algorithms [6, 71-75]. Given a Hamiltonian H and a simulation time t, there exist several ways to implement U(t)=e^{itH} on a digital quantum computer where only one or two-qubit gates can be used. The simplest approach uses product formulas such as Trotterization to decompose the dynamics into elementary gates U(t)≈e^{itH}^{₁} . . . e^{itH}^{ₙ} [70,76,77]. These methods have been generalized and improved in many ways [19, 78-90]. In particular, the introduction of randomness [67, 91-95] such as in the qDRIFT algorithm [29, 68, 96-102] has particularly good theoretical performance for non-sparse Hamiltonians H, i.e. when the number of terms in the Hamiltonian grows faster than [symbol] (L) where L is the number of qubits. These algorithms have in common that they only approximate the continuous time evolution with finite-depth circuits, and display discretization errors (sometimes called Trotter errors) that vanish only with infinitely many gates. This is particularly problematic for adiabatic state preparation (since Trotter errors generically lead to an effective heating) [6, 45, 103] and in applications like quantum chemistry [37, 104-108] where extreme precision is desired. More sophisticated algorithms have better theoretical scalings, such as linear combination of unitaries [19, 20, 21] (LCU), quantum signal processing [22-26] or quantum walks [109,110], but require a large resource overhead. As a consequence, at least in the near term, exact continuous time dynamics is considered to be the prerogative of non-gate-based, analog quantum simulators [111-115].

In this Appendix we introduce an algorithm to compute Hamiltonian dynamics of observables [symbol] [symbol] (t) [symbol] = [symbol] 0|e^{iHt} [symbol] e^{-iHt}|0 [symbol] on digital quantum computers without discretization error even with a finite number of gates, for any Hamiltonian H and unitary [symbol] . The expectation value [symbol] [symbol] (t) [symbol] is obtained as the average over random circuits drawn from a judiciously chosen distribution, multiplied by a known factor. One can choose freely the angle τ of the rotations entering the circuit, only modifying the multiplicative factor and not the precision of the result. It allows one to decrease the gate count at the cost of an increased number of shots on a quantum computer, yielding a natural noise-mitigation technique. The optimal choice of gate angle yields a shot overhead of order [symbol] (1) with a gate count per circuit [symbol] (t²μ²) where μ is the 1-norm of the Hamiltonian, without any dependence on the precision desired, contrary to all previous algorithms. Since the gate count depends only on u, the algorithm is particularly adapted to non-sparse Hamiltonians. It also straightforwardly generalizes to time-dependent Hamiltonians without any overhead. We demonstrate the algorithm with numerical simulations of the electronic structure of the stretched water molecule and of a 2D Ising model where it outperforms both Trotter formulas as well as other randomised compilation techniques.

Simulating Small-Angle Gates with Large-Angle Gates.

We first introduce the basic mechanism that underpins our algorithm. For a real number 0≤p≤1, an angle τ and O any operator such that O²=I, we have the equality

$$1 - p + {pe}^{i τ O} = λ {e}^{i τ′ O} , \qquad ( 63 )$$

$$where$$

$$tan {τ}^{′} = \frac{p sin τ}{1 - p + p cos τ} , λ = \frac{p sin τ}{sin {τ}^{′}} . \qquad ( 64 )$$

This relation can be used to realize an effective angle 0<τ′<τ by applying e^{iτ0} with probability

$$p = \frac{tan {τ}^{′}}{sin τ + ( 1 - cos τ ) tan {τ}^{′}} . \qquad ( 65 )$$

To see this, we consider a circuit that contains G many rotations e^{iτ′O} and that produces the wave function |ψ [symbol] . For a subset S of these rotations, we denote |ψ_{S} [symbol] the wave function obtained with the same circuit but with deleting the rotations e^{iτ′O} contained in S and replacing the remaining rotations e^{iτ′O} not in S by e^{iτO}. Then, for any observable [symbol] , by repeatedly applying (63), we have

$${\sum }_{S , {S}^{′}} {( 1 - p )}^{\vert S \vert + \vert {S}^{′} \vert} {p}^{2 G - \vert S \vert - \vert {S}^{′} \vert} 〈 {ψ}_{{S}^{′}} \vert ℳ \vert {ψ}_{S} 〉 = {λ}^{2 G} 〈 ψ \vert ℳ \vert ψ 〉 , \qquad ( 66 )$$

where the sum runs over all the possible subsets S, S′ of gates to delete in the original circuit.

The expectation value [symbol] ψ| [symbol] |ψ [symbol] that originally involves a circuit with angle τ′>0 can thus be exactly computed with a circuit involving only larger angles τ>τ′ but in which some rotations are randomly removed. This however comes with an attenuation factor λ^{2G}<1 which increases the total number of shots required to reach a given precision on [symbol] ψ| [symbol] |ψ [symbol] . The same reasoning applies to rotations with a negative angle τ′<0, with then τ<τ′. We note that similar mechanisms have been used recently to implement arbitrary rotation angles [116].

### Continuous Time Limit.

We now consider a Hamiltonian H that we write as a linear combination of N operators Oₙ that satisfy

$${O}_{n}^{2} = I ,$$

### I.e.

$$H = {\sum }_{n = 1}^{N} {c}_{n} {O}_{n} , \qquad ( 67 )$$

which is always possible by writing it as a sum of product of Pauli matrices. We would like to compute the expectation value of a unitary [symbol] within the wave function |ψ(t) [symbol] =e^{iHt}|ψ(0) [symbol] .

According to the Trotter-Suzuki formula, we have:

$${e}^{itH} = {lim}_{{τ}^{′} \to {0}^{+}} {( {e}^{i {τ}^{′} {c}_{1} {O}_{1}} … {e}^{i {τ}^{′} {c}_{N} {O}_{N}} )}^{t / {τ}^{′}} . \qquad ( 68 )$$

For each n=1, . . . , N, we choose 0<τₙ≤π/2 and implement e^{iτ′c}^{ₙ}^{O}^{ₙ} using the previously explained protocol with angle τₙ. In the sequence of rotations appearing on the right-hand side of (68), instead of each rotation e^{iτ′c}^{ₙ}^{O}^{ₙ} we thus apply e^{iτ}^{ₙ}^{sgn(c}^{ₙ}^{)O}^{ₙ} with probability pₙ given by

$${p}_{n} = \frac{{τ}^{′} \vert {c}_{n} \vert}{sin {τ}_{n}} + 𝒪 ( {( {τ}^{′} )}^{2} ) . \qquad ( 69 )$$

The corresponding attenuation factor λₙ is

$${λ}_{n} = 1 - {τ}^{′} \vert {c}_{n} \vert tan ( {τ}_{n} / 2 ) + 𝒪 ( {( {τ}^{′} )}^{2} ) . \qquad ( 70 )$$

In the limit τ′→0, the probability of picking a rotation pₙ→0 becomes a rare event and we converge to a Poisson process. Namely, for each rotation e^{iτ}^{ₙ}^{sgn(c}^{ₙ}^{)O}^{ₙ} we obtain a sequence of gate times

$$0 < {t}_{n}^{( 1 )} < … < {t}_{n}^{( {m}_{n} )} < t$$

drawn from a Poisson process with rate |cₙ|/sin τₙ. For a given realization T of all these times for different n's, we denote |ψ_{T} [symbol] the wave function obtained by applying the rotations e^{iτ}^{ₙ}^{sgn(c}^{ₙ}^{)O}^{ₙ} ordered by time of occurrence

$${t}_{n}^{( i )} ,$$

irrespective of n. Averaging expectation values over a plurality of quantum circuit configurations for a transverse-field Ising Hamiltonian, with U_{O}=e^{iτO} acting on a set of qubits provides an average that converges to the exact time-evolved expectation value [symbol] 0|e^{iHt} [symbol] e^{-iHt}|0 [symbol] , up to a known multiplicative constant.

Then, denoting [symbol] the expectation value with respect to two independent configurations T, T′, we have

$$〈 ψ ( t ) \vert ℳ \vert ψ ( t ) 〉 = \frac{𝔼 [ 〈 {ψ}_{{T}^{′}} \vert ℳ \vert {ψ}_{T} 〉 ]}{{λ}_{att}} , \qquad ( 71 )$$

with the total attenuation

$${λ}_{att} = exp ( - 2 t {\sum }_{n = 1}^{N} \vert {c}_{n} \vert tan ( {τ}_{n} / 2 ) ) . \qquad ( 72 )$$

This is the fundamental relation that defines our algorithm. Remarkably, the exact expectation value at time t under continuous time dynamics can be obtained without discretization error, by only applying rotations with application time τₙ>0 fixed. Moreover, the average number of rotations in each circuit is

$${N}_{rot} = 2 t {\sum }_{n = 1}^{N} \frac{\vert {c}_{n} \vert}{sin {τ}_{n}} , \qquad ( 73 )$$

which is finite and only controlled by τₙ and not by the precision wanted on the result. We note that the statistical variance in estimating [symbol] ψ(t)| [symbol] |ψ(t) [symbol] is bounded by

$${λ}_{att}^{- 1} .$$

An important consequence of this attenuation factor λₐₜₜ is thus to increase the number of shots required by a factor

$${λ}_{att}^{- 2}$$

to reach a given precision.

### Statement of the Algorithm.

We state here the algorithm deduced from the previous explanations. It takes as input a Hamiltonian H decomposed as in (67), a unitary observable [symbol] , a time t and an initial state |ψ(0) [symbol] , and outputs [symbol] ψ(t)| [symbol] (t) [symbol] . It takes 0<τₙ≤π/2 as N parameters.
1. Prepare the system in the initial state |ψ(0) [symbol] .
2. For each n∈{1, . . . , N}, draw an integer mₙ from a Poisson distribution with parameter

$$\frac{\vert {c}_{n} \vert t}{sin \vert {τ}_{n} \vert} .$$

Then draw mₙ real numbers

$${t}_{n}^{( i )} ,$$

where i∈{1, . . . , mₙ}, uniformly at random between 0 and t. These

$$M ≡ {\sum }_{n = 1}^{N} {m}_{n}$$

numbers are collected into a set T.
3. Deduce then the sequence k₁, . . . , K_{M}∈{1, . . . , N} such that the index n corresponding to the j-th smallest element of T is kⱼ. For m=1, . . . , M in this order, apply the rotation

$${e}^{i {τ}_{{k}_{m}} s g n ( {c}_{{k}_{m}} ) {O}_{{k}_{m}}}$$

on the system.
4. Apply the observable [symbol] on the system.
5. Repeat steps (2) and (3) with τₙ replaced by −τₙ.
6. Measure the overlap with the initial state and divide the result by λₐₜₜ given in (72). On a quantum computer, this step requires to perform a Hadamard test.
7. Repeat steps (1) to (6) a number of times and average the results.

When measuring the overlap with the initial state, one has to choose a number of shots S to do per configuration, i.e. how to distribute the resources between number of configurations and accuracy of each configuration. If we neglect compilation time, the optimal number of shots can be seen to be S=1 [117].

### Measurement of the Time Evolution Operator.

The algorithm presented above can be adapted to computing the amplitude [symbol] ψ(0)|e^{iHt}|ψ(0) [symbol] . It is often called Loschmidt amplitude in the condensed matter literature and can be used to determine ground state energies as well as microcanical expectation values [74, 118]. With the same notations as in Eq. (71), we have [symbol] ψ(0)|e^{iHt}|ψ(0) [symbol] =E [symbol] ψ((0)|ψ_{T} [symbol] ]/\sqrt{λₐₜₜ}. One thus skips steps (4) and (5) in the algorithm above, and replace the attenuation factor λₐₜₜ by \sqrt{λₐₜₜ} in step (6).

### Optimal Angle on a Perfect Quantum Computer.

Formula (71) holds for any choice of gate angle τₙ. Increasing the gate angle τₙ decreases the number of rotations per circuit Nᵣₒₜ, but also decreases the attenuation factor λₐₜₜ, and so increases the number of shots

$${λ}_{att}^{- 2}$$

that have to be performed to reach a given precision. The total number of rotations

$$R ( \{ {τ}_{n} \} ) = {N}_{rot} {λ}_{att}^{- 2}$$

to perform to get a precision of order [symbol] (1) on the result is thus a non-trivial function of the gate angles τₙ, that reaches a minimum at some

$${τ}_{n}^{*}$$

that can be computed numerically. At large t, we find analytically that the optimal angle is

$${τ}_{n}^{*} = \frac{1}{2 t μ} , \qquad ( 74 )$$

for all n=1, . . . , N, where

$$μ = {\sum }_{n = 1}^{N} \vert {c}_{n} \vert$$

is the 1-norm of the Hamiltonian [117]. In that limit we find λₐₜₜ=e^{-1/2} which remains finite and Nᵣₒₜ=4t²μ². Hence the gate count per circuit scales as

$$𝒪 ( {t}^{2} {μ}^{2} ) . \qquad ( 75 )$$

The number of shots to perform to reach precision E scales as [symbol] (ϵ⁻²). But remarkably, the precision E does not enter the gate count, which remains finite even when ϵ→0. This differs from usual algorithms such as Trotter, qDRIFT or LCU, whose gate count we recall in Table 1.

TABLE 1
Gate count of different algorithms for Hamiltonian dynamics

| Trotter K-th order | qDRIFT | LCU | our algorithm |
|---|---|---|---|
| N(Nt)^{1+1/K}ϵ^{-1/K} | t²μ² ϵ⁻¹ | $N μ t \frac{log ( μ t / ϵ )}{log log μ t / ϵ}$ | t²μ² |

In Table 1, N refers to the number of terms in the Hamiltonian, μ its 1-norm, t the simulation time and e the precision reached on the result.

### Optimal Angle on a Noisy Quantum Computer.

The optimal angle value (74) holds for a perfect, noiseless quantum computer. Let us explain how this formula is modified in presence of noise. For simplicity, we assume that the application of each gate e^{iτ}^{ₙ}^{sgn(c}^{ₙ}^{)O}^{ₙ} comes with a signal attenuation e^{-r}^{ₙ} with some rₙ>0. This kind of noise model is known to be a rough first approximation of the effect of the noise on current hardware. Moreover, other types of noise can be converted into this global depolarizing noise through some noise mitigation techniques [50, 51, 73]. In state-of-the-art devices typical two-qubit gate fidelities are e^{-r}˜99.8%, in which case r˜2e−3 [33]. There are on average

$$\frac{t \vert {c}_{n} \vert}{sin {τ}_{n}}$$

such rotations per configuration. The damping due to hardware imperfection is thus

$${q}_{att} = exp ( - 2 t {\sum }_{n = 1}^{N} \frac{{r}_{n} \vert {c}_{n} \vert}{sin {τ}_{n}} ) . \qquad ( 76 )$$

The total attenuation of the signal is λₐₜₜqₐₜₜ. Assuming rₙ small, the optimal times

$${τ}_{n}^{*}$$

that minimize the total gate count at large t are now [117]

$${τ}_{n}^{*} = \sqrt{2 {r}_{n}} . \qquad ( 77 )$$

### Time-Dependent Hamiltonian.

The algorithm can be generalized straightforwardly to dynamics with a time-dependent Hamiltonian H(t). Decomposing

$$H ( t ) = {\sum }_{n = 1}^{N} {c}_{n} ( t ) {O}_{n} , \qquad ( 78 )$$

with time-dependent coefficients cₙ(t), and denoting

$$\vert ψ ( t ) 〉 = 𝒥 exp ( i {\int }_{0}^{t} dsH ( s ) ) \vert ψψ ( 0 ) 〉 ,$$

the expectation value of operators [symbol] can again be written as an average over configurations (71).

The configurations |ψ_{T} [symbol] are produced by drawing times

$$0 < {t}_{n}^{( 1 )} < … < {t}_{n}^{( {m}_{n} )} < t$$

from a Poisson process with time-dependent rate |cₙ(s) |/sin τₙ, for each n=1, . . . , N, and applying on the initial wave function each gate e^{iτ}^{ₙ}^{sgn(c}^{ₙ}^{)O}^{ₙ} ordered by time of occurrence

$$s = {t}_{n}^{( i )} .$$

The attenuation factor is then obtained by replacing t|cₙ| by

$${\int }_{0}^{t} ds \vert {c}_{n} ( s ) \vert .$$

In practice, we proceed as follows. We introduce the function

$${z}_{n} ( u ) = {\int }_{0}^{u} ds \vert {c}_{n} ( s ) \vert , \qquad ( 79 )$$

as well as

$${z}_{n}^{- 1} ( u )$$

its reciprocal, i.e. such that

$${z}_{n}^{- 1} ( {z}_{n} ( u ) ) = u .$$

We replace step (2) of the time-independent case by the following step:
1. For each n∈{1, . . . , N}, draw an integer mₙ from a Poisson distribution with parameter

$$\frac{{z}_{n} ( t )}{sin \vert {τ}_{n} \vert} .$$

Then draw mₙ real numbers

$${\tilde{t}}_{n}^{( i )} ,$$

where i∈{1, . . . , mₙ}, uniformly at random between 0 and zₙ(t), and set

$${t}_{n}^{( i )} = {z}_{n}^{- 1} ( {\tilde{t}}_{n}^{( i )} ) .$$

these

$$M ≡ {\sum }_{n = 1}^{N} {m}_{n}$$

numbers

$${t}_{n}^{( i )}$$

are collected into a set T.

Then in step (3), the rotation applied is

$${e}^{i {τ}_{{k}_{m}} sgn ( {c}_{{k}_{m}} ( s ) ) {O}_{{k}_{m}}}$$

where

$$s ∈ \{ {t}_{n}^{( i )} \}$$

is the time at which the rotation is applied. For the backward propagation one has to reverse the order of the gates. The total attenuation λₐₜₜ of step (6) is

$${λ}_{att} = exp ( - 2 {\sum }_{n = 1}^{N} {z}_{n} ( t ) tan ( {τ}_{n} / 2 ) ) . \qquad ( 80 )$$

This algorithm produces the exact time evolution of the wave function under the time-dependent Hamiltonian H(t), without errors arising from discretizing the continuous function cₙ(s) or Trotter errors.

### Background Hamiltonian.

The algorithm has the following simple improvement. Let us consider a subset of gates [symbol] ⊂{Oₙ}_{n=1, . . . , N} that all commute among themselves, i.e. [O, O′]=0 for all O, O′∈ [symbol] , and denote H_{background}=ΣCₒ_{_{p∈}} [symbol] cₚOₚ. If for these terms we take the limit of zero angle τₚ→0 in the algorithm, the Poisson process almost always picks rotations of terms in [symbol] with very short angle. But since they commute this can be implemented with a finite product of e^{iτO} with τ obtained by summing the different angles. Hence the algorithm is modified as follows. In step (2) we only draw times corresponding to terms not in [symbol] , and use them to produce an ordered sequence of gates as in step (3). However, between each application of these rotations e^{iτ}^{ₙ}^{O}^{ₙ} and e^{iτ}^{ₘ}^{O}^{ₘ} at times sₙ<sₘ, we apply e^{iδsH}^{_{background}} with δs=sₘ−sₙ the difference between the two instants at which the rotations are applied. This reduces the attenuation factor λₐₜₜ, which is now computed only including the terms not in [symbol] . The Hamiltonian H_{background} thus plays the role of a “background” Hamiltonian that is always applied on the system, but on top of which rotations e^{iτ}^{ₙ}^{O}^{ₙ} with [symbol] ₙ∉ [symbol] are applied.

### Numerical Tests.

We now show numerical simulations of our algorithm. We start with a noisy implementation on a non-sparse Hamiltonian as routinely encountered in quantum chemistry. Hamiltonians describing molecular electronic structure problems are typically decomposed in a basis set of fermionic orbitals, where they read

$$H = {\sum }_{ij = 1}^{N} {h}_{ij} {c}_{i}^{†} {c}_{j} + {\sum }_{ijkl = 1}^{N} {h}_{ijkl} {c}_{i}^{†} {c}_{j}^{†} {c}_{k} {c}_{l} , \qquad ( 81 )$$

with c's canonical fermionic operators and N the number of orbitals considered. Written in terms of Pauli gates through a Jordan-Wigner transformation, these molecular Hamiltonians involve thus [symbol] (N⁴) terms with each [symbol] (N) Pauli gates, incurring a prohibitively large gate count for any Trotter implementation of the dynamics.

We consider a H₂O water molecule in a STO-6G basis with 14 orbitals, and use our algorithm to study the Loschmidt amplitude

$$ℒ ( t ) = 〈 HF \vert {e}^{itH} \vert HF 〉 , \qquad ( 82 )$$

where |HF [symbol] denotes the Hartree-Fock ground state.

We take a geometry with an angle H-O-H of 105° and with an elongated distance H-O of 2.2 Å, to have a significant difference between the exact ground state and |HF [symbol] . On a noisy hardware, we propose to compute the ratio

$$R ( t ) = \frac{𝒥ℒ ( t )}{ℛ ℒ ( t )} . \qquad ( 83 )$$

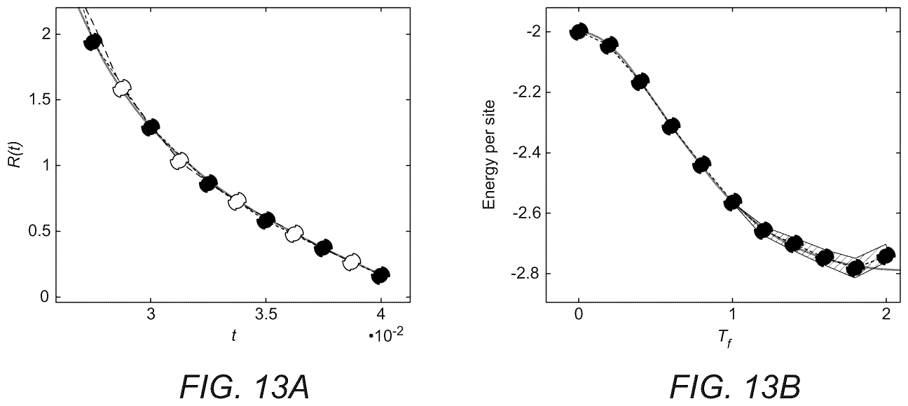

This ratio is not sensitive to the depolarizing part of the hardware noise, but still contains information about the energy levels in the oscillation frequencies. In the left panel of FIG. 13A we show a noisy simulation of our algorithm that includes a depolarizing channel with probability 0.002 after each 2-qubit gate, and observe very good agreement. In particular, FIG. 13A shows a noisy simulation of a computational chemistry Hamiltonian, with gate angles (77), with 2000 circuits with 20 shots each.

Next, we show numerical results for the time-dependent case of our algorithm. For this case, we consider the 2D square lattice Ising model in a transverse field h, whose Hamiltonian is

$$H = - {\sum }_{〈 i , j 〉} {Z}_{i} {Z}_{j} - h {\sum }_{j} {X}_{j} , \qquad ( 84 )$$

with periodic boundary conditions.

We implement the adiabatic preparation of the ground state at h_{f}=2.5, starting from h=0. For a final time Tr we consider the time-dependent magnetic field

$$h ( t ) = {h}_{f} {sin ( \frac{π}{2} {sin ( \frac{π t}{2 {T}_{f}} )}^{2} )}^{2} . \qquad [ 119 ]$$

In the right panel of FIG. 13B we show the final energy per site obtained at t=T_{f}, as a function of T_{f}, together with the error bars for a fixed number of shots. Specifically FIG. 13B shows an adiabatic state preparation, noiseless simulations with 10⁵ circuits and τ=0.04 (circles with a dashed line, the shade indicating one standard deviation), and exact value (lighter continuous line). We see the agreement with the exact values, as well as the broadening of the error bars as T_{f} grows at fixed τ, as imposed by (72).

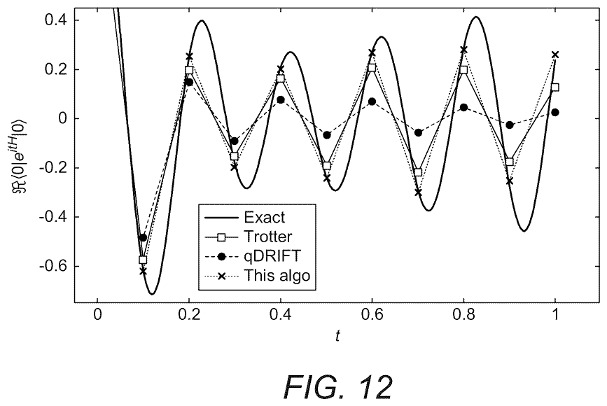

Finally, we compare our algorithm to first-order Trotter and qDRIFT in the case of the 2D square lattice Ising model (84) with magnetic field h=2, which is a typical model studied in condensed matter. In FIG. 12 we plot the real part of the Loschmidt amplitude [symbol] 0|e^{iHt}|0 [symbol] in the 2D Ising model at h=2 in size 3×4, starting from the Z=+1 product state |0 [symbol] , comparing Trotter, qDRIFT and the algorithm described in this patent specification, using a same gate angle τ=0.1 for our algorithm and for qDRIFT, and with a same time step 0.1 for Trotter. We take 10⁵ shots per point (which is necessary to have a precision <0.01 with high confidence), and distribute them over 10³ random circuits with 10² shots per circuit for our case and for qDRIFT. We see that our algorithm gives almost perfect results. In particular, it works considerably better than qDRIFT. We also see that it performs better than Trotter. This shows the practical use of our algorithm.

### Interpolation Between Quantum Time Evolution and Path Integral Representation.

Some comments about the upper and lower limits of the angle τ are in order. When τ→0, the different rotations e^{iτO}^{ₙ} commute at order t and there are increasingly more rotations drawn from the Poisson process. With probability 1 in this limit, a single configuration |ψ_{T} [symbol] is equal to the exact time evolution e^{iHt}|0 [symbol] , and the attenuation factor (72) is equal to 1. When τ=π/2, we have e^{iτO}^{ₙ}=iOₙ, and so when Oₙ is a string of Pauli operators, the rotations can be implemented with only one-qubit gates. Each configuration |ψ_{T} [symbol] remains thus a product state in the Z basis and describes a classical trajectory in discrete time. Thus (71) becomes akin to a path integral representation, in the sense that a quantum expectation value is expressed as an averaging over exponentially many classical trajectories.

These two limits provide thus an interesting interpretation of our algorithm as an interpolation between a single quantum trajectory for τ=0, and exponentially many classical trajectories for τ=π/2. Intermediate values of τ near π/2 allow one to decrease the entanglement present in each configuration |ψ_{T} [symbol] compared to the exact time-evolved state e^{iHt}|0 [symbol] , but at the cost of increasing the number of samples required through the attenuation factor (72). This could find applications in the classical simulation of quantum dynamics.

### Discussion

We presented a quantum algorithm to compute continuous Hamiltonian dynamics that requires a circuit depth that is independent of the desired precision, contrary to many algorithms that require an infinite depth when ∈→0. We show that by applying randomly gates on the initial state according to a well-chosen distribution, and multiplying the result by a known amplification factor, one achieves zero discretization error while having finite-depth circuits. This amplification factor however increases the number of shots required to reach a given precision. The algorithm is particularly adapted to non-sparse Hamiltonians as the gate count only depends on the 1-norm and not the number of terms.

The algorithm and its mechanisms can be generalized in a number of ways. For example, decomposing a circuit into Clifford gates and T-gates, one can implement each T-gate by applying a e^{iZπ/4}-gate or no gate both with probability ½, which is a S-gate times a global phase. Hence, because of the attenuation factor λ=cos(π/8) for each replaced T-gate, this enables one to sample classically from a circuit with t many T-gates in a time

$${e}^{2 \vert log ( cos \frac{π}{8} ) \vert t}$$

multiplied by the simulation time of the resulting Clifford circuits. The exponent matches the currently best known exponent [120].

### Implementation Detail

### Optimal Number of Shots Per Circuit.

In the described computer-implemented method, an expectation value is expressed as an average over random circuits. Each of these random circuits is then implemented on a quantum computer with a certain number of shots. Expectation values are computed by averaging measurement outcomes over multiple shots—i.e. multiple realizations of the same circuit. Let us denote S the number of shots per circuit and N/S the number of circuits. At fixed N, we would like to find the value of S that minimizes the variance on the result, taking into account both the shot noise and the statistical error due to the random circuits.

Given a random circuit U drawn from the Poisson process, we denote −1≤m_{U}≤1 the real part of the complex amplitude that we measure with our algorithm. Given the real part of a complex amplitude −1≤m<1, we denote xₘ the Bernoulli random variable that takes value +1 with probability

$$\frac{1 + m}{2} and - 1$$

with probability

$$\frac{1 - m}{2} .$$

We denote [symbol] the expectation value with respect to the random circuit U, and [symbol] [symbol] the expectation value with respect to the shot noise. The exact value of the real part of the complex amplitude that we measure after averaging over random circuits and shots is

$$m = 𝔼 [ 〈 {x}_{{m}_{U}} 〉 ] . \qquad ( 85 )$$

With S shots to evaluate my and N/S different circuits U, the estimated value mₑₛₜ of m is

$${m}_{est} = \frac{1}{N / S} {\sum }_{p = 1}^{N / S} \frac{1}{S} {\sum }_{i = 1}^{S} {x}_{{m}_{{U}_{p}}}^{( i )} , \qquad ( 86 )$$

where the Uₚ's are independent circuits drawn from the Poisson process, and where the

$${x}_{{m}_{{U}_{p}}}^{( i ) ′} s$$

are independent Bernoulli random variables with parameter

$$\frac{1 + {m}_{{U}_{p}}}{2} .$$

Let us compute the variance of this quantity.

We have

$$\begin{matrix}{m}_{est}^{2} = \frac{1}{{N}^{2}} {\sum }_{i , j , p , q} {x}_{{m}_{{U}_{p}}}^{( i )} {x}_{{m}_{{U}_{q}}}^{( j )} \\ = \frac{1}{N} + \frac{1}{{N}^{2}} {\sum }_{i , j , p , q i \neq jorp \neq q} {x}_{{m}_{{U}_{p}}}^{( i )} {x}_{{m}_{{U}_{q}}}^{( j )}\end{matrix} , \qquad ( 87 )$$

where we used that

$${( {x}_{{m}_{{U}_{p}}}^{( i )} )}^{2} = 1 .$$

Then, averaging over the shots

$$\begin{matrix}〈 {m}_{est}^{2} 〉 = \frac{1}{N} + \frac{1}{{N}^{2}} {\sum }_{i , j , p , q i \neq jorp \neq q} {m}_{{U}_{p}} {m}_{{U}_{q}} \\ = \frac{1}{N} + \frac{{S}^{2}}{{N}^{2}} {( {\sum }_{p} {m}_{{U}_{p}} )}^{2} - \frac{S}{{N}^{2}} {\sum }_{p} {m}_{{U}_{p}}^{2}\end{matrix} . \qquad ( 88 )$$

In the case where we have only one circuit U, i.e. S=N, we have

$$〈 {m}_{est}^{2} 〉 - {〈 {m}_{est} 〉}^{2} = \frac{1 - {m}_{U}^{2}}{N} ,$$

which is the usual variance of a Bernoulli random variable taking values ±1 with mean m_{U}. In the general case, after averaging over the circuits we have

$$𝔼 [ 〈 {m}_{est}^{2} 〉 ] = \frac{1}{N} + \frac{{S}^{2}}{{N}^{2}} ( \frac{{N}^{2}}{{S}^{2}} {𝔼 [ {m}_{U} ]}^{2} + \frac{N}{S} 𝔼 [ {m}_{U}^{2} ] - \frac{N}{S} {𝔼 [ {m}_{U} ]}^{2} ) - \frac{1}{N} 𝔼 [ {m}_{U}^{2} ] . \qquad ( 89 )$$

Denoting

$$v = 𝔼 [ {m}_{U}^{2} ] - {𝔼 [ {m}_{U} ]}^{2}$$

the variance over the circuits, it yields

$$𝔼 [ 〈 {m}_{est}^{2} 〉 ] - {𝔼 [ 〈 {m}_{est} 〉 ]}^{2} = \frac{1 - v}{N} + \frac{S}{N} v . \qquad ( 90 )$$

Since v≥0, we obtain that at fixed total number of shots N, doing only one shot S=1 per circuit minimizes the total variance.

### Optimal Gate Angles.

When measuring an observable [symbol] with our algorithm with gate angles τₙ, in absence of noise, the total number of rotations to perform to reach a precision E on the result is R({τₙ})/ϵ², where

$$R ( \{ {τ}_{n} \} ) = 2 t {\sum }_{n = 1}^{N} \frac{\vert {c}_{n} \vert}{sin {τ}_{n}} exp ( 4 t {\sum }_{n = 1}^{N} \vert {c}_{n} \vert tan ( {τ}_{n} / 2 ) ) . \qquad ( 91 )$$

Writing ∂_{τ}_{ₙ}R=0 at the optimal gate angle

$${τ}_{n}^{*} ,$$

we find that is satisfies the equation

$$\frac{2 t}{{cos}^{2} ( {τ}_{n}^{*} / 2 )} {\sum }_{p = 1}^{N} \frac{\vert {c}_{p} \vert}{sin {τ}_{p}^{*}} = \frac{cos {τ}_{n}^{*}}{{sin}^{2} {τ}_{n}^{*}} . \qquad ( 92 )$$

The left-hand side is bounded from below by 2tμ. Hence at large t, we necessarily have τₙ→0 for all n to make the right-hand side go to ∞. In that limit we have

$$2 t {\sum }_{p = 1}^{N} \frac{\vert {c}_{p} \vert}{{τ}_{p}^{*}} ∼ {( {τ}_{n}^{*} )}^{- 2} . \qquad ( 93 )$$

The left-hand side is independent of n, so the leading behavior of

$${τ}_{n}^{*}$$

when t→∞ is independent of n. Denoting this leading behaviour τ*, we thus have 2tμ(τ*)⁻¹=(τ*)⁻², and so

$${τ}_{n}^{*} = \frac{1}{2 t μ} \qquad ( 94 )$$

Let us now consider the noisy case where each rotation e^{iτ}^{ₙ}^{O}^{ₙ} comes with an attenuation factor e^{-r}^{ₙ}. The damping due to noise per circuit is thus

$$exp ( - 2 t {\sum }_{n = 1}^{N} \frac{\vert {c}_{n} \vert {r}_{n}}{sin {τ}_{n}} ) .$$

The total number of rotations to reach a precision ϵ is thus R({τₙ})/ϵ², with now

$$R ( \{ {τ}_{n} \} ) = 2 t {\sum }_{n = 1}^{N} \frac{\vert {c}_{n} \vert}{sin {τ}_{n}} exp ( 4 t {\sum }_{n = 1}^{N} \vert {c}_{n} \vert tan ( {τ}_{n} / 2 ) + 4 t {\sum }_{n = 1}^{N} \frac{\vert {c}_{n} \vert {r}_{n}}{sin {τ}_{n}} ) . \qquad ( 95 )$$

Writing again ∂_{τ}_{ₙ}R=0 at the optimal gate angle

$${τ}_{n}^{*} ,$$

we find that it satisfies the equation

$$2 t ( \frac{1}{{cos}^{2} ( {τ}_{n}^{*} / 2 )} - \frac{2 {r}_{n} cos {τ}_{n}^{*}}{{sin}^{2} {τ}_{n}^{*}} ) {\sum }_{p = 1}^{N} \frac{\vert {c}_{p} \vert}{sin {τ}_{p}^{*}} = \frac{cos {τ}_{n}^{*}}{{sin}^{2} {τ}_{n}^{*}} . \qquad ( 96 )$$

Let us assume that when t→∞, the quantity

$$Q ≡ \frac{1}{{cos}^{2} ( {τ}_{n}^{*} / 2 )} - \frac{2 {r}_{n} cos {τ}_{n}^{*}}{{sin}^{2} {τ}_{n}^{*}}$$

does not go to 0. Then the same reasoning as above would apply and we would have τₙ*→0. But then we would have Q→−∞, and so the right-hand side would become negative, which cannot be. Hence we must have Q→0. This yields an equation for

$${τ}_{n}^{*}$$

when t→∞

$$\frac{1}{{cos}^{2} ( {τ}_{n}^{*} / 2 )} = \frac{2 {r}_{n} cos {τ}_{n}^{*}}{{sin}^{2} {τ}_{n}^{*}} . \qquad ( 97 )$$

Assuming rₙ small, this is

$${τ}_{n}^{*} = \sqrt{2 {r}_{n}} . \qquad ( 98 )$$

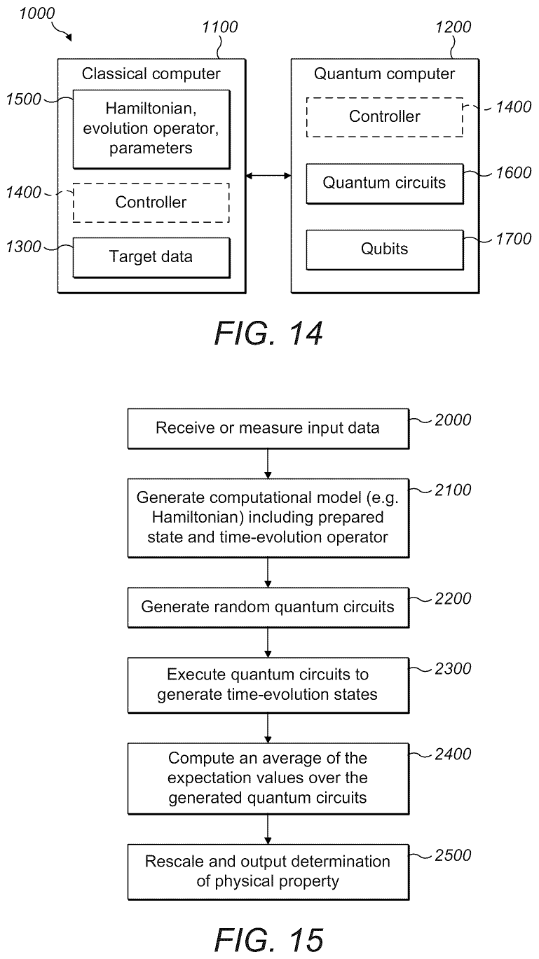

FIG. 14 is a schematic diagram showing a potential implementation of a quantum computing system 1000. The quantum computing system 1000 comprises two components, a classical computer 1100 and a quantum computer 1200. The classical computer 1100 may comprise a known form of digital computer(s) including one or more processors for executing program instructions and memory for storing the program instructions and data.

The classical computer 1100 may comprise target data 1300, a controller 1400 (which may also be a component within the quantum computer 1200 instead) and a Hamiltonian 1500. The Hamiltonian 1500 represents a physical system and may comprise an evolution operator and one or more parameters. The controller 1400 may be used to manage various interoperations between the classical computer 1100 and the quantum computer 1200, for example, transferring a compiled quantum circuit (program) to the quantum computer 1200 for execution. The controller 1400 may also allow a user to specify settings for the program which are then applied during execution of the program. The target data 1300 may represent data relating to the physical system that is being modelled.

The quantum computer 1200 may comprise a controller 1400 (which may also be a component within the classical computer 1100 instead), quantum circuits 1600, and qubits (or qudits) 1700. The quantum circuits 1600 may be configured to interact directly with the hardware of the quantum computer, for example to create and manipulate the qubits 1700. The quantum circuit 1700 may be considered as somewhat analogous to a compiled program (low-level code) which has been adapted to run on the specific hardware implementation of the quantum computer, such as reflecting the number and connectivity of the qubits and gates available on the quantum computer. More generally, it will be appreciated that the configuration and architecture shown in FIG. 14 is provided by way of illustration and not by way of limitation and hence the approach described herein may be implemented on many different types of quantum computing systems or platforms.

FIG. 15 shows a sequence of steps of an example of a method as disclosed herein for determining a physical property of a quantum state of a physical system. Operation 2000 comprises receiving or measuring input data. This input data may relate to the physical system that is to be modelled. Operation 2100 generates a computational model (e.g., a Hamiltonian) including a prepared initial state and a time-evolving operator. This computational model may represent the physical system that is to be modelled. The initial computational state may represent a state of the physical system and the time evolution operator may perform an evolution over time of the prepared initial computational state towards a target computational state. Operation 2200 generates random quantum circuits. These random quantum circuits may comprise a sequence of rotations of one of the terms with a fixed gate angle, drawn randomly and independent of each other with a rate given by a function of the gate angle. Operation 2300 executes the quantum circuits to generate time-evolution states. The quantum circuits may be executed on qubits or qudits of a quantum computing system, which qubits or qudits are measured to output expectation values of the time-evolution operator. Operation 2400 computes an average of the expectation values over the generated quantum circuits. Operation 2500 rescales and outputs a determination of a physical property. The computed average may be rescaled by a factor that is a function of the gate angle.

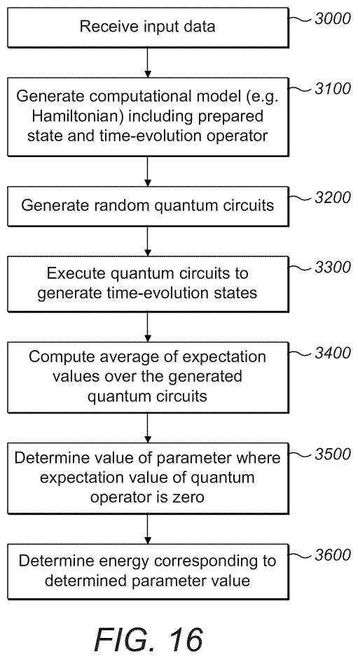

FIG. 16 shows a sequence of steps of an example of a method as disclosed herein for determining the energy of a quantum state of a physical system. Operation 3000 receives input data. This input data may relate to the physical system that is to be modelled. Operation 3100 generates a computational model (e.g., a Hamiltonian) including a prepared state and a time-evolution operator. This computational model may represent the physical system that is to be modelled. The prepared computational state may represent a state of the physical system and the time evolution operator may perform an evolution over time of the prepared computational state. The operator may comprise a parameter that encodes the energy of the time-evolved computational state and also comprise a parameter-dependent expectation value that is zero when the parameter is equal to the ground state energy of the state. Operation 3200 generates quantum circuits, optionally using the random circuits of the method of FIG. 15. These quantum circuits may correspond to the computational model. Operation 3300 executes the quantum circuits to generate time-evolution states. The quantum circuits may be executed on qubits or qudits of a quantum computing system to compute the effects of the time-evolution operator of the computational model. If using the described method of FIG. 15, Operation 3400 computes an average of the expectation values over a plurality of shots of the randomly generated quantum circuits (but the indirect measurement to determine a ground state energy of FIG. 16 could be implemented without the averaging over random circuits of FIG. 15). Operation 3500 determines a value of the parameter where the expectation value of the quantum operator is zero. Operation 3600 determines the energy corresponding to the determined parameter value. The energy may be the ground state energy of the time-evolved quantum state.

Simulating Sparse SYK Model with a Randomized Algorithm on a Trapped-Ion Quantum Computer

The Sachdev-Ye-Kitaev (SYK) model describes a strongly correlated quantum system that shows a strong signature of quantum chaos. Due to its chaotic nature, the simulation of real-time dynamics becomes quickly intractable by means of classical numerics, and thus, quantum simulation is deemed to be an attractive alternative. Nevertheless, quantum simulations of the SYK model on noisy quantum processors are severely limited by the complexity of its Hamiltonian. As a mitigation for this problem, the real-time dynamics of a sparsified version of the SYK model are simulated with 24 Majorana fermions on a trapped-ion quantum processor, taking advantage of the high fidelity of qubits based on trapped ions (such as provided in Quantinuum's quantum computing systems). The approach is to adopt the above-described randomized quantum algorithm, TETRIS, and to develop an error mitigation technique tailored to the algorithm. Leveraging the hardware's high-fidelity quantum operations and all-to-all connectivity of the qubits, it is possible to successfully calculate the Loschmidt amplitude for sufficiently long times so that its decay is observed. Based on the experimental and further numerical results, the future possibility of larger-scale simulations of the SYK model is assessed by estimating the required quantum resources. We present a scalable mirror-circuit benchmark based on the randomized SYK Hamiltonian and the TETRIS algorithm, which provides a better estimate of the decay of fidelity for local observables than standard mirror-circuits.

The Sachdev-Ye-Kitaev (SYK) model describes a strongly-interacting quantum system that consists of N Majorana fermions with random q-body interactions [A1-A3]. Its connections to condensed matter physics and non-Fermi liquids make it an attractive model to study strong electronic correlations and disorder in metals and cuprates [A4-A6]. The model has also gained significant attention as it admits a two-dimensional gravitational holographic description in the infrared regime. In fact, it has been used as a paradigmatic model for “Quantum Gravity in the Lab” [A7-A11], a research effort to study quantum gravity phenomena through the holographic duality lenses, leading to new understandings (see e.g. [A6, A12, A13] for reviews). The SYK model exhibits a strong signature of quantum chaos by saturating a universal bound of quantum Lyapunov exponent at low temperatures [A14]. Despite many analytical studies that address the static and dynamic properties of the SYK model under certain limits, further numerical investigations are required to understand them for the other regimes, e.g., finite N, finite-range interaction, etc. Simulation of real-time dynamics is useful for addressing signatures of quantum chaos through the Loschmidt echo, out-of-time-ordered correlators, spectral form factors, and other observables in the toolbox of condensed matter physics and quantum information science.

The real-time dynamics of the SYK model are simulated with four-body interactions (q=4) to explore its feasibility on noisy quantum hardware. Digital quantum simulations of the SYK models on noisy quantum hardware have been severely limited due to their fully non-local interactions and the number of terms scaling as O(N⁴) (see [A4, A15, A16] for experimental works). We alleviate these issues by considering a sparsified version of the SYK model [A17-A23] and employing a recently developed randomized Hamiltonian simulation algorithm, TETRIS (Time Evolution Through Random Independent Sampling) [A24]. This stochastic algorithm enables Hamiltonian simulation without discretization error and is particularly suited for simulating the SYK model, leveraging the randomized nature of the SYK Hamiltonian.

As a demonstrative example we focus on a single dynamical observable: the vacuum survival probability, or Loschmidt amplitude. We choose the Loschmidt amplitude [A25-A28] because it is a key observable to study quantum chaos in the SYK model due to its known connection [A27, A28] with out-of-time-ordered correlators (OTOC) [A29-A34]. In our experiment, we evolve the system for time t under the sparse SYK dynamics employing TETRIS and calculate the survival probability of the all-zero state on a trapped-ion quantum processor, whose all-to-all qubit connectivity facilitates the simulation of non-local interaction in the model. We carefully diagnose the error sources contributing to the measurement outcomes. Moreover, we develop an error mitigation technique that relies on properties of the randomized algorithm we use for computing the time evolution. Our protocol enables the successful simulation of N=24 sparse SYK model until the probability decay inherent to the model's ideal dynamics is observed at Jt˜1.

Besides simulating quantum dynamics of the SYK model, we employ the TETRIS algorithm for benchmarking the noise effect of a quantum processor on a circuit used to estimate a local observables. Mirror circuit benchmarks provide scalable benchmarking protocols, where one measures the survival probability of the initial state after an application of a mirror circuit, that is, a unitary circuit followed by its inverse [A35-A37]. The performance of a quantum processor in running a circuit with a given number of gates is measured by the decay of probability from 1, the ideal value, with faster decays indicating stronger noise effects. In the present work, we consider a variant of the mirror circuit benchmarks, where we use two independently sampled TETRIS unitary circuits, U and U′, that agree only on average with the correct time evolution operator. Thus, the circuit U′^{†}U provides a mirror-on-average circuit in the sense that it is proportional to the identity operator only on average [A38]. We argue that this benchmark gives a better estimate of noise on local observables than the standard mirror circuit benchmark when using this stochastic algorithm for implementing the time evolution.

Finally, we conclude by estimating the required quantum resources by extrapolating our numerical and experimental results and address the feasibility of larger simulations of the SYK model.

Setup.—The q=4 SYK model is a quantum mechanical model with N Majorana fermions ψᵢ({ᵢ,ψⱼ}=2δᵢⱼ) described by the Hamiltonian [A2, A3],

$$H = {\sum }_{i < j < k < l} {J}_{ijkl} {ψ}_{i} {ψ}_{j} {ψ}_{k} {ψ}_{l} , \qquad ( E1 )$$

The couplings Jᵢⱼₖₗ are independent random Gaussian variables with mean 0 and variance

$$Var [ {J}_{ijkl} ] = \frac{3 ! {J}^{2}}{{N}^{3}} .$$

The sparse SYK model is defined by [A17-A23] variance

$$H = {\sum }_{i < j < k < l} {p}_{ijkl} {J}_{ijkl} {ψ}_{i} {ψ}_{j} {ψ}_{k} {ψ}_{l} , \qquad ( E2 )$$

where pᵢⱼₖₗ∈{0,1} are randomly sampled, being equal to 1 with probability p, where p controls the sparsity of the model.

The average number of terms in the Hamiltonian

$$( E 2 ) is p ( \begin{matrix}N \\ 4\end{matrix} ) = O ( {pN}^{4} ) .$$

For gravitational physics to emerge at the infrared regime, one needs to retain an extensive number of terms on average by setting the probability to

$$p = kN / ( \begin{matrix}N \\ 4\end{matrix} )$$

for an N-independent sparsity parameter k [A17].

To maintain the extensive energy, the variance is rescaled as

$$Var [ {J}_{ijkl} ] = \frac{3 ! {J}^{2}}{{pN}^{3}} .$$

Upon taking the disorder average, we find the 1-norm of the Hamiltonian ∥H∥₁=Σ_{i<k<k<l}pᵢⱼₖₗ|Jᵢⱼₖₗ| is

$$\frac{\sqrt{6 p} J}{24} \frac{N !}{{N}^{3 / 2} ( N - 4 ) !} = O ( \sqrt{p} {N}^{5 / 2} ) = O ( N ) . \qquad ( E3 )$$

This Hamiltonian on N Majorana fermions can be expressed in terms of Pauli matrices through the Jordan-Wigner transformation into L=N/2 qubits

$$\begin{matrix}{ψ}_{2 j} & = {X}_{j} {Z}_{j - 1} {Z}_{j - 2} … {Z}_{1} , \\ {ψ}_{2 j + 1} & = {Y}_{j} {Z}_{j - 1} {Z}_{j - 2} … {Z}_{1}\end{matrix} . \qquad ( E 4 )$$

We write the corresponding spin Hamiltonian as

$$H = {\sum }_{n} {c}_{n} {P}_{n} , \qquad ( E5 )$$

with a Pauli string Pₙ.

The resulting SYK Hamiltonians are thus all-to-all coupled, with long Pauli strings of average length O(L), and with random coefficients that can take both small and large values. These properties make these Hamiltonians difficult to simulate. Note that a different fermion encoding could be used, but local encodings [A39, A40] provide diminishing returns due to the non-local and all-to-all nature of the interactions. The ternary tree encoding [A41] could be an attractive possibility due to its favourable scaling, despite the need for additional ancillas, and we will explore it later on. For the system size studied N=24, we found that the Jordan-Wigner encoding was more efficient.

The most widely used simulation technique, Trotterization, scales particularly badly with L for these systems. For a recent work on higher-order product formulas focusing on the SYK model, see reference [A42]. The time evolution operator is approximated by s Trotter steps using the first-order Trotter decomposition,

$${e}^{iHt} \approx {( {e}^{i {c}_{1} {P}_{1} t / s} … {e}^{i {c}_{M} {P}_{M} t / s} )}^{s} . \qquad ( E6 )$$

Since the Pauli strings are of length O(L) on average and the exponentiation of a Pauli string of length O(L) requires O(L) two-qubit (TQ) gates, the cost to implement one single Trotter step is O(pL⁵) TQ gates. Equation (E6) comes with an discretization (Trotter) error O(t²pL⁴/s). The Trotter error arises from non-vanishing commutators of the form [ψᵢψⱼψₖψₗ,ψᵢ,ψⱼ,ψₖ,ψₗ,]. For this to be finite, two four-body terms must share at least one of the fermion indices. There are O(N⁷) such combinations of (ijkl) and (i′j′k′l′). Moreover, each four-body term labelled by (ijkl) exists in a single disorder realization of the Hamiltonian (E2) with probability p. Therefore, the number of non-vanishing commutators scales as O(p²N⁷), resulting in the Trotter error t²/s×\sqrt{Var[Jᵢⱼₖₗ]}×O(t²p²N⁷/s)=O(t²pN⁴/s). Thus, the total TQ gate cost is O(p²L⁹t²/ϵ) to achieve the Trotter error ϵ. Setting p˜L⁻³, as required to reproduce the properties of the dense SYK model, we find a gate count O(L³t²/ϵ).

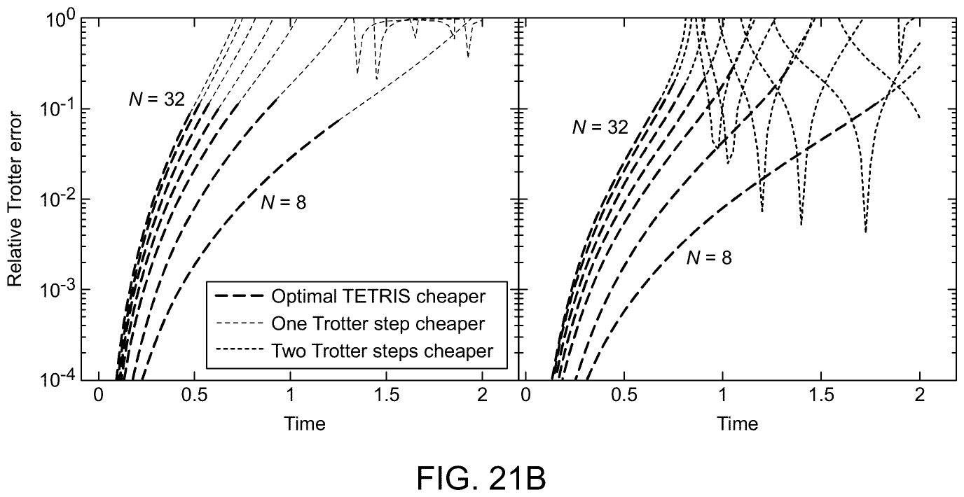

Various randomized algorithms for Hamiltonian simulation provide favourable quantum resources compared to the Trotterization in a number of cases [A43-A50]. As we will see below, the randomized TETRIS algorithm [A24] involves t²μ² rotations of Pauli strings, where μ is the 1-norm of the Hamiltonian. Most notably, the gate cost of each circuit is independent of the required error E. Since each rotation requires O(L) TQ gates, this yields a TQ gate count O(pL⁶t²). The scaling is strictly better than the Trotterization scaling for any sparsity parameter p˜L^{-α} with α<3. For p˜L⁻³, TETRIS achieves no discretization error at the same cost as the Trotterization. Furthermore, no matter how small the evolution time t is, the Trotterization needs to apply at least one Trotter step, which costs O(pL⁵). On the other hand, the TETRIS gate cost decreases as t², and thus, becomes cheaper for short-time evolution. This will be numerically verified later in FIG. 21. To give some precise numbers beyond this scaling analysis, for N=24 Majorana fermions, we get an average number of two-qubit gates around 1022 per Trotter step, before circuit optimization. For the TETRIS algorithm at optimal gate angle, we get an average number of two-qubit gates around 3100t² for simulation time t before circuit optimization.

The TETRIS algorithm takes as a parameter a gate angle 0<τ<π/2, and generates random unitary operators U that average to

$${𝔼}_{U} [ U ] = λ {e}^{iHt} , \qquad ( E7 )$$

where [symbol] _{U} denotes the statistical average over random samples of U, and λ is

$$λ = {e}^{- t μ tan ( τ / 2 )} , \qquad ( E8 )$$

with the 1-norm μ=Σₙ|cₙ| of the Hamiltonian (E5).

The random unitary operator U is expressed as a product

$$U = {e}^{i τ {P}_{{j}_{1}}} … {e}^{i τ {P}_{{j}_{M}}} ,$$

where the multiplication by e^{iτP}^{ₙ} are random events that follow independent Poisson processes with rates |cₙ|/sin τ during an evolution time t. As a consequence, the average number of rotation gates per sampled unitary operator U is tμ/sin τ. The attenuation factor λ increases the number of shots to reach a given precision by a factor 1/λ²=e^{2tμ tan(τ/2)}. The optimal choice of τ that minimizes the total number of gates across different shots is τ≈1/(tμ) for large tμ. This yields an average number of rotations t²μ². Note that for the SYK Hamiltonian, the long Pauli strings that will be exponentiated result mostly in two-qubit gates with maximal angle, coming from the decomposition of Pauli gadgets.

Noise mitigation: Echo verification.—The implementation of TETRIS involves an ancillary qubit to calculate the average of unitary operators U. We discuss an error mitigation scheme that makes use of the measurement outcomes on the system register [A51-A54]. Let us consider a density matrix ρ on the ancilla and the system qubits, that we initialize in |+ [symbol] [symbol] +| for the ancilla, and |0 [symbol] [symbol] 0|:=|0 . . . 0 [symbol] [symbol] 0 . . . 0| for the system qubits. After application of a unitary operator U conditioned on the ancilla being |1 [symbol] , we have

$$\begin{matrix}ρ = \frac{1}{2} \vert 0 〉 〈 0 \vert ⊗ \vert 0 〉 〈 0 \vert \\ + \frac{1}{2} \vert 1 〉 〈 0 \vert ⊗ U \vert 0 〉 〈 0 \vert + \frac{1}{2} \vert 0 〉 〈 1 \vert ⊗ \vert 0 〉 〈 0 \vert {U}^{†} \\ + \frac{1}{2} \vert 1 〉 〈 1 \vert ⊗ U \vert 0 〉 〈 0 \vert {U}^{†} ,\end{matrix} \qquad ( E9 )$$

where the registers before and after ⊗ denote the ancilla and the system qubits respectively.

Averaging over U, we get

$$\begin{matrix}{ρ}_{a v e} := {𝔼}_{U} [ ρ ] \\ = \frac{1}{2} \vert 0 〉 〈 0 \vert ⊗ \vert 0 〉 〈 0 \vert \\ + \frac{λ}{2} \vert 1 〉 〈 0 \vert ⊗ {e}^{iHt} \vert 0 〉 〈 0 \vert + \frac{λ}{2} \vert 0 〉 〈 1 \vert ⊗ \vert 0 〉 〈 0 \vert {e}^{- iHt} \\ + \frac{1}{2} \vert 1 〉 〈 1 \vert ⊗ {𝔼}_{U} [ U \vert 0 〉 〈 0 \vert {U}^{†} ] .\end{matrix} \qquad ( E10 )$$

One notes that the average of U|0 [symbol] [symbol] 0|U^{†} is a priori unknown since it is quadratic in U. Measuring X on the ancilla and [symbol] , an arbitrary observable, on the system qubits, we have

$$Tr [ {ρ}_{a v e} ( X ⊗ 𝒪 ) ] = λℜ [ 〈 0 \vert 𝒪 {e}^{iHt} \vert 0 〉 ] . \qquad ( E11 )$$

The real part of the Loschmidt amplitude can thus be obtained by setting [symbol] =I, i.e., only measuring the ancilla

$$ℜ [ 〈 0 \vert {e}^{iHt} \vert 0 〉 ] = {λ}^{- 1} Tr [ {ρ}_{a v e} ( X ⊗ I ) ] ) . \qquad ( E12 )$$

However, it can also be equivalently obtained by setting [symbol] =|0 [symbol] [symbol] 0|, the projector onto the initial state,

$$ℜ [ 〈 0 \vert {e}^{iHt} \vert 0 〉 ] = {λ}^{- 1} Tr [ {ρ}_{a v e} ( X ⊗ \vert 0 〉 〈 0 \vert ) ] . \qquad ( E13 )$$

When measuring the system qubits in the Z basis, the difference between the two cases above is that when computing X⊗I, the measurement outcome of the system qubits is not taken into account, whereas when computing X⊗|0 [symbol] [symbol] 0|, we count zero whenever the measurement outcome of the system qubits is not 0 . . . 0. This is different from discarding the corresponding shots because the overall number of shots remains the same. Similarly, projecting the system qubits onto any product state in the Z basis that is different from |0 . . . 0 [symbol] , i.e., taking [symbol] =|i₁ . . . i_{L} [symbol] [symbol] i₁ . . . i_{L}| has expectation value 0 whenever i₁ . . . i_{L}≠0 . . . 0. It follows that counting the shots where the system qubits are not 0 . . . 0 does not modify the expectation values, but increases the shot noise.

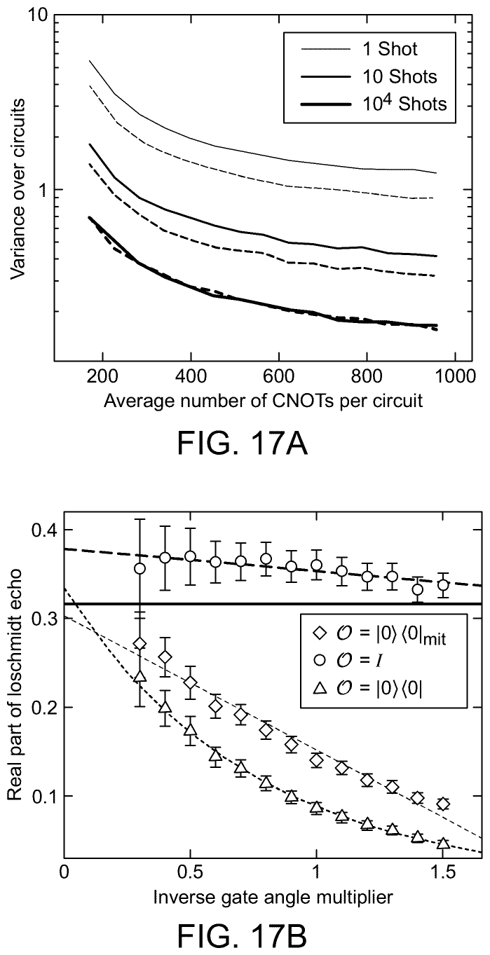

On a noiseless quantum computer, it is thus always more efficient to measure X⊗|0 [symbol] [symbol] 0|. This noise mitigation technique is called echo verification [A51, A54]. In FIG. 17A, we show the variance over circuits, for different numbers of shots per circuit and different numbers of gates, and for [symbol] =I, [symbol] =|0 [symbol] [symbol] 0|. We observe that [symbol] =|0 [symbol] [symbol] 0| has generally smaller variance than [symbol] =I, as expected. As for the influence of the number of shots per circuit, it is known that doing 1 shot per random TETRIS circuit minimizes the variance at fixed total number of shots, when neglecting compilation cost [A24]. We observe that in practice, doing 10 shots per circuit reduces the standard deviation by around \sqrt{10}, which is thus close to optimal. On the contrary, doing 10⁴ shots per random circuit reduces the standard deviation by much less than \sqrt{10⁴} which is far from the optimal case.

At early times before the Loschmidt amplitude decays, |0 . . . 0 [symbol] has the dominant amplitude in an evolving state. On a noisy quantum computer, some bit flips can occur to change the state |0 . . . 0 [symbol] to a state of a small Hamming weight. Counting 0 for these states will thus attenuate the signal. Since fermionic parity is conserved in the SYK model, shots with an odd number of bit flips can be attributed to noise with certainty. For a state with a small Hamming weight, noise is more likely to increase the weight than to decrease it. Therefore, the majority of the shots with a single 1 are expected to come from a bit-flip on top of 0 . . . 0 than on top of a bitstring with Hamming weight 2.

Taking these shots into account should thus improve the estimate of X⊗|0 [symbol] [symbol] 0| on a noisy quantum computer. To account for this, we propose a variant of the echo verification by measuring the following observable

$$( E14 )$$

$${\vert 0 〉 〈 0 \vert}_{mit} := \vert 0 … 0 〉 〈 0 … 0 \vert + {\sum }_{j = 1}^{L} \vert 0 … {010}_{j} … 0 〉 〈 0 … 010 … 0 \vert ,$$

where the single 1 is at position j in each bitstring.

FIG. 17A discloses standard deviation of measurements of real part of the Loschmidt amplitude at Jt=0.5, as a function of number of CNOTs per circuit (without any circuit optimization), for different number of shots per circuits (different shades of green) and measurement operator [symbol] =I (solid lines) and [symbol] =|0 [symbol] [symbol] | (dashed lines). The circuits are sampled both from TETRIS and from different disorder realizations of the SYK Hamiltonian. FIG. 17B discloses the real part of Loschmidt amplitude as a function of 1/α for gate angle τ=ατ₀ with τ₀=1/(tμ), for Jt=0.5, simulated with a depolarizing noise channel of amplitude 0.001 after every TQ gate, for different operators [symbol] . The error bars correspond to 10³ circuits with 10 shots each. The dashed lines are linear fits and the dotted line is an exponential fit. The black line shows the exact value.

Noise mitigation: Large Gate Angle Extrapolation (LGAE).—In TETRIS, the gate angle τ is a free parameter that does not modify the precision obtained on the result: the real part of the Loschmidt amplitude can be obtained with Eq. (E13) for all τ. Yet, the gate angle τ has a significant impact on the unitaries U sampled in Eq. (E7) and on the attenuation factor λ in Eq. (E8). We leverage this freedom to introduce another error mitigation scheme. The angle of the rotations in a TETRIS circuit U is τ, and there are on average tμ/sin τ such rotations in each circuit U. Being able to tune a parameter to continuously change the number of gates in the circuit, but without changing the expectation values, is the ideal setup to perform Zero Noise Extrapolation (ZNE) [A55, A56]. Namely, on an actual noisy hardware, by changing t one can measure the effect of noise on the result, and compensate for it. We refer to this variant of ZNE as Large Gate Angle Extrapolation (LGAE), in the sense that extrapolating noise to zero in the ZNE is performed here by increasing the gate angle.

LGAE proceeds as follows. We select two values of τ, a fixed τ₀>0 and a rescaled τ_{α}=ατ₀, where 0<α<1. Then, we run TETRIS with both angles and let y₀ and y_{α} be the expectation values obtained from the corresponding circuits. Let us assume for simplicity that these gate angles are sufficiently small so that sin τ≈τ. Also, as usual with ZNE, we assume that, at low noise level, the effect of noise is linear in the number of gates,

$${y}_{α} = a + b {N}_{g} ( α ) , \qquad ( E15 )$$

with the parameters a, b and the average number of gates N_{g}(α) in the circuits generated with gate angle τ_{α}. This number of gates is proportional to 1/sin τ_{α}≈1/τ_{α}. Under these assumptions, we obtain a mitigated expectation value as

$${y}_{LGAE} = \frac{{y}_{0} - α {y}_{α}}{1 - α} . \qquad ( E16 )$$

The standard deviation σ_{LGAE} obtained on y_{LGAE} is

$${σ}_{LGAE} = \frac{1}{1 - α} \sqrt{{σ}_{0}^{2} + {α}^{2} {σ}_{α}^{2}} , \qquad ( E17 )$$

where σ₀ and σ_{α} are the standard deviations of y₀, y_{α}, respectively.

Considering that there is a certain total number of shots to distribute among σ₀ and σ_{α}, we write

$${σ}_{0}^{2} = {s}_{0}^{2} / x and {σ}_{α}^{2} = {s}_{α}^{2} / ( 1 - x ) ,$$

with 0<x<1 and s₀, s_{α} numbers. The minimal variance is obtained for

$$x = \frac{{s}_{0}}{{s}_{0} + α {s}_{α}} , \qquad ( E 18 )$$

and then it takes the value

$${σ}_{LGAE} = \frac{{s}_{0} + α {s}_{α}}{1 - α} . \qquad ( E 19 )$$

Similarly to the conventional ZNE, instead of the linear fit with the number of gates, we may employ an exponential fit. The assumption is now that the effect of noise is of the form

$${y}_{α} = {ae}^{{bN}_{g} ( α )} . \qquad ( E 20 )$$

In that case the exponential mitigation gives

$${y}_{exp - LGAE} = exp \frac{log {y}_{0} - α log {y}_{α}}{1 - α} . \qquad ( E 21 )$$

There is no closed-form expression for the standard deviation of this estimate in terms of σ₀, σ_{α} in general, but assuming these are small, we can write using Gaussian propagation of uncertainty

$${σ}_{exp - LGAE} = \frac{{y}_{exp - LGAE}}{1 - α} \sqrt{\frac{{α}^{2} {σ}_{α}^{2}}{{y}_{α}^{2}} + \frac{{σ}_{0}^{2}}{{y}_{0}^{2}}} . \qquad ( E 22 )$$

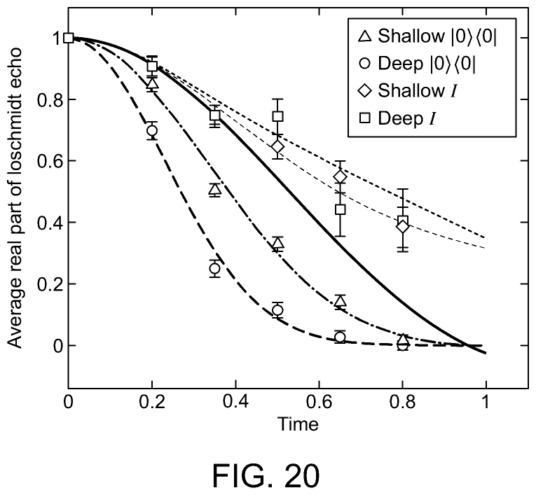

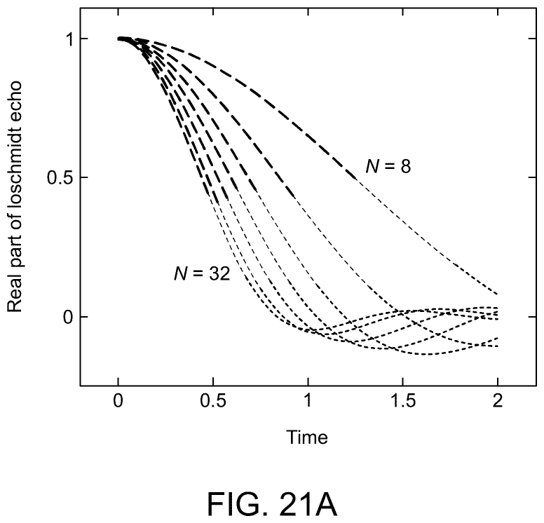

In FIG. 17B, we show the measured real part of the Loschmidt amplitude for different values of gate angles, when performing noisy numerical simulations of the SYK model for N=24 fermions, and for the three operators [symbol] =I, |0 [symbol] [symbol] 0|, |0 [symbol] [symbol] 0|ₘᵢₜ discussed in the previous section. When running noiseless simulations, all the points would match the exact value, independently of the gate angle. However, in noisy simulations, we see that the signal measured for [symbol] =|0 [symbol] [symbol] 0|, |0 [symbol] [symbol] 0|ₘᵢₜ depends strongly on the gate angle, and decays when the gate angle decreases. The signal for [symbol] =|0 [symbol] [symbol] 0|ₘᵢₜ is approximately linear, while that for [symbol] =|0 [symbol] [symbol] 0| presents a curvature. The signal for [symbol] =I is much less sensitive to gate angle, and is even slightly larger than the exact value due to the noise effect that we will discuss later (see e.g. FIG. 20). Because of the peculiar non-monotonous effect of noise here, the noise mitigation works less well. The error bars show that [symbol] =I displays more shot noise, requiring around twice as many shots to get the same precision as for [symbol] =|0 [symbol] [symbol] 0|, |0 [symbol] [symbol] 0|ₘᵢₜ.

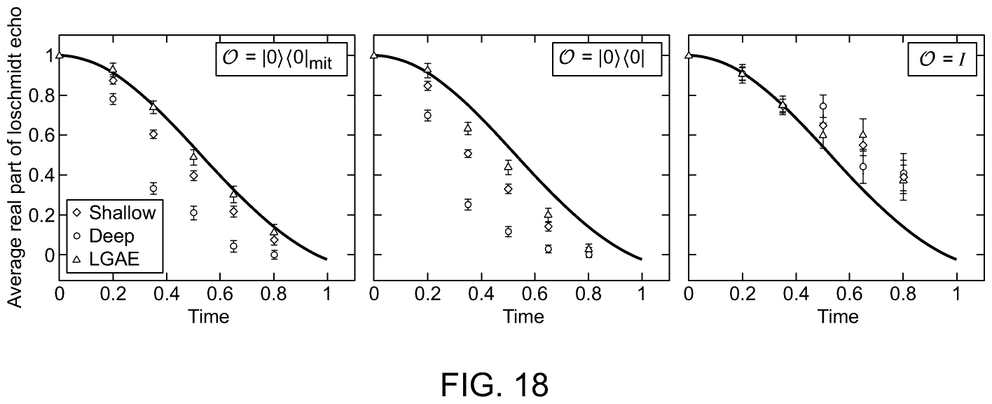

Hardware results.—We now present a hardware implementation of our setup on Quantinuum System Model H1 [A57]. This is a trapped-ion quantum computing device hosting 20 all-to-all coupled qubits. We fix the number of Majorana fermions to N=24, corresponding to L=12 qubits, and add one ancilla qubit, using thus 13 qubits in total. The sparsity parameter is k=2.3, below which the ramp, a universal behaviour predicted by random matrix theory, disappears in the spectral form factor, indicating the loss of spectral rigidity [A23]. Therefore, with k=2.3 we choose the most sparse SYK that could still be compatible with chaotic properties related to its holographic dual gravity model. We intend this experiment to provide a lower bound on the number of gates needed to simulate a SYK model with chaotic properties. On the hardware, we run 6 shots per circuit, each circuit being randomly sampled among different TETRIS unitary operators U and among different disorder realizations of the sparse SYK Hamiltonian H(E2). We use the ability of the hardware to perform mid-circuit measurement and qubit reset to “stitch” multiple circuits in a same run, in order to minimize the overhead cost in running several circuits with few shots each. We consider two different gate angles, τ₀=1.5/(tμ), where μ is the 1-norm of the sampled Hamiltonian H, that we refer to as “shallow circuits” and one equal to τ_{α}=ατ₀ with α=⅓, that we refer to as “deep circuits”. The deep circuits contain, on average, around three times more gates than the shallow circuits. Taking a large difference of number of gates in the two circuits used to perform ZNE reduces the shot noise amplification by the extrapolation [A58]. This allows us to apply the LGAE on the shallow and deep circuits and to study the efficiency of the three different measurement strategies, where [symbol] =I, |0 [symbol] [symbol] 0|, |0 [symbol] [symbol] 0|ₘᵢₜ. All hardware results are summarized in FIG. 18.

FIG. 18 discloses hardware results from the Quantinuum H1-1 ion-trap quantum computer. Real part of the Loschmidt amplitude, averaged over random realizations of the SYK Hamiltonian for N=24 fermions, as a function of time Jt, for shallow and deep circuits, together with the LGAE mitigation technique, for the three tested measurement operators [symbol] . The black line shows the exact value.

We observe that for [symbol] =|0 [symbol] [symbol] 0|ₘᵢₜ, the LGAE mitigation recovers the exact values within just about one standard deviation. In contrast, for [symbol] =|0 [symbol] [symbol] 0| the mitigation leads to an underestimation of the exact result. We attribute it to the fact that, because this observable is noisier, we are beyond the regime where noise effects are linear in the number of gates, as we already saw in FIG. 17B.

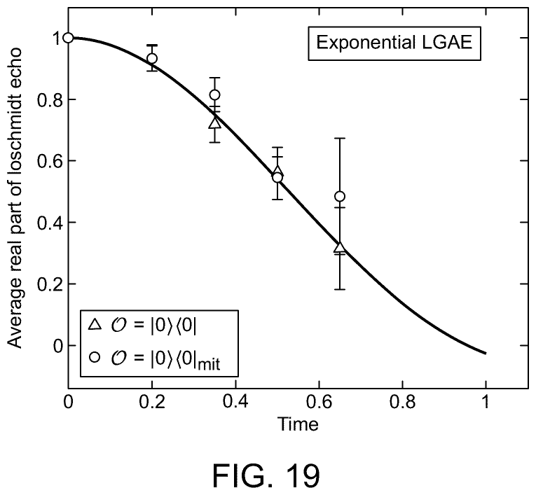

FIG. 19 discloses hardware results after exponential LGAE, in the same setting as in FIG. 18. The mitigated results for Jt=0.8 have very large variance and are outside of the plotted window.

In FIG. 19 we plot the mitigated results using the exponential form of LGAE. As expected, the error bars are significantly larger. Here, even the case [symbol] =|0 [symbol] [symbol] 0| correctly recovers the exact result within error bars, although the error bars are too large to be really conclusive for Jt=0.65 and Jt=0.8. For [symbol] =I with the linear extrapolation in FIG. 18, the results display significantly large error bars, with both shallow and deep circuits giving comparable results. In that case the efficiency of the noise mitigation is also less conclusive due again to the large error bars. We also observe that the signal is typically larger than the exact values. This upward bias due to noise is not standard because noise typically biases the results towards vanishing signal, except for non-unital channels such as leakage error. We next study theoretically the origin of this effect.

Effect of noise.—We now discuss the effect of noise on the expectation value Tr[ρₐᵥₑ(X⊗ [symbol] )]. We use [symbol] X⊗ [symbol] [symbol] to denote the noisy expectation values, while Tr[ρₐᵥₑ(X⊗O)] denotes the noiseless expectation value.

We analyze the dominant source of error occurring on the system qubits. To get tractable expressions, we model the noise effects on the system qubits with a global depolarizing channel [symbol] that occurs with rate q. If the channel [symbol] is applied at time t₁, the density matrix (E10) is turned into

$$𝒩 [ {ρ}_{ave} ] = \frac{1}{2} \vert 0 〉 〈 0 \vert ⊗ \frac{{I}^{N}}{{2}^{N}} + \frac{{λ}_{1}}{2} \vert 1 〉 〈 0 \vert ⊗ \frac{{I}^{N}}{{2}^{N}} 〈 0 \vert {e}^{{iHt}_{1}} \vert 0 〉 + \frac{{λ}_{1}}{2} \vert 0 〉 〈 1 \vert ⊗ \frac{{I}^{N}}{{2}^{N}} 〈 0 \vert {e}^{- {iHt}_{1}} \vert 0 〉 + \frac{1}{2} \vert 1 〉 〈 1 \vert ⊗ \frac{{I}^{N}}{{2}^{N}} , \qquad ( E 23 )$$

with λ₁=e^{-t}^{₁}^{μ tan(τ/2)} the attenuation factor up to time t₁.

Further evolving the state until time t₂, we find

$$\frac{1}{2} \vert 0 〉 〈 0 \vert ⊗ \frac{{I}^{N}}{{2}^{N}} + \frac{{λ}_{2}}{2} \vert 1 〉 〈 0 \vert ⊗ \frac{{e}^{iH ( {t}_{2} - {t}_{1} )}}{{2}^{N}} 〈 0 \vert {e}^{{iHt}_{1}} \vert 0 〉 + \frac{{λ}_{2}}{2} \vert 0 〉 〈 1 \vert ⊗ \frac{{e}^{- iH ( {t}_{2} - {t}_{1} )}}{{2}^{N}} 〈 0 \vert {e}^{- {iHt}_{1}} \vert 0 〉 + \frac{1}{2} \vert 1 〉 〈 1 \vert ⊗ \frac{{I}^{N}}{{2}^{N}} , \qquad ( E 24 )$$

by averaging over the TETRIS circuits, with λ₂=e^{-t}^{₂}^{μ tan(t/2)}.

Hence, if n errors occurs at times 0<t₁< . . . <tₙ<t, we measure the contribution at time t

$$λ 〈 0 \vert {e}^{{iHt}_{1}} \vert 0 〉 \frac{Tr [ {e}^{iH ( {t}_{2} - {t}_{1} )} ]}{{2}^{N}} \times \frac{Tr [ {e}^{iH ( {t}_{3} - {t}_{2} )} ]}{{2}^{N}} … \frac{Tr [ {e}^{iH ( {t}_{n} - {t}_{n - 1} )} ]}{{2}^{N}} \frac{Tr [ 𝒪 {e}^{iH ( t - {t}_{n} )} ]}{{2}^{N}} . \qquad ( E 25 )$$

The probability of having n errors is

$$\frac{{( qt )}^{n}}{n !} {e}^{- qt} .$$

The measured value constrained to having n errors is expressed by the integral of (E25) over 0<t₁< . . . <tₙ<t with a normalization factor n!/tⁿ. Collecting the contributions with different numbers of errors, it can be concisely written as

$$〈 X ⊗ 𝒪 〉 + i 〈 Y ⊗ 𝒪 〉 = {e}^{- qt} λ 〈 0 \vert 𝒪 {e}^{iHt} \vert 0 〉 + λ {qe}^{- qt} {\int }_{0}^{t} {dt}_{1} \frac{Tr [ 𝒪 {e}^{iH ( t - {t}_{1} )} ]}{{2}^{N}} F ( {t}_{1} ) , \qquad ( E 26 )$$

by introducing F(t) satisfying the integral equation

$$F ( t ) = 〈 0 \vert {e}^{iHt} \vert 0 〉 + q {\int }_{0}^{t} ds \frac{Tr [ {e}^{iH ( t - s )} ]}{{2}^{N}} F ( s ) . \qquad ( E27 )$$

For example at order O((qt)²), this is

$$〈 X ⊗ 𝒪 〉 + i 〈 Y ⊗ 𝒪 〉 = λ {e}^{- qt} 〈 0 \vert 𝒪 {e}^{iHt} \vert 0 〉 + λ {qe}^{- qt} {\int }_{0}^{t} {dt}_{1} 〈 0 \vert {e}^{{iHt}_{1}} \vert 0 〉 \frac{Tr [ 𝒪 {e}^{iH ( t - {t}_{1} )} ]}{{2}^{N}} + λ {q}^{2} {e}^{- qt} {\int }_{0}^{t} {dt}_{1} {\int }_{0}^{{t}_{1}} {dt}_{2} 〈 0 \vert {e}^{{iHt}_{2}} \vert 0 〉 \times \frac{Tr [ {e}^{iH ( {t}_{1} - {t}_{2} )} ]}{{2}^{N}} \frac{Tr [ 𝒪 {e}^{iH ( t - {t}_{1} )} ]}{{2}^{N}} + O ( {( qt )}^{3} ) . \qquad ( E28 )$$

At a low error rate q and for [symbol] =|0 [symbol] [symbol] 0|, we have

$$〈 X ⊗ \vert 0 〉 〈 0 \vert 〉 = λ ℜ 〈 0 \vert {e}^{iHt} \vert 0 〉 + λ q ℜ ( {\int }_{0}^{t} {dt}_{1} \frac{〈 0 \vert {e}^{{iHt}_{1}} \vert 0 〉 〈 0 \vert {e}^{iH ( t - {t}_{1} )} \vert 0 〉}{{2}^{N}} - t 〈 0 \vert {e}^{iHt} \vert 0 〉 ) + O ( {( q t )}^{2} ) . \qquad ( E29 )$$

Because of the factor ½^{N}, the parenthesis is very likely to be negative at small t. Hence the signal is decreased. On the other hand, when [symbol] =I, we have

$$〈 X ⊗ I 〉 = λ ℜ 〈 0 \vert {e}^{iHt} \vert 0 〉 + λ q ℜ ( {\int }_{0}^{t} {dt}_{1} \frac{Tr [ {e}^{{iHt}_{1}} ]}{{2}^{N}} 〈 0 \vert {e}^{iH ( t - {t}_{1} )} \vert 0 〉 - t 〈 0 \vert {e}^{iHt} \vert 0 〉 ) + O ( {( qt )}^{2} ) . \qquad ( E30 )$$

Now, the quantity

$$\frac{Tr [ {e}^{{iHt}_{1}} ]}{{2}^{N}}$$

is of order 1 at small t₁. Hence, the parenthesis can be positive or negative, implying noise can amplify the signal, counter-intuitively. Since Tr[e^{iHt}] and [symbol] 0|e^{iHt}|0 [symbol] are concave functions of t at small t, we can expect indeed this parenthesis to be positive.

FIG. 20 discloses the real part of Loschmidt amplitude as a function of time Jt, showing hardware results (bullets) and curves obtained from theoretical noise model (dashed lines), for shallow and deep circuits, and for measurement operator [symbol] =|0 [symbol] [symbol] 0|, I. The single parameter entering the theoretical model is fitted with the hardware data obtained for shallow circuits and [symbol] =|0 [symbol] [symbol] 0| (lightgreen). The three other dashed curves are deduced from it. The black line indicates the noiseless value.

To compare this theoretical noise model to hardware results, we proceed as follows. Recall that q is the error rate per unit of physical time t, not per gate. In an actual implementation of the algorithm, the error rate q depends on the chosen gate angle, because the number of gates per unit of physical time depends on the gate angle. In the experiments, since the gate angle is set to be inversely proportional to physical time t, the error rate q is proportional to the final physical time t for each experiment. Note in the formulas above, q stays constant in time, because the gate angle is constant throughout a single time evolution. To determine the proportionality factor β between error rate q and final physical time t, we fit the formula for [symbol] X⊗ [symbol] [symbol] in (E26) for [symbol] =|0 [symbol] [symbol] 0|, only on shallow circuits. Since the error rate must be proportional to the number of gates per unit of physical time, the error rate for deep circuits must be three times larger.

The fit yields the value β=2.46J². This means that, for Jt=0.5 for example, the error rate q in the shallow circuits is βτ=1.23), and so we have on average qt=0.615 errors during the evolution for time t. Since there are on average 275 TQ gates per shallow circuit for Jt=0.5, this gives an average number of errors per TQ gate equal to 0.0022. The component benchmark values give an error rate per two-qubit gate around 10⁻³ [A57]. However, this value 0.0022 obtained from the hardware also takes into account other sources of error like memory error, it is thus expected that it is larger than the component benchmark value. We plot in FIG. 20 the comparison of the theoretical noise model obtained with this fitted parameter, for the three other settings, namely shallow circuits with [symbol] =I, and deep circuits for both [symbol] =|0 [symbol] [symbol] 0| and [symbol] =I. We observe a good agreement for all the setups. In particular, the model correctly captures the upward bias due to noise of hardware results when O=I.

FIG. 21A discloses the real part of Loschmidt amplitude as a function of time Jt, for different system sizes N=8, 12, . . . , 32 (from right to left), with green indicating that TETRIS at optimal angle is cheaper than Trotter, orange that one Trotter step is cheaper, and purple that two Trotter steps are cheaper. FIG. 21B discloses relative Trotter error in the real part of the Loschmidt amplitude, as a function of time, using one single Trotter step (left panel) and two Trotter steps (right panel), for different system sizes N=8, 12, . . . , 32 (from bottom to top).

Cost comparison with Trotter.—We now perform a cost comparison against Trotterization. We saw that as a function of time, the complexity of our randomized algorithm scales as O(t²), whereas a Trotter decomposition at fixed Trotter step s scales as O(t). In FIG. 21A, we show, for sparsity parameter k=2.3, the different regimes where TETRIS has a lower gate count than one or two Trotter steps, as a function of time. We see that, at early times, TETRIS is always cheaper. Moreover, when system size increases, it remains consistently cheaper in the regime where the Loschmidt amplitude is ≅0.5. At later times, doing one single Trotter step always ends up getting cheaper. However, increasing time at a fixed number of Trotter steps inevitably increases the bias due to the Trotter error, which we have ignored so far.

In FIG. 21B, we show the relative Trotter error as a function of time, when doing one or two Trotter steps. We see that in both cases, Trotterization becomes cheaper only when the Trotter decomposition incurs at least ≈10% error. In particular, for time <1, the regime where one Trotter step is cheaper than TETRIS at optimal angle would have incurred a Trotter error of the same order as the error bars on the extrapolated values in FIG. 18. Trotter error would thus have been statistically visible in FIG. 18, even neglecting hardware noise.

Noise estimation through a mirror-on-average circuit benchmark.—Estimating the amount of noise in a circuit run on hardware is an important element of quantum computing calculations. However, comparing the measured expectation value to exact values is often limited to small system sizes or shallow circuits. Scalable methods to estimate the amount of noise in a circuit are to run a mirror circuit on top, where all the gates are exactly inverted. Since the circuit is logically equivalent to identity, hardware imperfections can be estimated in a scalable way by estimating the survival probability of the initial state [A35-A37]. These mirror circuit benchmarks, however, are known to overestimate the noise in actual local observables [A59-A61].

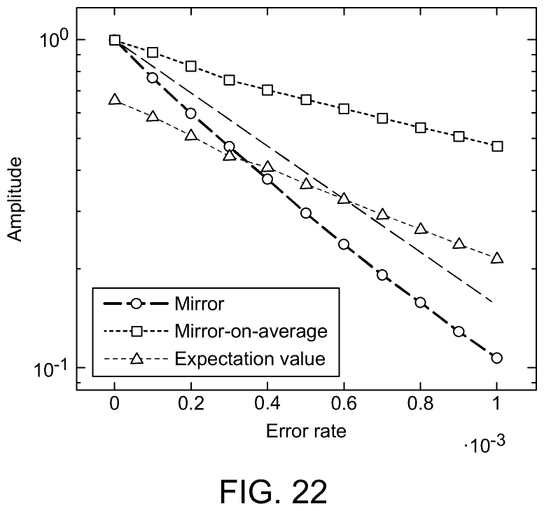

FIG. 22 discloses numerically simulated mirror-on-average benchmark λ⁻² [symbol] _{U,U′}[ρₐᵥₑ(X⊗I)] (E31) (purple), standard mirror benchmark [symbol] _{U}[ [symbol] 0|U^{†}U|0 [symbol] ] (teal), both of which return 1 in the noiseless case, and expectation values of the operator

$$𝒪 = \frac{1}{L} {\sum }_{j} {Z}_{j}$$

(orange), as a function of TQ depolarizing error rate p_{dep}, in size L=12, for Jt=0.8, taking disorder average of the sparse SYK Hamiltonian H. The teal dashed curve indicates the process gate fidelity, 1-15p_{dep}/16, to the average number of TQ gates in the circuits, here 1988.

The TETRIS algorithm allows instead for a scalable benchmark protocol where a mirror circuit equivalent to identity is implemented only on average. We initialize a density matrix ρ on the ancilla and the system qubits in |+ [symbol] ⊗|0 [symbol] . We generate two independent random unitaries U, U′ with the TETRIS algorithm, that satisfy [symbol] _{U}[U]=λe^{iHt}. We apply U on the system qubits conditioned on the ancilla to be in |0 [symbol] , and U′ on the system qubits conditioned on the ancilla to be in |1 [symbol] . The density matrix obtained after averaging over U, U′ is

$${ρ}_{ave} := {𝔼}_{U , {U}^{′}} [ ρ ] = \frac{1}{2} \vert 0 〉 〈 0 \vert ⊗ {𝔼}_{U} [ U \vert 0 〉 〈 0 \vert {U}^{†} ] + \frac{{λ}^{2}}{2} \vert 1 〉 〈 0 \vert ⊗ {e}^{iHt} \vert 0 〉 〈 0 \vert {e}^{- iHt} + \frac{{λ}^{2}}{2} \vert 0 〉 〈 1 \vert ⊗ {e}^{iHt} \vert 0 〉 〈 0 \vert {e}^{- iHt} + \frac{1}{2} \vert 1 〉 〈 1 \vert ⊗ {𝔼}_{{U}^{′}} [ {U}^{′} \vert 0 〉 〈 0 \vert {U}^{′ †} ] . \qquad ( E 31 )$$

Similar as before, denoting X⊗ [symbol] the observable applying X on the ancilla and [symbol] on the system qubits, we have

$$Tr [ {ρ}_{ave} ( X ⊗ 𝒪 ) ] = {λ}^{2} 〈 0 \vert {e}^{- iHt} {𝒪e}^{iHt} \vert 0 〉 . \qquad ( E 32 )$$

It follows that the ideal expectation value of X on the ancilla Tr[ρₐᵥₑ(X⊗I)]=λ² is known exactly. The expectation value of X on the ancilla cannot be computed in a scalable way for individual circuits because U and U′ are generally different. However, on averaging over U, U′, a mirror-on-average circuit is implemented, and the expectation value of X on the ancilla is exactly λ². Moreover, from the same circuits, the expectation value of [symbol] within e^{iHt}|0 [symbol] can be computed. We thus expect that the noise observed on the hardware on the expectation value of X on the ancilla gives a good estimate of the noise observed on a local observable. This is in contrast with usual mirror-circuits, which measure a global observable.

In FIG. 22, we test these ideas with noisy simulations of these mirror-on-average circuits. For L=12 qubits, and time Jt=0.8, we plot the expectation value of

$$𝒪 = \frac{1}{L} {\sum }_{j} {Z}_{j}$$

computed this way, as well as the expectation value of X on the ancilla divided by λ². We also compare with the expectation value obtained when measuring an exact mirror circuit where the inverse U^{†} is applied on the ancilla conditioned to be 0. All the Hamiltonians are systematically averaged over different SYK realizations. We first observe that the standard mirror circuits display a decay with noise that is similar to the circuit fidelity, estimated as gate fidelity to the number of gates(the agreement is not exact because the number of gates fluctuates among different random circuits). This is in line with previous implementations of mirror circuit benchmarks [A35-A37]. Secondly, we observe that the expectation value of a local observable like

$$\frac{1}{L} {\sum }_{j} {Z}_{j}$$

is significantly less damped by noise than this mirror circuit. Instead, its decay with noise is similar (although not identical) to that of the mirror-on-average circuits. This agreement between the two is not systematic, and for other parameter regimes the slope of the mirror-on-average circuits can present more deviation from than that of observables, but is always smaller than that of the mirror circuits. This shows that these mirror-on-average circuits give a better estimate of noise on actual observables than a standard mirror circuit benchmark, which tends to systematically overestimate the noise on local observables [A35]. Moreover, this mirror-on-average benchmark is scalable in the number of qubits and in the circuit depth.

Discussion and outlook.—We have demonstrated an experimental quantum simulation of the Loschmidt amplitude for the sparse SYK model, based on the TETRIS algorithm. The TETRIS algorithm is particularly suited to simulate the SYK model because its disorder average can be readily combined with the random sampling of TETRIS circuits to reduce the sampling overhead. While the sparsification of the SYK model and the use of TETRIS significantly reduce the circuit complexity, that alone is not enough to obtain reliable estimates of physical observables by running those circuits on currently available quantum processors. To overcome this difficulty, we proposed two noise mitigation techniques: echo verification and LGAE. We extensively assessed the performance of the algorithm with the noise mitigations and demonstrated substantial improvements in the accuracy of the experimentally obtained Loschmidt amplitude.

In order to address more physically motivated questions in future experiments, we discuss the computation of an OTOC Tr[Ae^{iHt} Be^{-iHt} A^{†}e^{iHt} B^{†}e^{-iHt}], where A and B are typically set to be Majorana operators. We note that the computation of the Lyapunov exponent requires the calculation of OTOCs at finite temperature. Preparation of the thermal states at scale requires separate consideration and is left for future work. Here, we replace the trace by the average of the expectation values with respect to randomly sampled pure states. With the TETRIS algorithm and the ternary tree encoding [A41], which maps a fermion operator to a spin operator of weight [log₃2L], each time-evolution operator e^{±iHt} uses approximately t²μ² log₃(2L)≈2k(Jt)²L² log₃(2L) TQ gates.

To extract the quantum Lyapunov exponent from the decay of the OTOC, we set the simulation time to Jt˜ln N. Therefore, the total TQ gate count is roughly,

$$8 \times {k ( ln ( 2 L ) L )}^{2} {log}_{3} ( 2 L ) \approx \{ \begin{matrix}4 \times 1 {0}^{6} & ( L = 50 ) \\ 2 \times 1 {0}^{7} & ( L = 100 )\end{matrix} \qquad ( E 33 )$$

for k=2.3.

Without any parallelization of gates and assuming the execution time per circuit depth being 30 milliseconds (ms), the runtime of each circuit is roughly 4×10⁶×30 ms=30 hours for L=50. Since L/log₃(L)≈14 gates can be parallelized by adding the same number of ancillary qubits, the execution time per circuit is reduced to two hours. These estimates point towards the need for further algorithmic improvements, for example, by using techniques like sum-of-squares spectral amplification [A62] or defining new simplified Hamiltonians that retain the chaotic properties of the original dense SYK model (see e.g. [A63-A65] for recent explorations of SYK-like models).

### REFERENCES

[1] E. Granet and H. Dreyer, arXiv: 2308.03694 (2023), 10.48550/arXiv.2308.03694.
[2] A. Aspuru-Guzik, A. D. Dutoi, P. J. Love, and M. Head-Gordon, Science 309, 1704 (2005).
[3] A. Peruzzo, J. McClean, P. Shadbolt, M.-H. Yung, X.-Q. Zhou, P. J. Love, A. Aspuru-Guzik, and J. L. O'brien, Nature communications 5, 4213 (2014).
[4] J. R. McClean, J. Romero, R. Babbush, and A. Aspuru-Guzik, New Journal of Physics 18, 023023 (2016).
[5] J. Tilly, H. Chen, S. Cao, D. Picozzi, K. Setia, Y. Li, E. Grant, L. Wossnig, I. Rungger, G. H. Booth, et al., Physics Reports 986, 1 (2022).
[6] E. Farhi, J. Goldstone, S. Gutmann, and M. Sipser, quant-ph/0001106 (2000), 10.48550/arXiv.quant-ph/0001106.
[7] J. R. McClean, S. Boixo, V. N. Smelyanskiy, R. Babbush, and H. Neven, Nature communications 9, 4812 (2018).
[8] M. Cerezo, A. Sone, T. Volkoff, L. Cincio, and P. J. Coles, Nature communications 12, 1791 (2021).
[9] S. Wang, E. Fontana, M. Cerezo, K. Sharma, A. Sone, L. Cincio, and P. J. Coles, Nature communications 12, 6961 (2021).
[10] E. R. Anschuetz and B. T. Kiani, Nature Communications 13, 7760 (2022).
[11] H. Dreyer, M. Bejan, and E. Granet, Physical Review A 104, 062614 (2021).
[12] L. Veis and J. Pittner, The Journal of Chemical Physics 140 (2014), 10.1063/1.4880755
[13] S. Lee, J. Lee, H. Zhai, Y. Tong, A. M. Dalzell, A. Kumar, P. Helms, J. Gray, Z.-H. Cui, W. Liu, et al., Nature Communications 14, 1952 (2023).
[14] R. Babbush, P. J. Love, and A. Aspuru-Guzik, Scientific reports 4, 6603 (2014).
[15] V. Kremenetski, C. Mejuto-Zaera, S. J. Cotton, and N. M. Tubman, The Journal of Chemical Physics 155 (2021), 10.1063/5.0060124. 17
[16] J. Du, N. Xu, X. Peng, P. Wang, S. Wu, and D. Lu, Physical review letters 104, 030502 (2010).
[17] B. Bauer, D. Wecker, A. J. Millis, M. B. Hastings, and M. Troyer, Physical Review X 6, 031045 (2016).
[18] H. Hayasaka, T. Imoto, Y. Matsuzaki, and S. Kawabata, arXiv: 2305.08352 (2023), 10.48550/arXiv.2305.08352.
[19] A. M. Childs and N. Wiebe, arXiv: 1202.5822 (2012), 10.26421/QIC12.11-12.
[20] D. W. Berry, A. M. Childs, R. Cleve, R. Kothari, and R. D. Somma, Physical review letters 114, 090502 (2015).
[21] D. W. Berry, A. M. Childs, R. Cleve, R. Kothari, and R. D. Somma, in Proceedings of the forty-sixth annual ACM symposium on Theory of computing (2014) pp. 283-292.
[22] G. H. Low and I. L. Chuang, Physical review letters 118, 010501 (2017).
[23] G. H. Low and I. L. Chuang, Quantum 3, 163 (2019).
[24] G. H. Low and N. Wiebe, arXiv: 1805.00675 (2018), 10.48550/arXiv.1805.00675.
[25] G. H. Low, T. J. Yoder, and I. L. Chuang, Physical Review X 6, 041067 (2016).
[26] Y. Kikuchi, C. M. Keever, L. Coopmans, M. Lubasch, and M. Benedetti, arXiv: 2303.05533 (2023), 10.48550/arXiv.2303.05533.
[27] D. Poulin, A. Qarry, R. Somma, and F. Verstraete, Physical review letters 106, 170501 (2011).
[28] M. Kieferov' a, A. Scherer, and D. W. Berry, Physical Review A 99, 042314 (2019).
[29] D. W. Berry, A. M. Childs, Y. Su, X. Wang, and N. Wiebe, Quantum 4, 254 (2020).
[30] N. C. Rubin, R. Babbush, and J. McClean, New Journal of Physics 20, 053020 (2018).
[31] J. Lee, D. W. Berry, C. Gidney, W. J. Huggins, J. R. McClean, N. Wiebe, and R. Babbush, PRX Quantum 2, 030305 (2021).
[32] E. Koridon, S. Yalouz, B. Senjean, F. Buda, T. E. O'Brien, and L. Visscher, Physical Review Research 3, 033127 (2021).
[33] S. Moses, C. Baldwin, M. Allman, R. Ancona, L. Ascarrunz, C. Barnes, J. Bartolotta, B. Bjork, P. Blanchard, M. Bohn, et al., arXiv: 2305.03828 (2023), 10.48550/arXiv.2305.03828.
[34] F. Jensen, Introduction to computational chemistry (John wiley & sons, 2017).
[35] R. Babbush, N. Wiebe, J. McClean, J. McClain, H. Neven, and G. K.-L. Chan, Physical Review X 8, 011044 (2018).
[36] R. Babbush, D. W. Berry, J. R. McClean, and H. Neven, npj Quantum Information 5, 92 (2019).
[37] Y. Su, D. W. Berry, N. Wiebe, N. Rubin, and R. Babbush, PRX Quantum 2, 040332 (2021).
[38] P. Jordan and E. P. Wigner, “Uber das paulische” aquivalenzverbot (Springer, 1993).
[39] S. B. Bravyi and A. Y. Kitaev, Annals of Physics 298, 210 (2002).
[40] J. T. Seeley, M. J. Richard, and P. J. Love, The Journal of chemical physics 137 (2012), 10.1063/1.4768229.
[41] K. A. Peterson, D. Feller, and D. A. Dixon, Theoretical Chemistry Accounts 131, 1 (2012).
[42] V. E. Elfving, B. W. Broer, M. Webber, J. Gavartin, M. D. Halls, K. P. Lorton, and A. Bochevarov, arXiv: 2009.12472 (2020), 10.48550/arXiv.2009.12472.
[43] M. Born and V. Fock, Zeitschrift f″ ur Physik 51, 165 (1928).
[44] T. Kato, Journal of the Physical Society of Japan 5, 435 (1950).
[45] T. Albash and D. A. Lidar, Reviews of Modern Physics 90, 015002 (2018).
[46] S. Jansen, M.-B. Ruskai, and R. Seiler, Journal of Mathematical Physics 48 (2007), 10.1063/1.2798382.
[47] D. Cheung, P. Høyer, and N. Wiebe, Journal of Physics A: Mathematical and Theoretical 44, 415302 (2011).
[48] R. Mackenzie, E. Marcotte, and H. Paquette, Physical Review A 73, 042104 (2006).
[49] A. Elgart and G. A. Hagedorn, Journal of Mathematical Physics 53 (2012), 10.1063/1.4748968.
[50] K. Temme, S. Bravyi, and J. M. Gambetta, Physical review letters 119, 180509 (2017).
[51] C. N. Self, M. Benedetti, and D. Amaro, arXiv: 2211.06703 (2022), 10.48550/arXiv.2211.06703.
[52] S. Bravyi, J. M. Gambetta, A. Mezzacapo, and K. Temme, arXiv: 1701.08213 (2017), 10.48550/arXiv.1701.08213.
[53] D. Wecker, M. B. Hastings, and M. Troyer, Physical Review A 92, 042303 (2015).
[54] A. Y. Kitaev, quant-ph/9511026 (1995), 10.48550/arXiv.quant-ph/9511026.
[55] M. A. Nielsen and I. L. Chuang, Quantum computation and quantum information (Cambridge university press, 2010).
[56] M. Dob sicek, G. Johansson, V. Shumeiko, and G. Wendin, Physical Review A 76, 030306 (2007).
[57] Y. Chen and T.-C. Wei, Physical Review A 101, 032339 (2020).
[58] H. Robbins and S. Monro, The annals of mathematical statistics, 400 (1951).
[59] M. Demirplak and S. A. Rice, The Journal of Physical Chemistry A 107, 9937 (2003).
[60] M. V. Berry, Journal of Physics A: Mathematical and Theoretical 42, 365303
[61] x. Chen, I. Lizuain, A. Ruschhaupt, D. Gu'ery-Odelin, and J. Muga, Physical review letters 105, 123003 (2010).
[62] N. N. Hegade, X. Chen, and E. Solano, Physical Review Research 4, L042030 (2022).
[63] D. Sels and A. Polkovnikov, Proceedings of the National Academy of Sciences 114, E3909 (2017).
[64] P. W. Claeys, M. Pandey, D. Sels, and A. Polkovnikov, Physical review letters 123, 090602 (2019).
[65] C. Jarzynski, Physical Review A 88, 040101 (2013).
[66] C. M. Keever and M. Lubasch, arXiv preprint arXiv: 2311.05544 (2023), 10.48550/arXiv.2311.05544.
[67] A. M. Childs, A. Ostrander, and Y. Su, Quantum 3, 182 (2019).
[68] E. Campbell, Physical review letters 123, 070503 (2019).
[69] R. P. Feynman, in Feynman and computation (CRC Press, 2018) pp. 133-153.
[70] S. Lloyd, Science 273, 1073 (1996).
[71] D. S. Abrams and S. Lloyd, Physical Review Letters 83, 5162 (1999).
[72] A. W. Harrow, A. Hassidim, and S. Lloyd, Physical review letters 103, 150502 (2009).
[73] Y. Yang, A. Christianen, S. Coll-Vinent, V. Smelyanskiy, M. C. Ba^{˜} nuls, T. E. O'Brien, D. S. Wild, and J. I. Cirac, PRX Quantum 4, 030320 (2023).
[74] S. Lu, M. C. Banuls, and J. I. Cirac, PRX Quantum 2, 020321 (2021).
[75] A. Schuckert, A. Bohrdt, E. Crane, and M. Knap, Physical Review B 107, L140410 (2023).
[76] M. Suzuki, Physics Letters A 146, 319 (1990).
[77] M. Suzuki, Journal of Mathematical Physics 32, 400 (1991).
[78] D. W. Berry, G. Ahokas, R. Cleve, and B. C. Sanders, Communications in Mathematical Physics 270, 359 (2007).
[79] A. M. Childs and Y. Su, Physical review letters 123, 050503 (2019).
[80] A. M. Childs, Y. Su, M. C. Tran, N. Wiebe, and S. Zhu, Physical Review X 11, 011020 (2021).
[81] G. H. Low, Y. Su, Y. Tong, and M. C. Tran, PRX Quantum 4, 020323 (2023).
[82] P. Zeng, J. Sun, L. Jiang, and Q. Zhao, arXiv: 2212.04566 (2022), 10.48550/arXiv.2212.04566.
[83] C. H. Cho, D. W. Berry, and M.-H. Hsieh, arXiv: 2210.11281 (2022), 10.48550/arXiv.2210.11281.
[84] T. Tomesh, K. Gui, P. Gokhale, Y. Shi, F. T. Chong, M. Martonosi, and M. Suchara, in 2021 International Conference on Rebooting Computing (ICRC) (IEEE, 2021) pp. 1-13.
[85] D. Aharonov and A. Ta-Shma, in Proc. ACM Symp. Th. Comp. (2003) pp. 20-29.
[86] J. Haah, M. B. Hastings, R. Kothari, and G. H. Low, SIAM Journal on Computing, FOCS18 (2021).
[87] C. Leadbeater, N. Fitzpatrick, D. M. Ramo, and A. J. Thom, arXiv: 2304.07917 (2023), 10.48550/arXiv.2304.07917.
[88] N. Fitzpatrick, H. Apel, and D. M. Ramo, arXiv: 2106.03985 (2021), 10.48550/arXiv.2106.03985.
[89] J. Ostmeyer, J. Phys. A (2022), 0.1088/1751-8121/acde7a. 6
[90] C. Mc Keever and M. Lubasch, Physical Review Research 5, 023146 (2023).
[91] E. Campbell, Physical Review A 95, 042306 (2017).
[92] P. K. Faehrmann, M. Steudtner, R. Kueng, M. Kieferov'a, and J. Eisert, Quantum 6, 806 (2022).
[93] K. Wan, M. Berta, and E. T. Campbell, Physical Review Letters 129, 030503 (2022).
[94] S. Wang, S. McArdle, and M. Berta, arXiv: 2302.01873 (2023), 10.48550/arXiv.2302.01873.
[95] W. Gong, Y. Kharkov, M. C. Tran, P. Bienias, and A. V. Gorshkov, arXiv: 2307.13028 (2023), 10.48550/arXiv.2307.13028.
[96] Y. Ouyang, D. R. White, and E. T. Campbell, Quantum 4, 235 (2020).
[97] C.-F. Chen, H.-Y. Huang, R. Kueng, and J. A. Tropp, PRX Quantum 2, 040305 (2021).
[98] K. Nakaji, M. Bagherimehrab, and A. Aspuru-Guzik, arXiv: 2302.14811 (2023), 10.48550/arXiv.2302.14811.
[99] O. Kiss, M. Grossi, and A. Roggero, Quantum 7, 977 (2023).
[100] M. Hagan and N. Wiebe, arXiv: 2206.06409 (2022), 10.48550/arXiv.2206.06409.
[101] W. J. Huggins, S. McArdle, T. E. O'Brien, J. Lee, N. C. Rubin, S. Boixo, K. B. Whaley, R. Babbush, and J. R. McClean, Physical Review X 11, 041036 (2021).
[102] M. Pocrnic, M. Hagan, J. Carrasquilla, D. Segal, and N. Wiebe, arXiv: 2306.16572 (2023), 10.48550/arXiv.2306.16572.
[103] A. Aspuru-Guzik, A. D. Dutoi, P. J. Love, and M. Head-Gordon, Science 309, 1704 (2005).
[104] M. Reiher, N. Wiebe, K. M. Svore, D. Wecker, and M. Troyer, Proc. Nat. Ac. Sc. 114, 7555 (2017).
[105] B. Bauer, S. Bravyi, M. Motta, and G. K.-L. Chan, Chemical Reviews 120, 12685 (2020).
[106] S. McArdle, S. Endo, A. Aspuru-Guzik, S. C. Benjamin, and X. Yuan, Reviews of Modern Physics 92, 015003 (2020).
[107] M. Motta and J. E. Rice, Wiley Interdisc. Rev.: Comp. Mol. Sc. 12, e1580 (2022).
[108] I. H. Kim, Y.-H. Liu, S. Pallister, W. Pol, S. Roberts, and E. Lee, Physical Review Research 4, 023019 (2022).
[109] D. W. Berry and A. M. Childs, arXiv: 0910.4157 (2009), 10.26421/QIC12.1-2.
[110] A. M. Childs, Comm. Math. Phys. 294, 581 (2010).
[111] I. Buluta and F. Nori, Science 326, 108 (2009).
[112] R. Blatt and C. F. Roos, Nature Physics 8, 277 (2012).
[113] A. Aspuru-Guzik and P. Walther, Nature physics 8, 285 (2012).
[114] I. Bloch, J. Dalibard, and S. Nascimbene, Nature Physics 8, 267 (2012).
[115] I. M. Georgescu, S. Ashhab, and F. Nori, Reviews of Modern Physics 86, 153 (2014).
[116] B. Koczor, J. Morton, and S. Benjamin, ar Xiv: 2305.19881 (2023), 10.48550/arXiv.2305.19881.
[117] See supplemental materials for details.
[118] K. H'emery, K. Ghanem, E. Crane, S. L. Campbell, J. M. Dreiling, C. Figgatt, C. Foltz, J. P. Gaebler, J. Johansen, M. Mills, S. A. Moses, J. M. Pino, A. Ransford, M. Rowe, P. Siegfried, R. P. Stutz, H. Dreyer, A. Schuckert, and R. Nigmatullin, “Measuring the loschmidt amplitude for finite-energy properties of the fermi-hubbard model on an ion-trap quantum computer,” (2023), arXiv: 2309.10552 [quant-ph].
[119] Z.-Y. Wei, D. Malz, and J. I. Cirac, Physical Review Research 5, L022037 (2023).
[120] S. Bravyi and D. Gosset, Physical review letters 116, 250501 (2016).
[A1] S. Sachdev and J. Ye, Phys. Rev. Lett. 70, 3339 (1993).
[A2] A. Kitaev, “A simple model of quantum holography,” (2015).
[A3] J. Maldacena and D. Stanford, Phys. Rev. D 94, 106002 (2016), arXiv: 1604.07818 [hep-th].
[A4] Z. Luo, Y.-Z. You, J. Li, C.-M. Jian, D. Lu, C. Xu, B. Zeng, and R. Laflamme, npj Quantum Inf. 5, 53 (2019), arXiv: 1712.06458 [quant-ph].
[A5] D. Chowdhury, A. Georges, O. Parcollet, and S. Sachdev, Rev. Mod. Phys. 94, 035004 (2022), arXiv: 2109.05037 [cond-mat.str-el].
[A6] S. Sachdev, ICTS News 8 (2022), arXiv: 2205.02285 [hepth].
[A7] P. Gao and D. L. Jafferis, JHEP 07, 097 (2021), arXiv: 1911.07416 [hep-th].
[A8] T. Schuster, B. Kobrin, P. Gao, I. Cong, E. T. Khabiboulline, N. M. Linke, M. D. Lukin, C. Monroe, B. Yoshida, and N. Y. Yao, Phys. Rev. X 12, 031013 (2022).
[A9] A. R. Brown, H. Gharibyan, S. Leichenauer, H. W. Lin, S. Nezami, G. Salton, L. Susskind, B. Swingle, and M. Walter, PRX Quantum 4, 010320 (2023).
[A10] S. Nezami, H. W. Lin, A. R. Brown, H. Gharibyan, 10 S. Leichenauer, G. Salton, L. Susskind, B. Swingle, and M. Walter, PRX Quantum 4, 010321 (2023).
[A11] I. Shapoval, V. P. Su, W. de Jong, M. Urbanek, and B. Swingle, Quantum 7, 1138 (2023), arXiv: 2205.14081 [quant-ph].
[A12] G. S'arosi, PoS Modave 2017, 001 (2018), arXiv: 1711.08482 [hep-th].
[A13] V. Rosenhaus, J. Phys. A 52, 323001 (2019), arXiv: 1807.03334 [hep-th].
[A14] J. Maldacena, S. H. Shenker, and D. Stanford, JHEP 08, 106 (2016), arXiv: 1503.01409 [hep-th].
[A15] D. Jafferis, A. Zlokapa, J. D. Lykken, D. K. Kolchmeyer, S. I. Davis, N. Lauk, H. Neven, and M. Spiropulu, Nature 612, 51 (2022).
[A16] M. Asaduzzaman, R. G. Jha, and B. Sambasivam, Physical Review D 109, 105002 (2024).
[A17] S. Xu, L. Susskind, Y. Su, and B. Swingle, “A Sparse Model of Quantum Holography,” (2020), arXiv: 2008.02303 [cond-mat.str-el].
[A18] A. M. Garc'la-Garc'la, Y. Jia, D. Rosa, and J. J. M. Verbaarschot, Phys. Rev. D 103, 106002 (2021).
[A19] E. Caceres, A. Misobuchi, and R. Pimentel, JHEP 11, 015 (2021), arXiv: 2108.08808 [hep-th].
[A20] E. C'aceres, A. Misobuchi, and A. Raz, JHEP 08, 236 (2022), arXiv: 2204.07194 [hep-th].
[A21] E. C'aceres, T. Guglielmo, B. Kent, and A. Misobuchi, JHEP 11, 088 (2023), arXiv: 2306.07345 [hep-th].
[A22] A. M. Garc'la-Garc'la, C. Liu, and J. J. M. Verbaarschot, Phys. Rev. Lett. 133, 091602 (2024), arXiv: 2311.00639 [hep-th].
[A23] P. Orman, H. Gharibyan, and J. Preskill, JHEP 02, 173 (2025), arXiv: 2403.13884 [hep-th].
[A24] E. Granet and H. Dreyer, npj Quantum Information 10, 82 (2024).
[A25] A. Peres, Phys. Rev. A 30, 1610 (1984).
[A26] A. Goussev, R. A. Jalabert, H. M. Pastawski, and D. Wisniacki, “Loschmidt echo,” (2012), arXiv: 1206.6348.
[A27] T. Gorin, T. Prosen, T. H. Seligman, and M. Znidari ̌c, ̌ Phys. Rept. 435, 33 (2006).
[A28] B. Yan, L. Cincio, and W. H. Zurek, Phys. Rev. Lett. 124, 160603 (2020), arXiv: 1903.02651 [quant-ph].
[A29] A. I. Larkin and Y. N. Ovchinnikov, Soviet Journal of Experimental and Theoretical Physics 28, 1200 (1969).
[A30] S. H. Shenker and D. Stanford, Journal of High Energy Physics 2014, 067 (2014).
[A31] D. A. Roberts, D. Stanford, and L. Susskind, Journal of High Energy Physics 2015, 051 (2015).
[A32] P. Hosur, X.-L. Qi, D. A. Roberts, and B. Yoshida, Journal of High Energy Physics 2016, 004 (2016).
[A33] B. Swingle, Nature Phys. 14, 988 (2018).
[A34] S. Xu and B. Swingle, PRX Quantum 5, 010201 (2024).
[A35] T. Proctor, K. Rudinger, K. Young, E. Nielsen, and R. Blume-Kohout, Nature Phys. 18, 75 (2022), arXiv: 2008.11294 [quant-ph].
[A36] K. Mayer et al., “Theory of mirror benchmarking and demonstration on a quantum computer,” (2021), arXiv: 2108.10431 [quant-ph].
[A37] M. DeCross, R. Haghshenas, M. Liu, E. Rinaldi, J. Gray, Y. Alexeev, C. H. Baldwin, J. P. Bartolotta, M. Bohn, E. Chertkov, et al., arXiv preprint arXiv: 2406.02501 (2024), 10.1103/PhysRevX.15.021052.
[A38] E. Granet and H. Dreyer, arXiv preprint arXiv: 2503.04298 (2025), 10.48550/arXiv.2503.04298.
[A39] C. Derby, J. Klassen, J. Bausch, and T. Cubitt, Physical Review B 104, 035118 (2021).
[A40] R. Nigmatullin, K. Hemery, K. Ghanem, S. Moses, D. Gresh, P. Siegfried, M. Mills, T. Gatterman, N. Hewitt, E. Granet, et al., Nature Physics, 1 (2025).
[A41] Z. Jiang, A. Kalev, W. Mruczkiewicz, and H. Neven, Quantum 4, 276 (2020).
[A42] Y. Chen, J. Helsen, and M. Ozols, “Trotter error and gate complexity of the SYK and sparse SYK models,” (2025), arXiv: 2502.18420 [quant-ph].
[A43] E. Campbell, Phys. Rev. Lett. 123, 070503 (2019).
[A44] A. M. Childs, A. Ostrander, and Y. Su, Quantum 3, 182 (2019).
[A45] C.-F. Chen, H.-Y. Huang, R. Kueng, and J. A. Tropp, PRX Quantum 2, 040305 (2021).
[A46] K. Wan, M. Berta, and E. T. Campbell, Phys. Rev. Lett. 129, 030503 (2022), arXiv: 2110.12071 [quant-ph].
[A47] K. Nakaji, M. Bagherimehrab, and A. Aspuru-Guzik, PRX Quantum 5, 020330 (2024), arXiv: 2302.14811 [quant-ph].
[A48] M. Pocrnic, M. Hagan, J. Carrasquilla, D. Segal, and N. Wiebe, Phys. Rev. Res. 6, 013224 (2024), arXiv: 2306.16572 [quant-ph].
[A49] J. D. Watson, “Randomly Compiled Quantum Simulation with Exponentially Reduced Circuit Depths,” (2024), arXiv: 2411.04240 [quant-ph].
[A50] C. Kiumi and B. Koczor, “TE-PAI: Exact Time Evolution by Sampling Random Circuits,” (2024), arXiv: 2410.16850 [quant-ph].
[A51] T. E. O'Brien, S. Polla, N. C. Rubin, W. J. Huggins, S. McArdle, S. Boixo, J. R. McClean, and R. Babbush, PRX Quantum 2, 020317 (2021).
[A52] M. Huo and Y. Li, Phys. Rev. A 105, 022427 (2022).
[A53] Z. Cai, “Resource-efficient Purification-based Quantum Error Mitigation,” (2021), arXiv: 2107.07279 [quant-ph].
[A54] S. Polla, G.-L. R. Anselmetti, and T. E. O'Brien, Phys. Rev. A 108, 012403 (2023).
[A55] K. Temme, S. Bravyi, and J. M. Gambetta, Phys. Rev. Lett. 119, 180509 (2017), arXiv: 1612.02058 [quant-ph].
[A56] T. Giurgica-Tiron, Y. Hindy, R. LaRose, A. Mari, and W. J. Zeng, in 2020 IEEE International Conference on Quantum Computing and Engineering (2020) arXiv: 2005.10921 [quant-ph].
[A57] Quantinuum, “H1-1 product data sheet,” (2025).
[A58] R. Haghshenas, E. Chertkov, M. Mills, W. Kadow, S.-H. Lin, Y.-H. Chen, C. Cade, I. Niesen, T. Begu ̌si'c, M. S. Rudolph, et al., arXiv preprint arXiv: 2503.20870 (2025), 10.48550/arXiv.2503.20870.
[A59] B. F. Schiffer, A. F. Rubio, R. Trivedi, and J. I. Cirac, arXiv preprint arXiv: 2404.15397 (2024), 10.48550/arXiv.2404.15397.
[A60] E. Granet and H. Dreyer, PRX Quantum 6, 010333 (2025).
[A61] E. Chertkov, Y.-H. Chen, M. Lubasch, D. Hayes, and M. Foss-Feig, arXiv preprint arXiv: 2410.10794 (2024), 10.48550/arXiv.2410.10794.
[A62] R. King, G. H. Low, R. Babbush, R. D. Somma, and N. C. Rubin, “Quantum simulation with sum-of-squares spectral amplification,” (2025), arXiv: 2505.01528 [quant-ph].
[A63] B. Swingle and M. Winer, Phys. Rev. B 109, 094206 (2024), arXiv: 2311.01516 [hep-th].
[A64] M. Hanada, A. Jevicki, X. Liu, E. Rinaldi, and M. Tezuka, JHEP 05, 280 (2024), arXiv: 2309.15349 [hep-11th].
[A65] M. Hanada, S. van Leuven, O. Oktay, and M. Tezuka, “Two-local modifications of SYK model with quantum chaos,” (2025), arXiv: 2505.09900 [quant-ph].

1. A computer-implemented method for determining a physical property of a quantum state of a physical system, comprising:
generating a computational model representing the physical system, wherein the computational model comprises an initial computational state and a time-evolution operator for performing an evolution over time to prepare a computational state;
generating quantum circuits for implementing the computational model, wherein each of the quantum circuits comprises a sequence of steps to implement the time-evolution operator, wherein each step of the sequence of steps is drawn randomly from a set of potential steps of the time-evolution operator;
executing the quantum circuits on the qubits or qudits of a quantum computing system to output expectation values of the time evolution operator;
computing an average of the expectation values over the generated quantum circuits; and
determining a physical property of the physical system from the computed average of the expectation values.

2. A computer-implemented method according to claim 1, wherein the prepared computational state represents an electronic structure state of the physical system, and the determination of the physical property comprises a determination of the energy of a quantum state of the physical system.

3. A computer-implemented method according to claim 1, wherein the time-evolution operator performs adiabatic time evolution of the prepared computational state.

4. A computer-implemented method according to claim 1, wherein the prepared computational state represents the ground state of the physical system and wherein the operator performs adiabatic time evolution of the ground state, and the determination of a physical property comprises a determination of the ground state energy following adiabatic time evolution of the prepared computational state of the physical system.

5. A computer-implemented method according to claim 1, wherein each of the quantum circuits comprises a sequence of rotations with a selected gate angle, wherein the rotations are each drawn randomly and independent of each other with a rate given by a function of the gate angle.

6. A computer-implemented method according to claim 5, wherein the selected gate angle is selected to minimise the expected runtime of the computer-implemented method which runtime is required to reach a selected precision in the determination of the physical property.

7. A computer-implemented method according to claim 6, wherein the selected gate angle is selected to minimise the number of shots times the number of gates per shot that is required to reach a selected precision, thereby to minimise the expected runtime.

8. A computer-implemented method according to claim 1, wherein the operator is selected to have a parameter-dependent expectation value that is zero when the parameter is equal to the ground state energy of the state, and the method comprises:
after executing the quantum circuits on the qubits or qudits of a quantum computing system, measuring the qubits or qudits of the quantum computing system so as to determine the value of the parameter where the parameter-dependent expectation value is zero; and
outputting a determination of the ground state energy of the quantum state of the physical system.

9. (canceled)

10. A computer-implemented method according to claim 98, wherein the computational model is a Hamiltonian which represents the states and interactions of a physical system and the Hamiltonian is generated as a mathematical representation of experimentally-determined properties of the physical system to be modelled.

11. A computer-implemented method according to claim 8, wherein the computational model is a Hamiltonian which represents the states and interactions of a physical system and the Hamiltonian comprises a predefined gate angle parameter, and wherein generating each of the quantum circuits comprises:
generating N gates using the Hamiltonian and the predefined gate angle parameter to construct a quantum circuit, generating a first random number for each of the N gates wherein the first random number determines the number of times each of the N gates is applied in the quantum circuit, and generating a second random number for each gate to be applied in the quantum circuit, wherein the second random number determines the order that each gate is applied in the quantum circuit.

12. A computer-implemented method according to claim 11, to be performed on a computer system comprising a quantum computer having a plurality of qubits or qudits and a controller for applying the N gates using a combination of the qubits or qudits, wherein the controller is adapted to apply at least some of the N gates between non-nearest neighbour qubits or qudits of the plurality of qubits or qudits.

13. (canceled)

14. A computer-implemented method according to claim 5, comprising:
computing a first average of a set of expectation values using a first gate angle;
computing a second average of a second set of expectation values using a second gate angle;
determining an effect of noise using the computed first average of the set of expectation values for the first gate angle and the computed second average of the second set of expectation values for the second gate angle; and
computing a noise-mitigated expectation value based on the determined effect of noise.

15. A computer-implemented method according to claim 14, wherein computing the second average of the second set of expectation values using the second gate angle comprises:
generating a second set of quantum circuits for implementing the computational model using the second gate angle, wherein each of the quantum circuits in the second set comprise a sequence of steps to implement the time-evolution operator, wherein each step of the sequence of steps is drawn randomly from a set of potential steps of the time-evolution operator;
executing the second set of quantum circuits on the qubits or qudits of the quantum computing system to output a second set of expectation values of the time evolution operator; and
computing the second average of the second set of expectation values over the generated second set of quantum circuits.

16. A computer-implemented method according to claim 14, wherein computing the noise-mitigated expectation value comprises performing zero noise extrapolation using a difference between the computed first average of the set of expectation values for the first gate angle and the computed second average of the second set of expectation values for the second gate angle, and a ratio of the second gate angle divided by the first gate angle.

17. A computer-implemented method according to claim 14, wherein computing the noise-mitigated expectation value comprises performing zero noise extrapolation by computing the average of a set of expectation values for each of a plurality of different gate angles corresponding to a different number of rotation gates, determining the effect of noise from the differences between the averages of expectation values for the plurality of different gate angles, and determining an expectation value at zero noise by extrapolating from different rotation angles, thereby to compensate for the determined effect of noise within rotation gates of the quantum circuits.

18. A computer-implemented method according to claim 1 comprising:
preparing a first plurality of the qubits of the quantum computing system in a ground state;
preparing a second plurality of the qubits of the quantum computing system in a |+ [symbol] state;
generating a first quantum circuit for implementing the computation model comprising a first sequence of steps to implement the time-evolution operator, wherein each step of the first sequence of steps is drawn randomly from a set of potential steps of the time-evolution operator;
executing the first quantum circuit on the first plurality of qubits conditioned on when the qubits in the second plurality of qubits are in the |1 [symbol] state;
generating a second quantum circuit for implementing the computation model comprising a second sequence of steps to implement the time-evolution operator, wherein each step of the second sequence of steps is drawn randomly from a set of potential steps of the time-evolution operator;
executing the second quantum circuit on the first plurality of qubits conditioned on when the qubits in the second plurality of qubits are in the |0 [symbol] state;
computing an average of the executed first quantum circuit and the executed second quantum circuit;
measuring at least one observable, O, on the first plurality of qubits and measuring a Pauli operator, X, on the second plurality of qubits; and
computing an average of the measurement to obtain an expectation value of the at least one observable, O.

19. A quantum computing system comprising a quantum computer having a plurality of qubits or qudits for executing quantum circuits, and further comprising a controller for controlling performance of operations on the quantum computer, to perform a method comprising:
generating a computational model representing the physical system, wherein the computational model comprises an initial computational state and a time-evolution operator for performing an evolution over time to prepare a time-evolved computational state;
generating quantum circuits for implementing the computational model, which quantum circuits each comprise a sequence of gate operations having a selected gate angle, to implement the time-evolution operator, wherein each gate operation of the sequence of gate operations is drawn randomly from a set of operations of the time-evolution operator;
executing the quantum circuits on the qubits or qudits of a quantum computing system to output expectation values of the time evolution operator;
computing an average of the expectation values over the generated quantum circuits; and
rescaling the computed average by a factor that is a function of the gate angle; and
determining a physical property of the physical system based on the rescaled computed average.

20-21. (canceled)

22. A computer-implemented method for determining the energy of a quantum state of a physical system, comprising:
generating a computational model representing the energy of a quantum state of the physical system, wherein the computational model comprises an initial computational state and a time-evolution operator for performing an evolution over time to prepare a time-evolved computational state, wherein the operator has a parameter that encodes the energy of the time-evolved computational state and the operator has a parameter-dependent expectation value that is zero when the parameter is equal to the ground state energy of the quantum state;
generating quantum circuits corresponding to the computational model;
executing the quantum circuits on the qubits or qudits of a quantum computing system to compute the effects of the time-evolution operator of the computational model; and
measuring the qubits or qudits of the quantum computing system so as to determine the value of the parameter where the parameter-dependent expectation value is zero, and using the determined parameter value to determine the ground state energy of the quantum state of the physical system.

23. A computer-implemented method according to claim 22, wherein the step of generating quantum circuits comprises generating quantum circuits that each comprises a sequence of operations of the time-evolution operator, wherein each operation of the sequence of operations is drawn randomly from a set of operations of the time-evolution operator.

24. A computer-implemented method according to claim 22, wherein the step of generating quantum circuits comprises generating quantum circuits that each comprise rotations for each of a plurality of terms in the computational model, the rotations for each term comprising a sequence of rotations of a selected gate angle, wherein the rotations are each drawn randomly and independently of each other with a rate given by a function of the gate angle.

25. A computer-implemented method according to claim 22, wherein the time-evolution operator performs adiabatic evolution of the prepared computational state.

26. A computer-implemented method according to claim 25, wherein the prepared computational state represents the ground state of the physical system and wherein the operator performs adiabatic time evolution of the ground state, and the output determination is a determination of the ground state energy following adiabatic time-evolution of the prepared computational state of the physical system.

27. A computer-implemented method according to claim 22, wherein the operator is selected to have a parameter-dependent expectation value that is zero when the parameter is equal to the ground state energy of the state, and the method comprises:
after executing the quantum circuits on the qubits or qudits of a quantum computing system, measuring the qubits or qudits of the quantum computing system so as to determine the value of the parameter where the parameter-dependent expectation value is zero; and
outputting a determination of the ground state energy of the quantum state of the physical system.

28. (canceled)

29. A computer-implemented method according to claim 27, wherein the computational model is a Hamiltonian which represents the states and interactions of a physical system and the Hamiltonian is generated as a mathematical representation of experimentally-determined properties of the physical system to be modelled.

30. A computer-implemented method according to claim 27, wherein the computational model is a Hamiltonian which represents the states and interactions of a physical system and the Hamiltonian comprises a predefined gate angle parameter, and wherein generating each of the quantum circuits comprises:
generating N gates using the Hamiltonian and the predefined gate angle parameter to construct a quantum circuit, generating a first random number for each of the N gates wherein the first random number determines the number of times each of the N gates is applied in the quantum circuit, and generating a second random number for each gate to be applied in the quantum circuit, wherein the second random number determines the order that each gate is applied in the quantum circuit.

31. (canceled)
